(19) United States
(12) Patent Application Publication
(10) Pub. No.: US 2022/0316211 A1
(43) Pub. Date: Oct. 6, 2022

(54) WALL PANEL ASSEMBLY INCLUDING A CONDUCTOR

(71) Applicant: Goldray Industries, Ltd., Calgary (CA)

(72) Inventors: Saroka Michael, Calgary (CA); Prince Ruchogeza, Calgary (CA)

(21) Appl. No.: 17/713,999

(22) Filed: Apr. 5, 2022

Related U.S. Application Data
(60) Provisional application No. 63/171,548, filed on Apr. 6, 2021.

(51) Int. Cl. E04C 2/52; E04F 13/08; H02G 3/12; G02B 6/44

(52) U.S. Cl. CPC E04C 2/526; E04F 13/081; H02G 3/12; G02B 6/4439; E04F 2290/02

(57) ABSTRACT

A wall panel assembly for mounting to a support is disclosed. The support includes a support-defined communicating module that includes a support-defined counterpart of a connecting structure and a support-defined conductor. The wall panel assembly comprises a wall panel that is mountable to the support, and a wall panel assembly-defined communicating module that includes a wall panel assembly-defined counterpart of the connecting structure that is configured for releasably coupling to the support-defined counterpart of the connecting structure, and a wall panel assembly-defined conductor. In response to the releasable coupling of the wall panel assembly-defined and the support-defined counterparts of the connecting structure, the wall panel assembly-defined conductor becomes disposed in operable communication, for example, electrical communication or data communication, with the support-defined conductor. Once the coupling is released, the wall panel assembly-defined counterpart is releasably couplable to another support-defined counterpart of the connecting structure to reposition the wall panel assembly.

### FIELD

The present disclosure relates to systems and methods for mounting and re-positioning a wall panel assembly to a support, the wall panel assembly including a conductor.

### BACKGROUND

While constructing a building, the number of, and the location of, outlets, such as electrical outlets or data outlets, are considered. For example, it may be desired to have an electrical outlet and a data outlet disposed on a lower portion of a particular wall. Accordingly, during construction, the electrical and data conductors are run such that one end of the conductors are disposed to be in operable communication with the electrical source, such as the fuse box, and the data source, such as the modem or router, while the other end of the conductors are disposed proximate the portion of the frame corresponding to the desired location of the outlets on the wall. Upon installation of the dry wall and outlets, the dry wall and the outlets occlude the frame.

During a building or room renovation, it may be desirable to install additional outlets at another wall, or to relocate existing outlets to the other wall. Unfortunately, such installation or relocation may be impractical or not feasible. To avoid running additional conductors through the interior of a room, which may present a safety hazard, the additional conductors may have to be run behind the wall. However, depending on the desired location of the outlets, existing building components, such as the frame, insulation, ductwork, and the like, may not allow for the conductors to be run behind the wall. Even if the conductors may be run behind the wall, existing building components may impede running of the conductors behind the wall, which may render the installation or relocation cumbersome. In addition, openings may have to be cut into the wall to receive a device box for the desired outlets. While cutting the opening, building components behind the wall, such as conductors, wiring, cables, or pipes, may be damaged. Further, the conductors may have to be re-run if they are not sufficiently proximate to the opening. Moreover, if an existing outlet is being relocated, then after the outlet is relocated, the opening in which the outlet was previously received may have to be patched up, which may be time-consuming, and if done improperly, may be aesthetically unpleasant.

### SUMMARY

In one aspect, there is provided a wall panel assembly for mounting to a support, the support including a support defined current or light communicating module that includes a support defined counterpart of a connecting structure and a support defined current or light conductor, the wall panel assembly comprising: a wall panel that is mountable to the support; a wall panel assembly defined current or light communicating module that includes: a wall panel assembly defined counterpart of the connecting structure that is configured for releasably coupling to the support defined counterpart of the connecting structure; and a wall panel assembly defined current or light conductor; wherein the wall panel assembly-defined current or light conductor and the wall panel assembly defined counterpart of the connecting structure are co operatively configured such that in response to the releasable coupling of the wall panel assembly defined and the support defined counterparts of the connecting structure, the wall panel assembly-defined current or light conductor becomes disposed in operable communication with the support-defined current or light conductor.

In another aspect, there is provided a wall panel system, comprising: a wall panel assembly that is mountable to a support, the support including a support defined current or light communicating module that includes: a support defined counterpart of a connecting structure; and a support defined current or light conductor; the wall panel assembly including a wall panel assembly defined current or light communicating module that includes: a wall panel assembly defined counterpart of the connecting structure that is configured for releasably coupling to the support defined counterpart of the connecting structure; and a wall panel assembly defined current or light conductor; wherein the wall panel assembly-defined current or light conductor, the support-defined current or light conductor, the wall panel assembly defined counterpart of the connecting structure, and the support defined counterpart of the connecting structure are co operatively configured such that in response to the releasable coupling of the wall panel assembly defined counterpart of the connecting structure and the support defined counterpart of the connecting structure, the wall panel assembly-defined current or light conductor becomes disposed in operable communication with the support-defined current or light conductor.

Other aspects will be apparent from the description and drawings provided herein.

### BRIEF DESCRIPTION OF DRAWINGS

In the figures, which illustrate example embodiments,

FIG. 1 is a cross-sectional view of an embodiment of a system for mounting a load to a wall frame;

FIG. 2 is a cross-sectional view of the system of FIG. 1, with wall brackets mounted to the wall frame, and load brackets mounted to the load;

FIG. 3 is a cross-sectional view of the system of FIG. 1 that is mounting a load to a wall frame;

FIG. 4 is an enlarged view of the portion of the system of FIG. 2, the portion identified by window C shown in FIG. 2;

FIG. 5 is an enlarged view of the portion of the system of FIG. 2, the portion identified by window D shown in FIG. 2;

FIG. 6 is an elevation view of the wall brackets of the first and second mounting systems mounted to a stud;

FIG. 7 is an elevation view of the wall bracket of the second mounting system mounted to a stud;

FIG. 8 is an elevation view of the load brackets of the first and second mounting systems mounted to a wall panel assembly;

FIG. 9 is an elevation view of the second counterpart of the second mounting system mounted to a wall panel assembly;

FIG. 10 is an elevation view of wall panel assemblies mounted to studs using the system of FIG. 1;

FIG. 11 is a front view of a wall panel;

FIG. 12 is a rear view of the wall panel of FIG. 11;

FIG. 13 is a side view of two wall panels with respective cushioning members disposed in abutting engagement;

FIG. 14 is an elevation view of a first system for mounting a wall panel assembly to a wall frame, and a second system for mounting a wall panel assembly to a wall frame;

FIG. 15 is an elevation view of a wall panel assembly mounted to a wall frame with a first portion of a wall bracket of a first mounting system and a first portion of a wall bracket of a second mounting system of a first system for mounting a wall panel assembly to a wall frame;

FIG. 16 is an elevation view of a wall panel assembly mounted to a frame with a second portion of a wall bracket of a first mounting system and a second portion of a wall bracket of a second mounting system of a first system for mounting a wall panel assembly to a wall frame;

FIG. 17 is an elevation view of a wall panel assembly mounted to a wall frame with a wall bracket of a first mounting system and a wall bracket of a second mounting system of a second system for mounting a wall panel assembly to a wall frame;

FIG. 18 is a cross-sectional view of an embodiment of a wall panel assembly;

FIG. 19 is a perspective view of the wall panel assembly of FIG. 18 with an electrical outlet;

FIG. 20 is a perspective view of the device box of the wall panel assembly of FIG. 18;

FIG. 21 is a elevation view of the wall panel assembly of FIG. 18 with first and second counterparts of a system for releasably securing the wall panel assembly to a support;

FIG. 22 is an elevation view of the wall panel assembly of FIG. 18 with an electrical outlet;

FIG. 23 is a cross-sectional view of the wall panel assembly of FIG. 18 that is mounted to a wall frame, with a wall panel assembly-defined counterpart of a connecting structure releasably coupled to a support-defined counterpart of the connecting structure;

FIG. 24 is a cross-sectional view of the wall panel assembly of FIG. 18 that is releasably mounted to a wall frame, with a wall panel assembly-defined counterpart of a second connecting structure releasably coupled to a support-defined counterpart of the second connecting structure;

FIG. 25 is a cross-sectional view of the wall panel assembly of FIG. 18 that is releasably mounted to a second support, with a wall panel assembly-defined counterpart of a second connecting structure releasably coupled to a support-defined counterpart of the second connecting structure;

FIG. 26 is an elevation view of a wall panel assembly mounted to studs and disposed in engagement with a corner bracket;

FIG. 27 is a perspective view of wall panel assemblies disposed in abutting engagement to define a wall between two corner brackets;

FIG. 28 is a perspective of wall panels disposed in abutting engagement to define a wall between two corner brackets, with one of the wall panels depicted in dashed line;

FIG. 29 is a perspective view of a wall panel assembly-defined counterpart of a connecting structure;

FIG. 30 is a perspective view of a support-defined counterpart of the connecting structure;

FIG. 31 is an elevation view of the wall panel assembly-defined counterpart of FIG. 29 connected to a device box of the wall panel assembly;

FIG. 32 is a schematic of the device box of the wall panel assembly with the wall panel assembly-defined counterpart of FIG. 29 connected thereon;

FIG. 33 is a schematic of the support-defined counterpart of FIG. 30 connected to a support-defined current or light conductor;

FIG. 34 is a schematic of the wall panel assembly-defined counterpart of FIG. 29 and the support-defined counterpart of FIG. 30;

FIG. 35 is a schematic of the wall panel assembly-defined counterpart of FIG. 29 releasably coupled to the support-defined counterpart of FIG. 30;

FIG. 36 is a schematic of the releasable coupling of the wall panel assembly-defined counterpart of FIG. 29 and the support-defined counterpart of FIG. 30.

### DETAILED DESCRIPTION

A wall panel assembly for mounting to a wall frame is disclosed. The wall panel assembly is mountable to the wall frame with a mounting system. The mounting system has a wall bracket that mounted on the wall frame, and has a load bracket that is mounted on the wall panel assembly. The wall panel assembly includes a wall panel assembly-defined current or light communicating module that includes a wall panel assembly-defined counterpart of a connecting structure that is configured for releasably coupling to a support-defined counterpart of the connecting structure, and a wall panel assembly-defined current or light conductor. The wall panel assembly-defined current or light conductor is connected to an outlet or switch on one end, and is connected to the wall panel assembly-defined counterpart of the connecting structure on the other end. A support-defined current or light conductor is connected to a power source or data source on one end, and is connected to the support-defined counterpart of the connecting structure on the other end. In response to releasable coupling of the wall panel assembly-defined counterpart of the connecting structure and the support-defined counterpart of the connecting structure, the outlet or switch becomes disposed in operable communication, for example, electrical communication or data communication, with the power source or data source. The releasable coupling of the wall panel assembly-defined counterpart of the connecting structure and the support-defined counterpart of the connecting structure is releasable, and once released, the wall panel assembly-defined counterpart of the connecting structure is releasably couplable to another support-defined counterpart of the connecting structure to reposition the wall panel assembly and the outlet or switch.

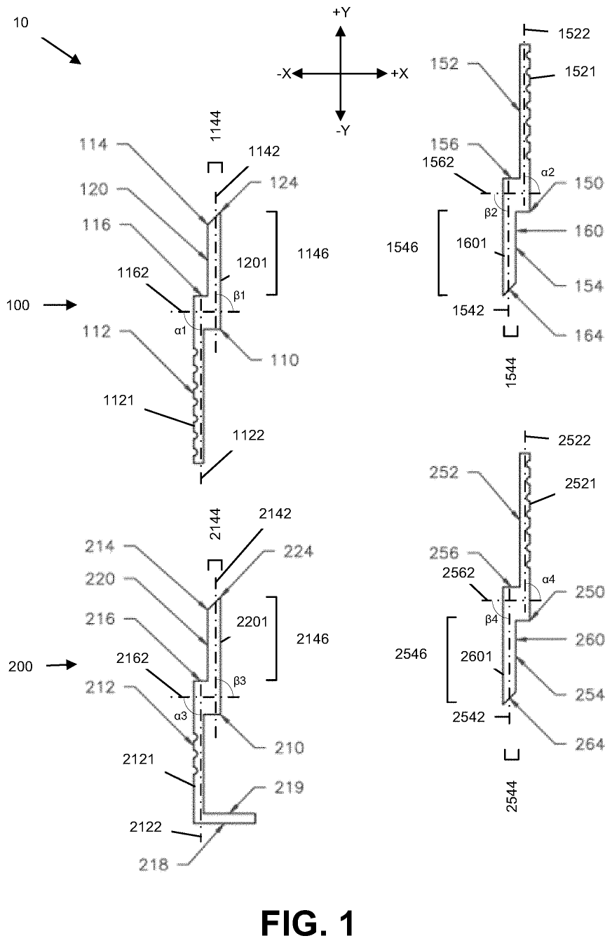

FIG. 1 depicts a system 10 for mounting a load 30 to a support 20, such as a frame of a building, for example, studs 20, or a wall frame 20. In some embodiments, for example, the load 30 is a wall panel assembly 30 that includes a wall panel 31 having a wall paneling 34, a shelf, a cabinet, a rack, a picture frame, a composite panel comprising, for example, a glass panel and a reinforcing substrate, and the like. As depicted in FIG. 1, the system 10 includes a first mounting system 100 and a second mounting system 200. The first mounting system 100 includes a first counterpart 110, for example, a wall bracket 110, and a second counterpart 150, for example, a load bracket 150. Similarly, the second mounting system 200 includes a first counterpart 210, for example, a wall bracket 210, and a second counterpart 250, for example, a load bracket 250.

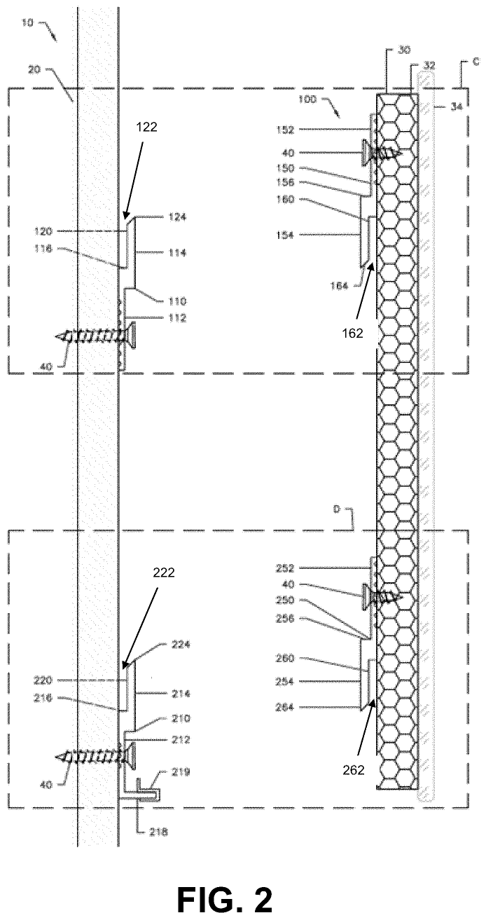

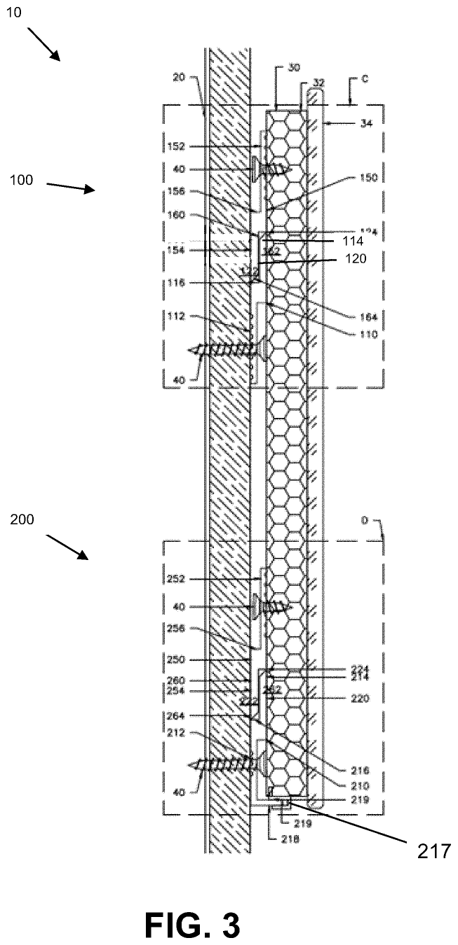

In some embodiments, for example, the wall bracket 110 of the first mounting system 100 is configured to be mounted to the wall frame 20. In this regard, the wall bracket 110 of the first mounting system 100 has a mounting flange 112 for mounting the wall bracket 110 of the first mounting system 100 to the wall frame 20. In some embodiments, for example, the mounting flange 112 is configured to correspond to the surface of the wall frame 20 to facilitate mounting of the wall bracket 110 of the first mounting system 100 to the wall frame 20. As depicted in FIG. 2 and FIG. 3, when the mounting flange 112 is placed on the surface of the wall frame 20, the mounting flange 112 is parallel relative to the surface of the wall frame 20, such that the wall bracket 110 of the first mounting system 100 may be mounted to the wall frame 20. In some embodiments, for example, when the mounting flange 112 is placed on the surface of the wall frame 20, the mounting flange 112 is flush against the surface of the wall frame 20. In some embodiments, for example, the wall bracket 110 of the first mounting system 100 is mounted to the wall frame 20 using fastening devices 40 such as nuts and bolts, screws, rivets, pins, studs, washers, and the like, or adhesives, tape, welding, and the like. In some embodiments, for example, where the wall bracket 110 of the first mounting system 100 is mounted to the wall frame 20 using fastening devices 40, the mounting flange 112 defines one or more ports to receive the fastening devices 40 to mount the wall bracket 110 of the first mounting system 100 is mounted to the wall frame 20. In some embodiments, for example, the wall bracket 110 has a length that is measured along an axis that is parallel to a z-axis (not illustrated), which is perpendicular to both an x-axis and a y-axis, as depicted in FIG. 1 (for example, the z-axis is perpendicular to the drawing sheet on which FIG. 1 is depicted). In some embodiments, for example, the minimum length of the wall bracket 110 is at least 4 inches.

In some embodiments, for example, the mounting flange 112 of the wall bracket 110 of the first mounting system 100 includes a wall-abutting surface 1121 configured for disposition in an abutting relationship relative to the wall frame 20 to which mounting flange 112 is mountable.

In some embodiments, for example, the wall bracket 110 of the first mounting system 100 includes a retaining flange 114 that is connected to the mounting flange 112. The retaining flange 114 defines a retaining surface 120, and is configured to resist displacement of the load 30 from the wall frame 20, as described in greater detail below. As depicted in FIG. 1, the retaining flange 114 is generally parallel to the mounting flange 112. In this respect, the mounting flange 112 defines an axis 1122 that extends along the height of the mounting flange 112, and the retaining flange 114 defines an axis 1142 that extends along the height of the retaining flange 114, as depicted in FIG. 1, and the axis 1122 and the axis 1142 are parallel. In some embodiments, for example, the retaining flange 114 is angled relative to the mounting flange 112. That is, an angle is defined between the axis 1122 and the axis 1142. In some embodiments, for example, the retaining flange 114 has a length, a width 1144 and a height 1146, as depicted in FIG. 1. In some embodiments, for example, the minimum length of the retaining flange 114 is at least 4 inches. In some embodiments, for example, the minimum width 1144 of the retaining flange 114 is at least 3/32 inches. In some embodiments, for example, the minimum height 1146 of the retaining flange 114 is at least ⅝ inches.

In some embodiments, for example, the retaining flange 114 defines surfaces 120 and 1201, wherein the surfaces 120 and 1201 are disposed on opposite sides of the retaining flange 114. In some embodiments, for example, the surfaces 120 and 1201 define respective normal axes. In some embodiments, for example, while a wall panel 30 is mounted to the wall frame 20 via the mounting system 10, the normal axes of surfaces 120 and 1201 are parallel to the normal axis defined by the front surface of the wall panel 30.

While the wall bracket 110 of the first mounting system 100 is mounted to the wall frame 20, a receiving space 122 is defined between the wall frame 20 and the retaining flange 114, as depicted in FIG. 2. As depicted in FIG. 1, in some embodiments, for example, the wall bracket 110 of the first mounting system 100 includes a connecting member 116 that extends between the mounting flange 112 and the retaining flange 114. As depicted in FIG. 1, the connecting member 116 is generally perpendicular relative to the mounting flange 112 and the retaining flange 114. In this respect, the connecting member 116 defines an axis 1162 that extends along the width of the connecting member 116, as depicted in FIG. 1, and an angle α1 defined between the axis 1122 and the axis 1162 is 90 degrees, and the angle β1 defined between the axis 1142 and the axis 1162 is 90 degrees (e.g. the axis 1162 is perpendicular to both the axis 1122 and the axis 1142). In some embodiments, for example, the connecting member 116 is angled relative to the mounting flange 112 and the retaining flange 114. That is, the angle α1 defined between the axis 1122 and the axis 1162 is greater or less than 90 degrees, and the angle β1 is defined between the axis 1142 and the axis 1162 is greater or less than 90 degrees. In some embodiments, for example, the mounting flange 112, the retaining flange 114, and the connecting member 116 of the wall bracket 110 of the first mounting system 100 are co-operatively configured to define the receiving space 122 while the wall bracket 110 of the first mounting system 100 is mounted to the wall frame 20. In some embodiments, for example, the receiving space 122 is configured to receive the retainable flange 154 of the load bracket 150 of the first mounting system 100, as described in greater detail below. In some embodiments, for example, the length of the receiving space 122 is based on the length of the wall bracket 110 of the first mounting system 100, the height of the receiving space 122 is based on the height of the retaining flange 114, and the width of the receiving space 122 is based on the width of the connecting member 116. In some embodiments, for example, the minimum length of the receiving space 122 is at least 4 inches. In some embodiments, for example, the minimum width of the receiving space 122 is at least 3/32 inches. In some embodiments, for example, the minimum height of the receiving space 122 is at least ⅝ inches.

In some embodiments, for example, the load bracket 150 of the first mounting system 100 is configured to be mounted to the load 30. In this regard, the load bracket 150 of the first mounting system 100 has a mounting flange 152 for mounting the load bracket 150 of the first mounting system 100 to the load 30. In some embodiments, for example, the mounting flange 152 is configured to correspond to the surface of the load 30 to facilitate mounting of the load bracket 150 of the first mounting system 100 to the load 30. As depicted in FIG. 2 and FIG. 3, when the load bracket 150 is placed on the surface of the load 30, the mounting flange 152 is parallel relative to the surface of the load 30, such that the load bracket 150 of the first mounting system 100 may be mounted to the load 30. In some embodiments, for example, when the mounting flange 152 is placed on the surface of the load 30, the mounting flange 152 is flush against the surface of the load 30. In some embodiments, for example, the load bracket 150 of the first mounting system 100 is mounted to the load 30 using fastening devices 40 such as nuts and bolts, screws, rivets, pins, studs, washers, and the like, or adhesives, tape, welding, and the like. In some embodiments, for example, where the load bracket 150 of the first mounting system 100 is mounted to the load 30 using fastening devices 40, the mounting flange 152 defines one or more ports to receive the fastening devices 40 to mount the load bracket 150 of the first mounting system 100 is mounted to the load 30. In some embodiments, for example, the minimum length of the load bracket 150 is at least 4 inches.

In some embodiments, for example, the mounting flange 152 of the load bracket 150 of the first mounting system 100 includes a load-abutting surface 1521 configured for disposition in an abutting relationship relative to the load 30 to which mounting flange 152 is mountable.

In some embodiments, for example, the load bracket 150 of the first mounting system 100 includes a retainable flange 154 that is connected to the mounting flange 152. The retainable flange 154 defines a retainable surface 120, and is configured to resist displacement of the load 30 from the wall frame 20, as described in greater detail below. As depicted in FIG. 1, the retainable flange 154 is generally parallel to the mounting flange 152. In this respect, the mounting flange 152 defines an axis 1522 that extends along the height of the mounting flange 152, and the retainable flange 154 defines an axis 1542 that extends along the height of the retainable flange 154, as depicted in FIG. 1, and the axis 1522 and the axis 1542 are parallel. In some embodiments, for example, the retainable flange 154 is angled relative to the mounting flange 152. That is, an angle is defined between the axis 1522 and the axis 1542. In some embodiments, for example, the retainable flange 154 has a length, a width 1544 and a height 1546, as depicted in FIG. 1. In some embodiments, for example, the minimum length of the retainable flange 154 is at least 4 inches. In some embodiments, for example, the minimum width 1544 of the retainable flange 154 is at least 3/32 inches. In some embodiments, for example, the minimum height 1546 of the retainable flange 154 is at least ⅝ inches.

In some embodiments, for example, the retainable flange 154 defines surfaces 160 and 1601, wherein the surfaces 160 and 1601 are disposed on opposite sides of the retaining flange 154. In some embodiments, for example, the surfaces 160 and 1601 define respective normal axes. In some embodiments, for example, while a wall panel 30 is mounted to the wall frame 20 via the mounting system 10, the normal axes of surfaces 160 and 1601 are parallel to the normal axis defined by the front surface of the wall panel 30.

While the load bracket 150 of the first mounting system 100 is mounted to the load 30, a receiving space 162 is defined between the load 30 and the retainable flange 154, as depicted in FIG. 2. As depicted in FIG. 1, in some embodiments, for example, the load bracket 150 of the first mounting system 100 includes a connecting member 156 that extends between the mounting flange 152 and the retainable flange 154. As depicted in FIG. 1, the connecting member 156 is generally perpendicular relative to the mounting flange 152 and the retainable flange 154. In this respect, the connecting member 156 defines an axis 1562 that extends along the width of the connecting member 156, as depicted in FIG. 1, and an angle α2 defined between the axis 1522 and the axis 1562 is 90 degrees, and the angle β2 defined between the axis 1542 and the axis 1562 is 90 degrees (e.g. the axis 1562 is perpendicular to both the axis 1522 and the axis 1542). In some embodiments, for example, the connecting member 156 is angled relative to the mounting flange 152 and the retainable flange 154. That is, the angle α2 defined between the axis 1522 and the axis 1562 is greater or less than 90 degrees, and the angle β2 is defined between the axis 1542 and the axis 1562 is greater or less than 90 degrees. In some embodiments, for example, the mounting flange 152, the retainable flange 154, and the connecting member 156 of the load bracket 150 of the first mounting system 100 are co-operatively configured to define the receiving space 162 while the load bracket 150 of the first mounting system 100 is mounted to the load 30. In some embodiments, for example, the receiving space 162 is configured to receive the retaining flange 114 of the wall bracket 110 of the first mounting system 100, as described in greater detail below. In some embodiments, for example, the length of the receiving space 162 is based on the length of the load bracket 150 of the first mounting system 100, the height of the receiving space 162 is based on the length of the load bracket 150 of the first mounting system 100, and the width of the receiving space 162 is based on the width of the connecting member 156. In some embodiments, for example, the minimum length of the receiving space 162 is at least 4 inches. In some embodiments, for example, the minimum width of the receiving space 162 is at least 3/32 inches. In some embodiments, for example, the minimum height of the receiving space 162 is at least ⅝ inches.

In some embodiments, for example, the wall bracket 210 of the second mounting system 200 is configured to be mounted to the wall frame 20, similar to the wall bracket 110 of the first mounting system 100. In this regard, the wall bracket 210 of the second mounting system 200 has a mounting flange 212 for mounting the wall bracket 210 of the second mounting system 200 to the wall frame 20. In some embodiments, for example, the mounting flange 212 is configured to correspond to the surface of the wall frame 20 to facilitate mounting of the wall bracket 210 of the second mounting system 200 to the wall frame 20. As depicted in FIG. 2 and FIG. 3, when the mounting flange 212 is placed on the surface of the wall frame 20, the mounting flange 212 is parallel against the surface of the wall frame 20, such that the wall bracket 210 of the second mounting system 200 may be mounted to the wall frame 20. In some embodiments, for example, when the mounting flange 212 is placed on the surface of the wall frame 20, the mounting flange 212 is flush against the surface of the wall frame 20. In some embodiments, for example, the wall bracket 210 of the second mounting system 200 is mounted to the wall frame 20 using fastening devices 40 such as nuts and bolts, screws, rivets, pins, studs, washers, and the like, or adhesives, tape, welding, and the like. In some embodiments, for example, where the wall bracket 210 of the second mounting system 200 is mounted to the wall frame 20 using fastening devices 40, the mounting flange 212 defines one or more ports to receive the fastening devices 40 to mount the wall bracket 210 of the second mounting system 200 is mounted to the wall frame 20. In some embodiments, for example, the minimum length of the wall bracket 210 is at least 4 inches.

In some embodiments, for example, the mounting flange 212 of the wall bracket 210 of the second mounting system 200 includes a load-abutting surface 2121 configured for disposition in an abutting relationship relative to the wall frame 20 to which mounting flange 212 is mountable.

In some embodiments, for example, the wall bracket 210 of the second mounting system 200 includes a retaining flange 214 that is connected to the mounting flange 212. The retaining flange 214 defines a retaining surface 220, and is configured to resist displacement of the load 30 from the wall frame 20, as described in greater detail below. As depicted in FIG. 1, the retaining flange 214 is generally parallel to the mounting flange 212. In this respect, the mounting flange 212 defines an axis 2122 that extends along the height of the mounting flange 212, and the retaining flange 214 defines an axis 2142 that extends along the height of the retaining flange 214, as depicted in FIG. 1, and the axis 2122 and the axis 2142 are parallel. In some embodiments, for example, the retaining flange 214 is angled relative to the mounting flange 212. That is, an angle is defined between the axis 2122 and the axis 2142. In some embodiments, for example, the retaining flange 214 has a length, a width 2144 and a height 2146, as depicted in FIG. 1. In some embodiments, for example, the minimum length of the retaining flange 214 is at least 4 inches. In some embodiments, for example, the minimum width 2144 of the retaining flange 214 is at least 3/32 inches. In some embodiments, for example, the minimum height 2146 of the retaining flange 214 is at least ⅝ inches.

In some embodiments, for example, the retaining flange 214 defines surfaces 220 and 2201, wherein the surfaces 220 and 2201 are disposed on opposite sides of the retaining flange 214. In some embodiments, for example, the surfaces 220 and 2201 define respective normal axes. In some embodiments, for example, while a wall panel 30 is mounted to the wall frame 20 via the mounting system 10, the normal axes of surfaces 220 and 2201 are parallel to the normal axis defined by the front surface of the wall panel 30.

While the wall bracket 210 of the second mounting system 200 is mounted to the wall frame 20, a receiving space 222 is defined between the wall frame 20 and the retaining flange 114, as depicted in FIG. 2. As depicted in FIG. 1, in some embodiments, for example, the wall bracket 210 of the second mounting system 200 includes a connecting member 216 that extends between the mounting flange 212 and the retaining flange 214. As depicted in FIG. 1, the connecting member 216 is generally perpendicular relative to the mounting flange 212 and the retaining flange 214. In this respect, the connecting member 216 defines an axis 2162 that extends along the width of the connecting member 216, as depicted in FIG. 1, and an angle α3 defined between the axis 2122 and the axis 2162 is 90 degrees, and the angle β3 defined between the axis 2142 and the axis 2162 is 90 degrees (e.g. the axis 2162 is perpendicular to both the axis 2122 and the axis 2142). In some embodiments, for example, the connecting member 216 is angled relative to the mounting flange 212 and the retaining flange 214. That is, the angle α1 defined between the axis 2122 and the axis 2162 is greater or less than 90 degrees, and the angle β3 is defined between the axis 2142 and the axis 2162 is greater or less than 90 degrees. In some embodiments, for example, the mounting flange 212, the retaining flange 214, and the connecting member 216 of the wall bracket 210 of the second mounting system 200 are co-operatively configured to define the receiving space 222 while the wall bracket 210 of the second mounting system 200 is mounted to the wall frame 20. In some embodiments, for example, the receiving space 222 is configured to receive the retainable flange 254 of the load bracket 250 of the first mounting system 100, as described in greater detail below. In some embodiments, for example, the length of the receiving space 222 is based on the length of the wall bracket 210 of the second mounting system 200, the height of the receiving space 222 is based on the height of the retaining flange 214, and the width of the receiving space 222 is based on the width of the connecting member 216. In some embodiments, for example, the minimum length of the receiving space 222 is at least 4 inches. In some embodiments, for example, the minimum width of the receiving space 222 is at least 3/32 inches. In some embodiments, for example, the minimum height of the receiving space 222 is at least ⅝ inches.

The wall bracket 210 of the second mounting system 200 includes a ledge 218, for example, a shoulder, that is configured to support the load 30. The ledge 218 defines a support surface 219 for effecting the vertical support of the load 30. In some embodiments, for example, the load 30 rests on the ledge 218 while the ledge 218 is supporting the load 30. In some embodiments, for example, when the wall bracket 210 of the second mounting system 200 is mounted to the wall frame 20, the ledge 218 is level with the floor, such that when the load 30 is supported by the ledge 218, the load 30 is level with the floor. As depicted in FIG. 1, in some embodiments, for example, the ledge 218 extends from the mounting flange 212, and extends sufficiently from the mounting flange 212 to support the load 30. In some embodiments, for example, the ledge 218 extends perpendicularly from the mounting flange 212. In such embodiments, where the mounting flange 212 is mounted flush or parallel with the surface of the wall frame 20, the ledge 218 is perpendicular to the surface of the wall frame 20 on which the wall bracket 210 of the second mounting system 200 is mounted. As depicted in FIG. 1, the ledge 218 is offset from the connecting member 216 of the wall bracket 210 of the second mounting system 200.

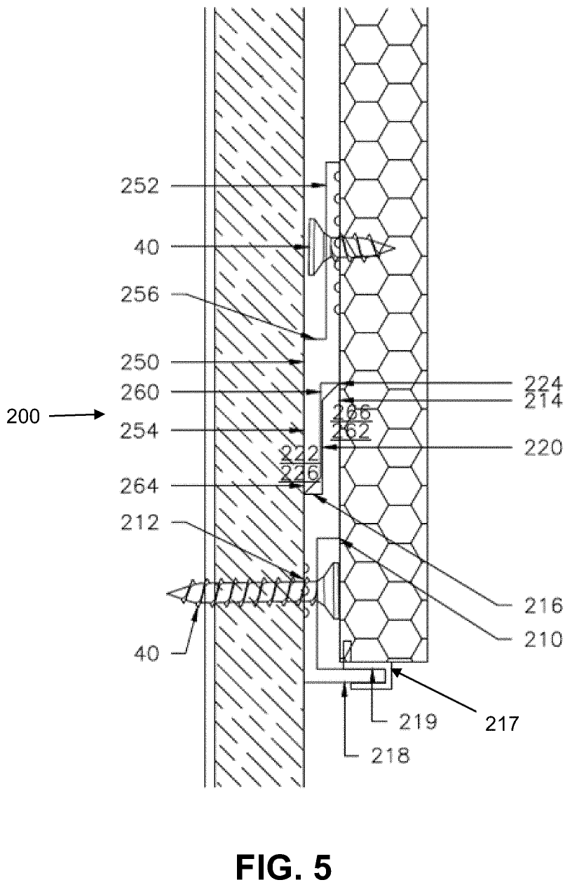

In some embodiments, for example, a protective member 217 is disposed on the ledge 218. In some embodiments, for example, the protective member 217 is disposed on the surface 219. As depicted in FIG. 5, while the load 30 is supported by the ledge 218, the protective member 217 is disposed between the ledge 218 and the load 30 to reduce damage to the ledge 218 and the load 30, for example, due to wear and tear or friction between the ledge 218 and the load 30. In some embodiments, for example, the protective member 217 is a gasket, a seal, or a rubber sealant, such as a silicone rubber sealant.

In some embodiments, for example, the support surface 219 has a normal axis that is perpendicular to the normal axis of the wall-abutting surface 2121 of the mounting flange 212 of the wall bracket 210 of the second mounting system 200.

In some embodiments, for example, the load bracket 250 of the second mounting system 200 is configured to be mounted to the load 30. In this regard, the load bracket 250 of the second mounting system 200 has a mounting flange 252 for mounting the load bracket 250 of the second mounting system 200 to the load 30. In some embodiments, for example, the mounting flange 252 is configured to correspond to the surface of the load 30 to facilitate mounting of the load bracket 250 of the second mounting system 200 to the load 30. As depicted in FIG. 2 and FIG. 3, when the load bracket 250 is placed on the surface of the load 30, the mounting flange 252 is parallel relative to the surface of the load 30, such that the load bracket 250 of the second mounting system 200 may be mounted to the load 30. In some embodiments, for example, when the mounting flange 252 is placed on the surface of the load 30, the mounting flange 252 is flush against the surface of the load 30. In some embodiments, for example, the load bracket 250 of the second mounting system 200 is mounted to the load 30 using fastening devices 40 such as nuts and bolts, screws, rivets, pins, studs, washers, and the like, or adhesives, tape, welding, and the like. In some embodiments, for example, where the load bracket 250 of the second mounting system 200 is mounted to the load 30 using fastening devices 40, the mounting flange 252 defines one or more ports to receive the fastening devices 40 to mount the load bracket 250 of the second mounting system 200 is mounted to the load 30. In some embodiments, for example, the minimum length of the load bracket 250 is at least 4 inches.

In some embodiments, for example, the mounting flange 252 of the load bracket 250 of the second mounting system 200 includes a load-abutting surface 2521 configured for disposition in an abutting relationship relative to the load 30 to which mounting flange 252 is mountable.

In some embodiments, for example, the load bracket 250 of the second mounting system 200 includes a retainable flange 254 that is connected to the mounting flange 252. The retainable flange 254 defines a retainable surface 260, and is configured to resist displacement of the load 30 from the wall frame 20, as described in greater detail below. As depicted in FIG. 1, the retainable flange 254 is generally parallel to the mounting flange 252. In this respect, the mounting flange 252 defines an axis 2522 that extends along the height of the mounting flange 252, and the retainable flange 254 defines an axis 2542 that extends along the height of the retainable flange 254, as depicted in FIG. 1, and the axis 2522 and the axis 2542 are parallel. In some embodiments, for example, the retainable flange 254 is angled relative to the mounting flange 252. That is, an angle is defined between the axis 1522 and the axis 1542. In some embodiments, for example, the retainable flange 254 has a length, a width 2544 and a height 2546, as depicted in FIG. 1. In some embodiments, for example, the minimum length of the retainable flange 254 is at least 4 inches. In some embodiments, for example, the minimum width 2544 of the retainable flange 254 is at least 3/32 inches. In some embodiments, for example, the minimum height 2546 of the retainable flange 254 is at least ⅝ inches.

In some embodiments, for example, the retainable flange 254 defines surfaces 260 and 2601, wherein the surfaces 260 and 2601 are disposed on opposite sides of the retaining flange 254. In some embodiments, for example, the surfaces 260 and 2601 define respective normal axes. In some embodiments, for example, while a wall panel 30 is mounted to the wall frame 20 via the mounting system 10, the normal axes of surfaces 260 and 2601 are parallel to the normal axis defined by the front surface of the wall panel 30.

While the load bracket 250 of the second mounting system 200 is mounted to the load 30, a receiving space 262 is defined between the load 30 and the retainable flange 254, as depicted in FIG. 2. As depicted in FIG. 1, in some embodiments, for example, the load bracket 250 of the second mounting system 200 includes a connecting member 256 that extends between the mounting flange 252 and the retainable flange 254. As depicted in FIG. 1, the connecting member 256 is generally perpendicular relative to the mounting flange 252 and the retainable flange 254. In this respect, the connecting member 256 defines an axis 2562 that extends along the width of the connecting member 256, as depicted in FIG. 1, and an angle α4 defined between the axis 2522 and the axis 2562 is 90 degrees, and the angle β4 defined between the axis 2542 and the axis 2562 is 90 degrees (e.g. the axis 2562 is perpendicular to both the axis 2522 and the axis 2542). In some embodiments, for example, the connecting member 256 is angled relative to the mounting flange 252 and the retainable flange 254. That is, the angle α4 defined between the axis 2522 and the axis 2562 is greater or less than 90 degrees, and the angle β4 is defined between the axis 2542 and the axis 2562 is greater or less than 90 degrees. In some embodiments, for example, the mounting flange 252, the retainable flange 254, and the connecting member 256 of the load bracket 250 of the second mounting system 200 are co-operatively configured to define the receiving space 262 while the load bracket 250 of the second mounting system 200 is mounted to the load 30. In some embodiments, for example, the receiving space 262 is configured to receive the retaining flange 214 of the wall bracket 210 of the second mounting system 200, as described in greater detail below. In some embodiments, for example, the length of the receiving space 262 is based on the length of the load bracket 250 of the second mounting system 200, the height of the receiving space 262 is based on the length of the load bracket 250 of the second mounting system 200, and the width of the receiving space 262 is based on the width of the connecting member 256. In some embodiments, for example, the minimum length of the receiving space 262 is at least 4 inches. In some embodiments, for example, the minimum width of the receiving space 262 is at least 3/32 inches. In some embodiments, for example, the minimum height of the receiving space 262 is at least ⅝ inches.

The first mounting system 100 and the second mounting system 200 are co-operatively configured to mount the load 30 to the support 20. FIG. 3 depicts the system 10 securing the load 30 to the wall via the system 10, with the wall bracket 110 of the first mounting system 100 engaged with the load bracket 150 of the first mounting system 100, and the wall bracket 210 of the second mounting system 200 engaged with the load bracket 250 of the second mounting system 200. As depicted in FIG. 3, the load 30, or a portion of the load 30, is resting on the surface 219 of the ledge 218 and supported by the ledge 218 while the load 30 is secured to the wall frame 20.

As depicted in FIG. 2 and FIG. 3, the wall bracket 110 of the first mounting system 100 and the wall bracket 210 of the second mounting system 200 are mounted to the wall frame 20 using fasteners 40, and the load bracket 150 of the first mounting system 100 and the load bracket 250 of the second mounting system 200 are mounted to the load 30 using fasteners. In addition, the retainable flange 154 of the load bracket 150 of the first mounting system 100 is received in the receiving space 122 defined by the wall bracket 110 of the first mounting system 100, and the retainable flange 254 of the load bracket 250 of the second mounting system 200 is received in the receiving space 222 defined by the wall bracket 110 of the second mounting system 200.

In some embodiments, for example, the first mounting system 100 and the second mounting system 200 are co-operatively configured such that, while the wall bracket 110 of the first mounting system 100 and the wall bracket 210 of the second mounting system 200 are mounted to the wall frame 20, and the load bracket 150 of the first mounting system 100 and the load bracket 250 of the second mounting system 200 are mounted to the load 30, and the retainable flange 154 of the load bracket 150 of the first mounting system 100 is received in the receiving space 122 defined by the wall bracket 110 of the first mounting system 100, and the retainable flange 254 of the load bracket 250 of the second mounting system 200 is received in the receiving space 222 defined by the wall bracket 210 of the second mounting system 200, the load 30 is supported by the ledge 218 of the wall bracket 210 of the second mounting system 200.

In some embodiments, for example, the first mounting system 100 and the second mounting system 200 are co-operatively configured such that while the load bracket 150 of the first mounting system 100 is mounted to the load 30, and the retainable flange 154 of the load bracket 150 of the first mounting system 100 is received in the receiving space 122 defined by the wall bracket 110 of the first mounting system 100 while the wall bracket 110 of the first mounting system 100 is mounted to the wall frame 20, displacement of the load 30 away from the wall frame 20 is resisted. In some embodiments, for example, the displacement of the load 30 away from the wall frame 20 is resisted upon engagement of the retaining surface 120 of the retaining flange 114 of the wall bracket 110 of the first mounting system 100 and the retainable surface 120 of the retainable flange 154 of the load bracket 150 of the first mounting system 100. In some embodiments, for example, the displacement of the load 30 away from the wall frame 20 is resisted while the load 30 is supported by the ledge 218.

In some embodiments, for example, the first mounting system 100 and the second mounting system 200 are co-operatively configured such that while the load bracket 250 of the second mounting system 200 is mounted to the load 30, and the retainable flange 254 of the load bracket 250 of the second mounting system 200 is received in the receiving space 222 defined by the wall bracket 210 of the second mounting system 200 while the wall bracket 210 of the second mounting system 200 is mounted to the wall frame 20, displacement of the load 30 away from the wall frame 20 is resisted. In some embodiments, for example, the displacement of the load 30 away from the wall frame 20 is resisted upon engagement of the retaining surface 220 of the retaining flange 214 of the wall bracket 210 of the second mounting system 200 and the retainable surface 260 of the retainable flange 254 of the load bracket 250 of the second mounting system 200. In some embodiments, for example, the displacement of the load 30 away from the wall frame 20 is resisted while the load 30 is supported by the ledge 218.

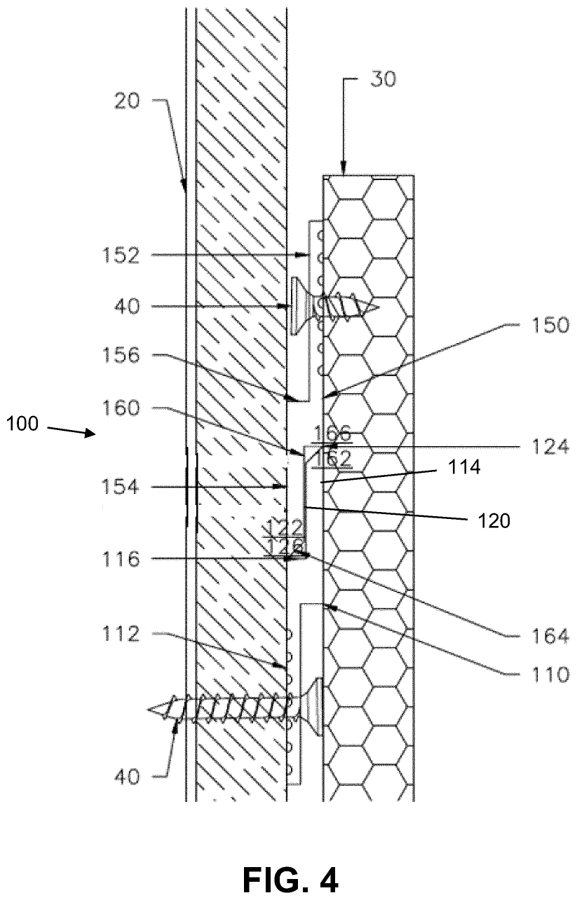

In some embodiments, for example, the first mounting system 100 and the second mounting system 200 are co-operatively configured such that while the load bracket 150 of the first mounting system 100 is mounted to the load 30, and the retainable flange 154 of the load bracket 150 of the first mounting system 100 is received in the receiving space 122 defined by the wall bracket 110 of the first mounting system 100 while the wall bracket 110 of the first mounting system 100 is mounted to the wall frame 20, the retaining surface 120 of the retaining flange 114 of the wall bracket 110 of the first mounting system 100 opposes the retainable surface 120 of the retainable flange 154 of the load bracket 150 of the first mounting system 100, as depicted in FIG. 3 and FIG. 4. In some embodiments, for example, the retaining surface 120 of the retaining flange 114 of the wall bracket 110 of the first mounting system 100 opposes the retainable surface 120 of the retainable flange 154 of the load bracket 150 of the first mounting system 100 while the load 30 is supported by the ledge 218.

In some embodiments, for example, the first mounting system 100 and the second mounting system 200 are co-operatively configured such that while the load bracket 250 of the second mounting system 200 is mounted to the load 30, and the retainable flange 254 of the load bracket 250 of the second mounting system 200 is received in the receiving space 222 defined by the wall bracket 210 of the second mounting system 200 while the wall bracket 210 of the second mounting system 200 is mounted to the wall frame 20, the retaining surface 220 of the retaining flange 214 of the wall bracket 210 of the second mounting system 200 opposes the retainable surface 260 of the retainable flange 254 of the load bracket 250 of the second mounting system 200, as depicted in FIG. 3 and FIG. 5. In some embodiments, for example, the retaining surface 220 of the retaining flange 214 of the wall bracket 210 of the second mounting system 200 opposes the retainable surface 260 of the retainable flange 254 of the load bracket 250 of the second mounting system 200 while the load 30 is supported by the ledge 218.

As depicted in FIG. 2, FIG. 3, and FIG. 4, in some embodiments, for example, the receiving space 162 is defined by the load bracket 150 of the first mounting system 100 when the load bracket 150 is mounted to the load 30. In some embodiments, for example, the first mounting system 100 and the second mounting system 200 are co-operatively configured such that while the wall bracket 110 of the first mounting system 100 is mounted to the wall frame 20, and the load bracket 150 of the first mounting system 100 is mounted to the load 30, and the retainable flange 154 of the load bracket 150 of the first mounting system 100 is received in the receiving space 122 defined by the wall bracket 110 of the first mounting system 100, the retaining flange 114 of the wall bracket 110 of the first mounting system 100 is received in the receiving space 162 defined by the load bracket 150 of the first mounting system 100.

As depicted in FIG. 2, FIG. 3, and FIG. 5, in some embodiments, for example, the receiving space 262 is defined by the load bracket 250 of the second mounting system 200 when the load bracket 250 is mounted to the load 30. In some embodiments, for example, the first mounting system 100 and the second mounting system 200 are co-operatively configured such that while the wall bracket 210 of the second mounting system 200 is mounted to the wall frame 20, and the load bracket 250 of the second mounting system 200 is mounted to the load 30, and the retainable flange 254 of the load bracket 250 of the second mounting system 200 is received in the receiving space 222 defined by the wall bracket 210 of the second mounting system 200, the retaining flange 214 of the second counterpart 210 of the second mounting system 200 is received in the receiving space 262 defined by the load bracket 250 of the second mounting system 200.

In some embodiments, for example, the retainable flange 154 is loosely received in the receiving space 122 defined by the wall bracket 110 of the first mounting system 100 while the wall bracket 110 of the first mounting system 100 is mounted to the wall frame 20. In this respect, while the retainable flange 154 is loosely received in the receiving space 122: (i) a gap is defined between the support 20 and the retainable flange 154, (ii) the retainable flange 154 and the retaining flange 114, and (iii) the retaining flange 114 and the load 30. In some embodiments, for example, the maximum width of the gap defined between the support 20 and the retainable flange 154 is 0.001 inches. In some embodiments, for example, the maximum width of the gap defined between the retainable flange 154 and the retaining flange 114 is 0.001 inches. In some embodiments, for example, the maximum width of the gap defined between the retaining flange 114 and the load 30 is 0.001 inches. In some embodiments, for example, the wall bracket 110 and the load bracket 150 of the first securing system 100 have a friction fit or interference fit engagement while the retainable flange 154 is received in the receiving space 122.

In some embodiments, for example, the retainable flange 254 is loosely received in the receiving space 222 defined by the wall bracket 210 of the second mounting system 200 when the wall bracket 210 of the second mounting system 200 is mounted to the wall frame 20. In this respect, while the retainable flange 254 is loosely received in the receiving space 222: (i) a gap is defined between the support 20 and the retainable flange 254, (ii) the retainable flange 254 and the retaining flange 214, and (iii) the retaining flange 214 and the load 30. In some embodiments, for example, the maximum width of the gap defined between the support 20 and the retainable flange 254 is 0.001 inches. In some embodiments, for example, the maximum width of the gap defined between the retainable flange 254 and the retaining flange 214 is 0.001 inches. In some embodiments, for example, the maximum width of the gap defined between the retaining flange 214 and the load 30 is 0.001 inches. In some embodiments, for example, the wall bracket 210 and the load bracket 250 of the second mounting system 200 have a friction-fit or interference-fit engagement when the retainable flange 254 is received in the receiving space 222.

In some embodiments, for example, where the retaining flange 114 is received in the receiving space 162, the retaining flange 114 is loosely received in the receiving space 162 defined by the load bracket 150 of the first mounting system 100 when the load bracket 150 of the first mounting system 100 is mounted to the load 30. In some embodiments, for example, the wall bracket 110 and the load bracket 150 of the first mounting system 100 have a friction fit or interference fit engagement when the retaining flange 114 is received in the receiving space 162.

In some embodiments, for example, where the retaining flange 214 is received in the receiving space 262, the retaining flange 214 is loosely received in the receiving space 262 defined by the load bracket 250 of the second mounting system 200 when the load bracket 250 of the second mounting system 200 is mounted to the load 30. In some embodiments, for example, the wall bracket 210 and the load bracket 250 of the second mounting system 200 have a friction fit or interference fit engagement when the retaining flange 214 is received in the receiving space 262.

As depicted in FIG. 2, FIG. 3, and FIG. 4, in some embodiments, for example, the first mounting system 100 and the second mounting system 200 are co-operatively configured such that while the wall bracket 110 of the first mounting system 100 is mounted to the wall frame 20, and the load bracket 150 of the first mounting system 100 is mounted to the load 30, and the retainable flange 154 of the load bracket 150 of the first mounting system 100 is received in the receiving space 122 defined by the wall bracket 110 of the first mounting system 100, a space 126 is defined between a lower end surface 164 of the retainable flange 154 of the load bracket 150 of the first mounting system 100 and the connecting member 116 of the wall bracket 110 of the first mounting system 100. In some embodiments, for example, the space 126 is defined between the lower end surface 164 of the retainable flange 154 of the load bracket 150 of the first mounting system 100 and the connecting member 116 of the wall bracket 110 of the first mounting system 100 while the load 30 is supported by the ledge 218.

As depicted in FIG. 2, FIG. 3, and FIG. 5, in some embodiments, for example, the first mounting system 100 and the second mounting system 200 are co-operatively configured such that while the wall bracket 210 of the second mounting system 200 is mounted to the wall frame 20, and the load bracket 250 of the second mounting system 200 is mounted to the load 30, and the retainable flange 254 of the load bracket 250 of the second mounting system 200 is received in the receiving space 222 defined by the wall bracket 210 of the second mounting system 200, a space 226 is defined between a lower end surface 264 of the retainable flange 254 of the load bracket 250 of the second mounting system 200 and the connecting member 216 of the wall bracket 210 of the second mounting system 200. In some embodiments, for example, the space 226 is defined between the lower end surface 264 of the retainable flange 254 of the load bracket 250 of the second mounting system 200 and the connecting member 216 of the wall bracket 210 of the second mounting system 200 while the load 30 is supported by the ledge 218.

As depicted in FIG. 2, FIG. 3, and FIG. 4, in some embodiments, for example, the first mounting system 100 and the second mounting system 200 are co-operatively configured such that while the wall bracket 110 of the first mounting system 100 is mounted to the wall frame 20, and the load bracket 150 of the first mounting system 100 is mounted to the load 30, and the retaining flange 114 of the wall bracket 110 of the first mounting system 100 is received in the receiving space 162 defined by the load bracket 150 of the first mounting system 100, a space 166 is defined between an upper end surface 124 of the retaining flange 114 of the wall bracket 110 of the first mounting system 100 and the connecting member 156 of the load bracket 150 of the first mounting system 100. In some embodiments, for example, the space 166 is defined between the upper end surface 124 of the retaining flange 114 of the wall bracket 110 of the first mounting system 100 and the connecting member 156 of the load bracket 150 of the first mounting system 100 while the load 30 is supported by the ledge 218.

As depicted in FIG. 2, FIG. 3, and FIG. 5, in some embodiments, for example, the first mounting system 100 and the second mounting system 200 are co-operatively configured such that while the wall bracket 210 of the second mounting system 200 is mounted to the wall frame 20, and the load bracket 250 of the second mounting system 200 is mounted to the load 30, and the retaining flange 214 of the wall bracket 210 of the second mounting system 200 is received in the receiving space 262 defined by the load bracket 250 of the second mounting system 200, a space 266 is defined between an upper end surface 224 of the retaining flange 214 of the wall bracket 210 of the second mounting system 200 and the connecting member 256 of the load bracket 250 of the second mounting system 200. In some embodiments, for example, the space 266 is defined between the upper end surface 224 of the retaining flange 214 of the wall bracket 210 of the second mounting system 200 and the connecting member 256 of the load bracket 250 of the second mounting system 200 while the load 30 is supported by the ledge 218.

In some embodiments, for example, while the load 30 is secured to the wall frame 20 using the system 10, the weight of the load 30 is substantially supported by ledge 218, while the weight of the load 30 is not supported by the retaining flange 114 of the wall bracket 110 of the first mounting system 100 and the support flange 214 of the wall bracket 210 of the second mounting system 200. In some embodiments, for example, the retaining flanges 114 and 214 only support the load 30 to resist displacement of load 30 away from the wall frame 20.

In some embodiments, for example, the wall bracket 110 and the load bracket 150 of the first mounting system 100 and the wall bracket 210 and the load bracket 250 of the second mounting system 200 are co-operatively configured, and the wall bracket 110 of the first mounting system 100, the load bracket 150 of the first mounting system 100, the wall bracket 210 of the second mounting system 200, the load bracket 250 of the second mounting system 200, the mountability of the wall bracket 110, of the first mounting system 150, to the wall frame 20, the mountability of the load bracket 150, of the first mounting system 100, to the load 30, the mountability of the wall bracket 210, of the second mounting system 200, to the wall frame 20, and the mountability of the load bracket 250, of the second mounting system 200, to the load 30 are co-operatively configured, such that: (1) a first receiving space 122 is defined between the wall frame 20 and the retaining flange 114 of the wall bracket 110 of the first mounting system 100, (2) the retainable flange 152 of the load bracket 150 of the first mounting system 100 is receivable within the first receiving space 122, (3) a second receiving space 222 is defined between the wall frame 20 and the retaining flange 214 of the wall bracket 210 of the second mounting system 200, (4) the retainable flange 254 of the load bracket 250 of the second mounting system 200 is receivable within the second receiving space 222, (5) and the ledge 218 is disposed for vertically supporting the load 30 while: (i) the retainable flange 154 of the load bracket 150 of the first mounting system 100 is disposed within the first receiving space 122, and (ii) the retainable flange 254 of the load bracket 250 of the second mounting system 200 is disposed within the second receiving space 222, such that the load 30 is mounted to the wall frame 20 via the first and second mounting systems 100 and 200.

In some embodiments, for example, the wall bracket 110 of the first mounting system 100, the load bracket 150 of the first mounting system 100, the wall bracket 210 of the second mounting system 200, the load bracket 250 of the second mounting system 200, the mountability of the wall bracket 110, of the first mounting system 100, to the wall frame 20, the mountability of the load bracket 150, of the first mounting system 100, to the load 30, the mountability of the wall bracket 210, of the second mounting system 200, to the wall frame 20, and the mountability of the load bracket 250, of the second mounting system 200, to the load 30 are further co-operatively configured, such that, while the load 30 is mounted to the wall frame 20 via the first and second mounting system 100 and 200, the retaining flange 114 of the wall bracket 110 of the first mounting system 100 is disposed in opposition to displacement of the retainable flange 154 of the load bracket 150 of the first mounting system 100 away from the wall frame 20; and the retaining flange 214 of the wall bracket 210 of the second mounting system 200 is disposed in opposition to displacement of the retainable flange 254 of the load bracket 250 of the second mounting system 200 away from the wall frame 20,

In some embodiments, for example, the wall bracket 110 of the first mounting system 100, the load bracket 150 of the first mounting system 100, the wall bracket 210 of the second mounting system 200, the load bracket 250 of the second mounting system 200, the mountability of the wall bracket 110, of the first mounting system 100, to the wall frame 20, the mountability of the load bracket 150, of the first mounting system 100, to the load 30, the mountability of the wall bracket 210, of the second mounting system 200, to the wall frame 20, and the mountability of the load bracket 250, of the second mounting system 200, to the load 30 are further co-operatively configured, such that, while the load 30 is mounted to the wall frame 20 via the first and second mounting system 100 and 200, the retaining flange 114 of the wall bracket 110 of the first mounting system 100 is opposing displacement of the retainable flange 154 of the load bracket 150 of the first mounting system 100 along an axis that is normal to a surface of the wall frame 20 to which the mounting flange 112 of the wall bracket 110 of the first mounting system 100 is mounted, and the retaining flange 214 of the wall bracket 210 of the second mounting system 200 is opposing displacement of the retainable flange 254 of the load bracket 250 of the second mounting system 200 along an axis that is normal to a surface of the wall frame 20 to which the mounting flange 212 of the wall bracket 210 of the second mounting system 200 is mounted.

In some embodiments, for example, the wall bracket 110 of the first mounting system 100, the load bracket 150 of the first mounting system 100, the wall bracket 210 of the second mounting system 200, the load bracket 250 of the second mounting system 200, the mountability of the wall bracket 110, of the first mounting system 100, to the wall frame 20, the mountability of the load bracket 150, of the first mounting system 100, to the load 30, the mountability of the wall bracket 210, of the second mounting system 200, to the wall frame 20, and the mountability of the load bracket 250, of the second mounting system 200, to the load 30 are further co-operatively configured, such that, while the load 30 is mounted to the wall frame 20 via the first and second mounting system 100 and 200, there is an absence of vertical support of the retainable flange 154 of the load bracket 150 of the first mounting system 100 by the wall bracket 110 of the first mounting system 100, and there is an absence of vertical support of the retainable flange 254 of the load bracket 250 of the second mounting system 200 by the wall bracket 210 of the second mounting system 200.

In some embodiments, for example, as depicted in FIG. 2 and FIG. 3, the first mounting system 100 is an upper mounting system for effecting mounting of an upper portion of the load 30 to the wall frame 20, and the second mounting system 200 is a lower mounting system for effecting mounting of a lower portion of the load 30 to the wall frame 20.

In some embodiments, for example, the mounting flange 152 of the load bracket 150 of the first mounting system 100 is mountable to an upper portion of the load 30, and the mounting flange 252 of the load bracket 250 of the second mounting system 200 is mountable to a lower portion of the load 30.

In some embodiments, for example, as depicted in FIG. 2 and FIG. 3 while the wall bracket 110 is mounted to the wall frame 20, the mounting flange 112 and the retaining flange 114 are extending vertically, and the surfaces 1121, 120, and 1201 define normal axes that extend horizontally.

In some embodiments, for example, while the load bracket 150 is mounted to the load 30 and the load 30 is mounted to the wall frame 20 via the mounting system 10, the mounting flange 152 and the retainable flange 154 are extending vertically, and the surfaces 1521, 160, and 1601 define normal axes that extend horizontally.

In some embodiments, for example, while the wall bracket 210 is mounted to the wall frame 20, the mounting flange 212 and the retaining flange 214 are extending vertically, and the surfaces 2121, 220, and 2201 define normal axes that extend horizontally.

In some embodiments, for example, while the load bracket 250 is mounted to the load 30 and the load 30 is mounted to the wall frame 20 via the mounting system 10, the mounting flange 252 and the retainable flange 254 are extending vertically, and the surfaces 2521, 260, and 2601 define normal axes that extend horizontally.

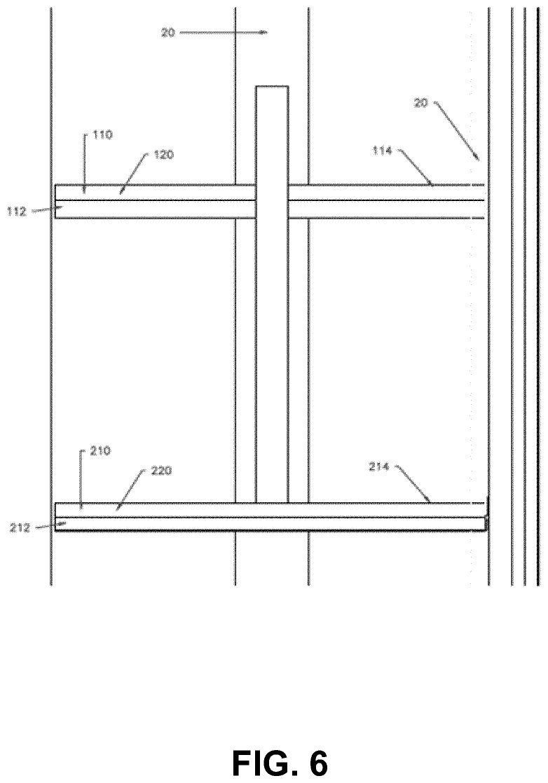

FIGS. 6 to 10 depict the mounting of a load 30, in particular a wall panel assembly 30, to a support 20, such as a stud 20 or a wall frame 20, using the system 10.

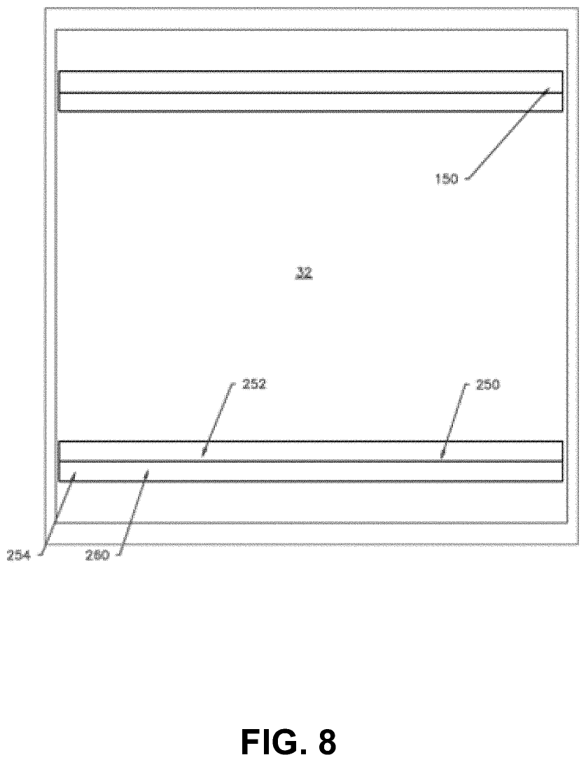

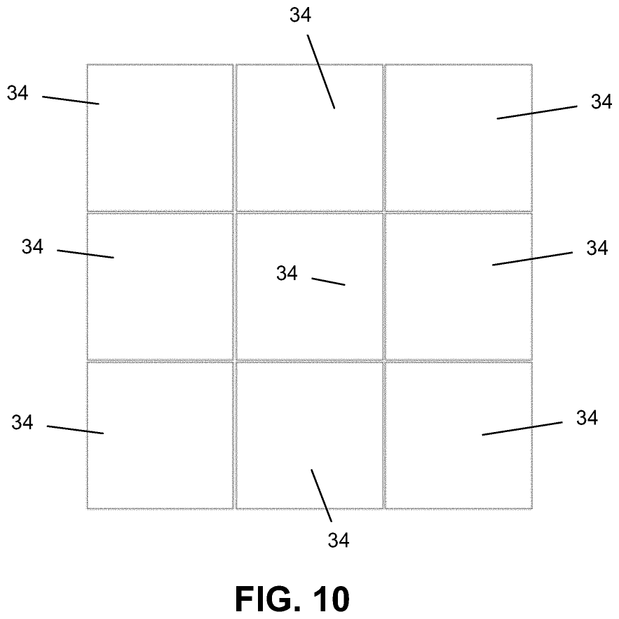

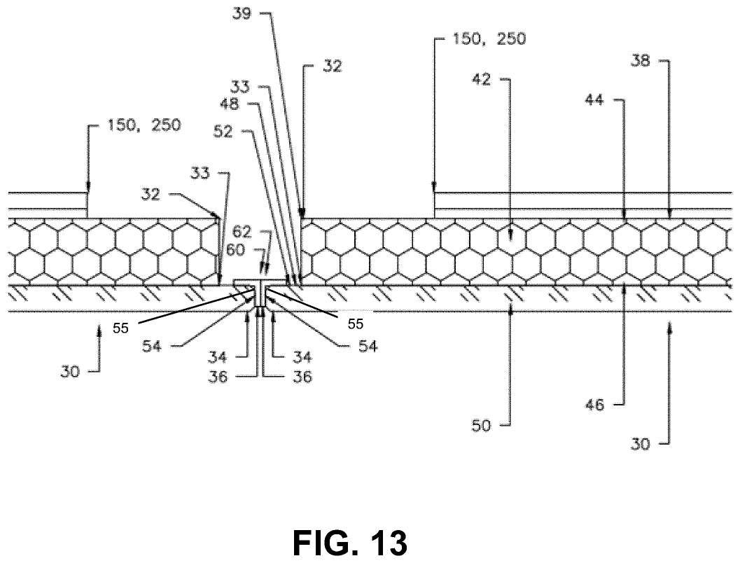

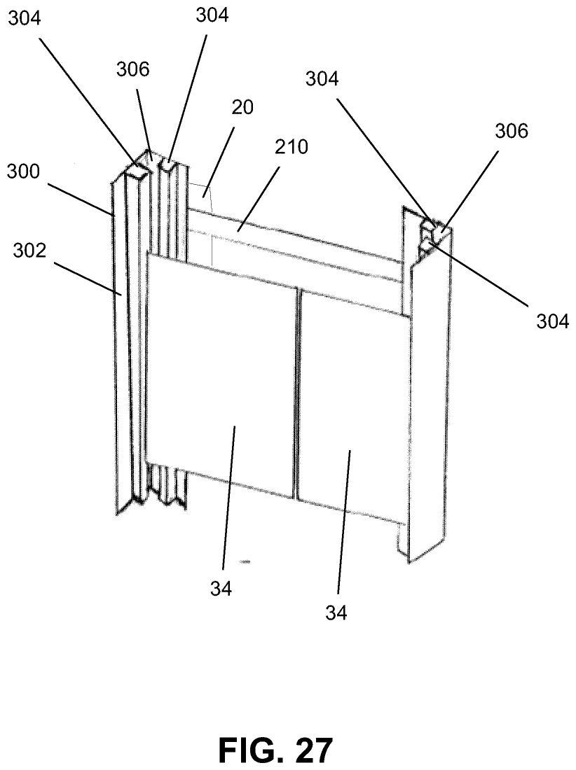

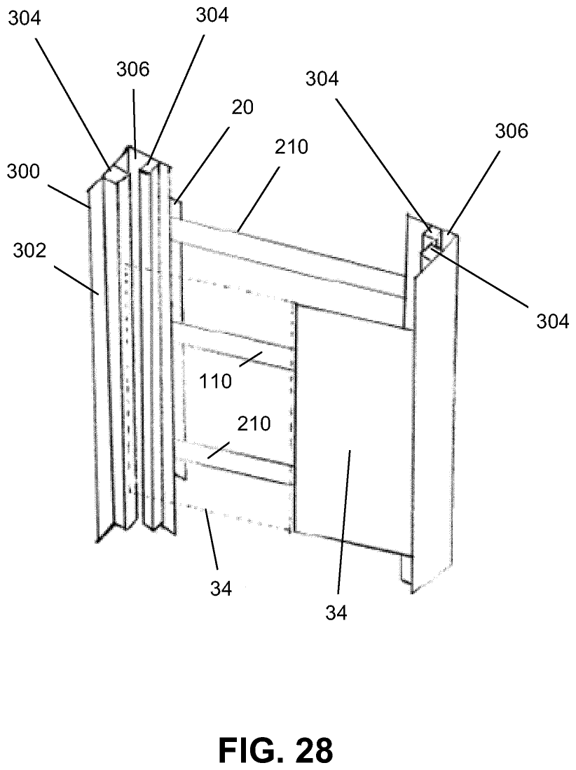

In some embodiments, for example, as depicted in FIG. 2, FIG. 3, FIG. 8, FIG. 10, FIG. 27, and FIG. 28, the load 30 is a wall panel assembly 30 that is configured to be mountable to a wall frame 20. In some embodiments, for example, the wall panel assembly 30 is configured to assemble a wall while one more wall panel assemblies 30 are mounted to the wall frame 20. In some embodiments, for example, the wall panel assembly 30 includes a wall panel 31 that is mountable to the wall frame 20. In some embodiments, for example, as depicted in FIG. 13, the wall panel 31 includes a reinforcing substrate 32 and a wall paneling 34 that is connected to the reinforcing substrate 32. In some embodiments, for example, the reinforcing substrate 32 and the wall paneling 34 are connected using an adhesive 33, such as a pressure-sensitive adhesive. In some embodiments, for example, the reinforcing substrate 32 has a body 38 with a rear surface 44 and a front surface 46 that is disposed on an opposite side of the front surface 44. In some embodiments, for example, the wall paneling 34 has a front surface 48 and a rear surface 50 that is disposed on an opposite side of the front surface 48. As depicted in FIG. 13, the reinforcing substrate 32 and the wall paneling 34 are connected together by connecting the surface 46 of the reinforcing substrate 32 and the surface 48 of the wall paneling 34 using the adhesive 33.

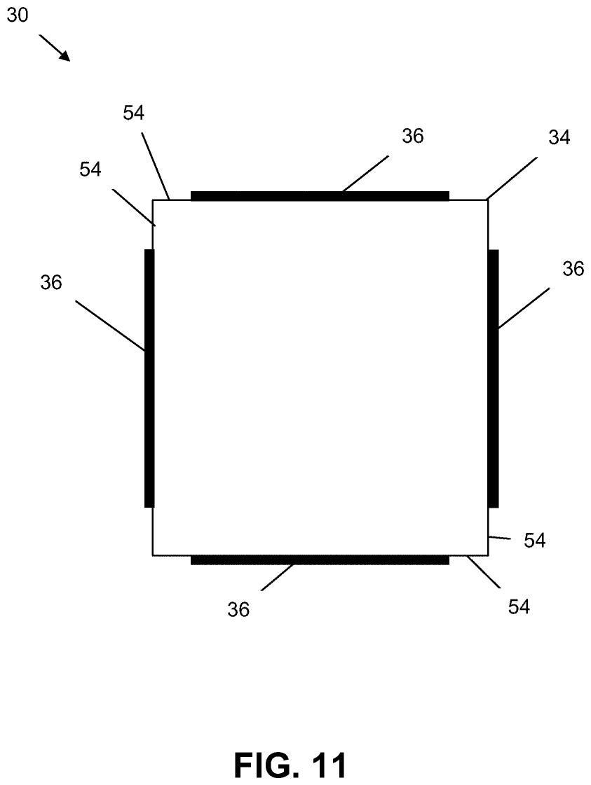

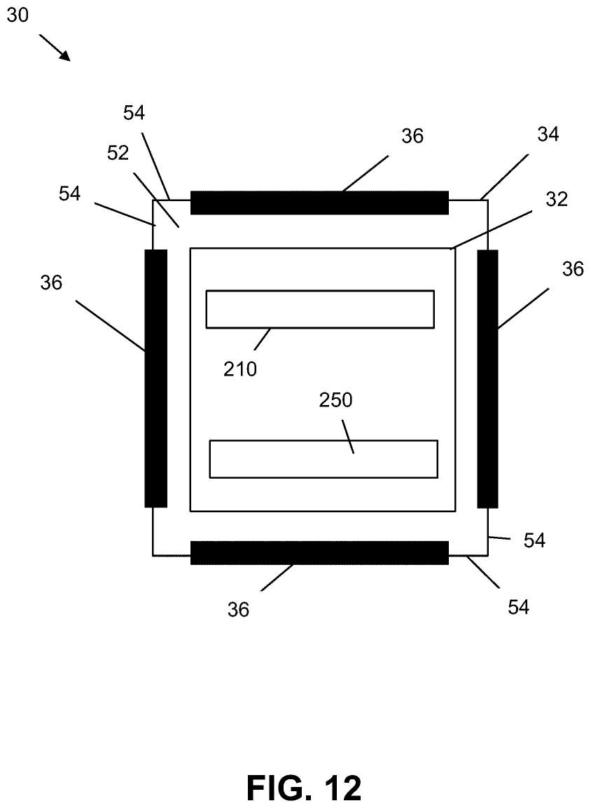

In some embodiments, for example, the front surface 50 has one or more sides, for example, four sides, as depicted in FIG. 11 and FIG. 12. In some embodiments, for example, the rear surface 48 has one or more sides that correspond to the sides of the front surface 50, for example, four corresponding sides, as depicted in FIG. 11 and FIG. 12. In some embodiments, for example, the front surface 50 and the rear surface 48 of the glass panel 34 are connected by corresponding side surfaces 54 that extend between corresponding sides of the front surface 50 and the rear surface 50. In some embodiments, for example, as depicted in FIG. 11 and FIG. 12, the glass panel 34 has four side surfaces 54.

In some embodiments, for example, the front surface 50 has a shape with one side, for example, a circle or an oval. In some embodiments, for example, the front surface 50 has a shape with more than one side, such as a triangle, square, quadrilateral, or a polygon. In some embodiments, for example, as depicted in FIG. 11 and FIG. 12, the front surface has a four-sided shape. In some embodiments, for example, the shape of the rear surface 48 corresponds to the shape of the front surface 50.

In some embodiments, for example, the surfaces 44 and 46 of the reinforcing substrate 32 have a shape that corresponds to the shape of the front surface 50. In some embodiments, for example, as depicted in FIG. 11 and FIG. 12, both the glass panel 34 and the reinforcing substrate 32 have a four-sided shape.

In some embodiments, for example, the reinforcing substrate 32 includes a honeycomb skeletal structure 42 within the body 38 to provide strength and rigidity to the reinforcing substrate 32, and to the load 30 while the reinforcing substrate 32 is connected to the wall paneling 34. In some embodiments, for example, the honeycomb skeletal structure 42 is interposed between the surfaces 44 and 46, such that the load bracket 150 of the first mounting system 100 and the load bracket 250 of the second mounting system 200 may be mounted to the reinforcing substrate 32 of the load 30, in particular, using the surface 44. In some embodiments, for example, the reinforcing substrate 32 is manufactured using metal, such as aluminum. Suitable example substrates 32 include the aluminum honeycomb panels supplied by Pacific Panel®.

In some embodiments, for example the wall paneling 34 is manufactured with glass, plastic, ceramic, steel, wood, aluminum, or a combination thereof. In some embodiments, for example, the wall paneling 34 is glass paneling.

In some embodiments, the wall panel assembly 30 includes a cushioning member 36. In some embodiments, for example, the cushioning member 36 is overlaying at least a portion of the side surface 54, such that at least a portion of a wall panel side surface 55 is defined by the cushioning member 36, as depicted in FIG. 13. In some embodiments, for example, the cushioning member 36 extends around the load 30, and in particular, around the wall paneling 34. In some embodiments, for example, the wall panel 30 includes one cushioning member 36 that overlays the entire perimeter edge of the glass panel 34. In some embodiments, for example, the wall panel 30 includes a cushioning member 36 for each one of the sides of the glass panel 34, such that a cushioning member 36 overlays at least a portion of the side surface 54.

In some embodiments, for example, the reinforcing substrate 32 and the wall paneling 34 are co-operatively configured while the reinforcing substrate 32 is connected to the wall paneling 34, an exposed surface portion 52 of the surface 48 of the wall paneling 34 is defined, the exposed surface portion 52 configured for mounting of the cushioning member 36 to the wall paneling 34, such that the cushioning member 36 may be connected to the wall paneling 34, in particular, on the surface portion 52, as depicted in FIG. 12 and FIG. 13. In some embodiments, for example, the reinforcing substrate 32 and the wall paneling 34 are co-operatively configured such that while the reinforcing substrate 32 is connected to the wall paneling 34, the surface portion 52 is defined around the entire reinforcing substrate 32, as depicted in FIG. 12. In some embodiments, for example, while the reinforcing substrate 32 is connected to the surface 48, a majority of the surface 48 is obscured by the reinforcing substrate 32.

In some embodiments, for example, the reinforcing substrate 32 includes at least one side surface 39, and the wall paneling 34 includes at least one side surface 54. In some embodiments, for example, the side surface 39 is a surface on the perimeter of the reinforcing substrate 32. In some embodiments, for example, the side surface 39 is a surface that extends between the front surface 46 and rear surface 44 of the reinforcing substrate 32. In some embodiments, for example, the side surface 54 is a surface on the perimeter of the wall paneling 34. In some embodiments, for example, the side surface 54 is a surface that extends between the front surface 50 and rear surface 48 of the wall paneling 34. The wall paneling 34 and the reinforcing substrate 32 are co-operatively configured such that, while the reinforcing substrate 32 is connected to the wall paneling 34, at least a portion of the surface portion 52 is defined between at least one side surface 39 of the reinforcing substrate 32 and at least one side surface 54 of the wall paneling 34. In some embodiments, for example, at least one side surface 39 of the reinforcing substrate 32 is offset from at least one side surface 54 of the wall paneling 34 to define the surface portion 52 between the side surface 39 and the side surface 54.

In some embodiments, for example, the cushioning member 36 is connected to the wall paneling 34, on the same surface of the wall paneling 34 as the reinforcing substrate 32, using adhesives, such as the surface 48, as depicted in FIG. 12. In some embodiments, for example, the cushioning member 36 is connected to the side surface 54 of the wall paneling 34. In some embodiments, for example, as depicted in FIG. 13, the cushioning member 36 is connected to the surface 48, such as the exposed surface portion 52, and to the side surface 54 of the wall paneling 34.

In some embodiments, for example, a cushioning member 36 is connected to one or more side surfaces 54 of the wall paneling 34. In some embodiments, for example, a cushioning member 36 is connected to all side surfaces 54 of the wall paneling 34, such that the cushioning member 36 extends around the wall panel assembly 30, and in particular, around the wall paneling 34. In some embodiments, for example, a cushioning member 36 is connected to each of one or more side surfaces 54 of the wall paneling 34.

In some embodiments, for example, a side surface 54 of a wall paneling 34 of a first load 30, such as a first wall panel assembly 30, is configured to be disposed opposite to a side surface 54 of a wall paneling 34 of a second load 30, such as a second wall panel assembly 30, that is positioned adjacent the first load 30. In some embodiments, for example, a side surface 54 of a wall paneling 34 of a first load 30, such as a first wall panel assembly 30, is configured to be disposed opposite to a side surface 54 of a wall paneling 34 of a second load 30, such as a second wall panel assembly 30, while the first wall panel assembly 30 is mounted adjacent to the second wall panel assembly 30 on a wall frame 20, such as one or more studs, wall, or a supporting member 20, using the system 10.

In some embodiments, for example, the wall panel side surface portion 55 is configured for becoming disposed in abutting engagement with a side surface portion 55 of another wall panel 30.

In some embodiments, for example, the cushioning member 36 is configured to protect the side surfaces 54 of the glass panel 34. In some embodiments, for example, while the wall panel side surface portion 55 is disposed in engagement with a side surface portion 55 of another wall panel 30, such that the cushioning member 36 is engaged to the other wall panel 30, the cushioning member 36 experiences more stress than the glass panel 34. In some embodiments, for example, in response to engagement, the cushioning member 36 is compressed or is deformed. In this regard, the glass panel 34 experiences less stress, and is protected from damage or wear and tear, for example, while the glass panel 34 is installed.

In some embodiments, for example, the cushioning member 36 is a silicone rubber sealant.

In some embodiments, for example, while adjacent wall panels 30 are joined, for example, butt-joined, abutting cushioning members 36 of the adjacent wall panels 30 are joined and control flow of sound and temperature through the abutting cushioning members 36.

In some embodiments, for example, the cushioning members 36 are configured to protect the glass panel 34, and also configured to control sound and temperature between two wall panels 30 when cushioning members 36 of the two wall panels 30 are abutting against each other.

The cushioning member 36 is configured to provide a seal 62 at an interface 60 defined between two loads 30, for example, two wall panel assemblies 30, as depicted in FIG. 10 and FIG. 13. In some embodiments, for example, the cushioning member 36 of a first wall panel assembly 30 is configured to abut a cushioning member 36 of a second wall panel assembly 30 that is positioned adjacent the first wall panel assembly 30. While the cushioning member 36 of the first wall panel assembly 30 is abutting the cushioning member 36 of the second wall panel assembly 30 that is positioned adjacent the first wall panel assembly 30, the abutting cushioning members 36 define a seal 62 that seals the interface 60 defined between the two wall panel assemblies 30, as depicted in FIG. 13.

In some embodiments, for example, the cushioning member 36 meets the fire rating standard E-84.

In some embodiments, for example, the seal 62 is configured to function as acoustics and temperature control for a room in which the wall panels 30 are installed, by sealing the gap in between two wall panels 30.

In some embodiments, for example, the cushioning member 36 is defined by a gasket or seal, or is defined by more than one gasket or seal.

In some embodiments, for example, where the load 30, for example, the wall panel assembly 30, which includes the reinforcing substrate 32, the wall paneling 34, and the cushioning member 36, is pre-assembled prior to delivery to the construction site, on-site assembly of the wall panel assembly 30, which may include applying adhesive or silicone to the wall paneling 34 to connect the reinforcing substrate 32 or the cushioning member 36, may be avoided or reduced.

The system 10, the wall frame 20, and the load 30 are co-operatively configured to mount the load 30 to the wall frame 20 using the system 10.

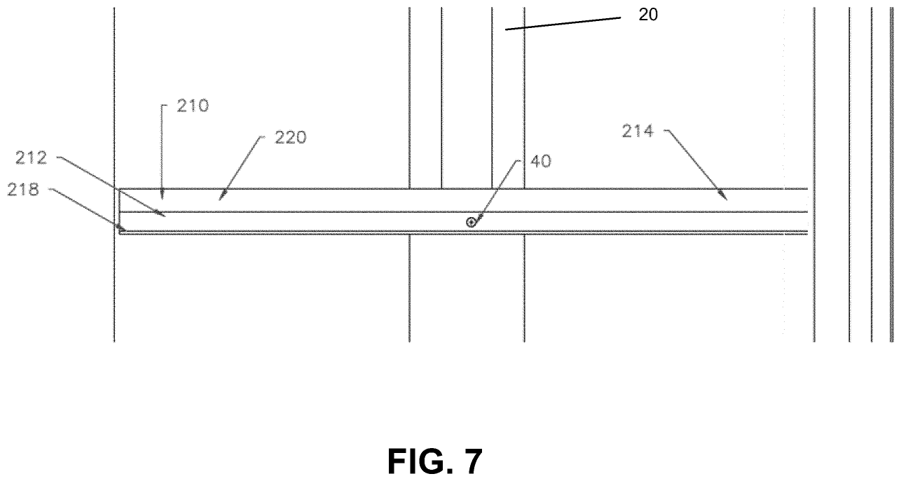

As depicted in FIG. 6 and FIG. 7, the wall bracket 110 of the first mounting system 100 and the wall bracket 210 of the second mounting system 200 are connected to the support 20, for example, studs 20 or a wall frame 20. In some embodiments, for example, the wall bracket 110 of the first mounting system 100 and the wall bracket 210 of the second mounting system 200 are connected to at least two studs 20 using fasteners. In some embodiments, for example, as depicted in FIG. 6, the wall bracket 110 of the first mounting system 100 is positioned above the wall bracket 210 of the second mounting system 200 when the wall bracket 110 of the first mounting system 100 and the wall bracket 210 of the second mounting system 200 are connected to studs 20.

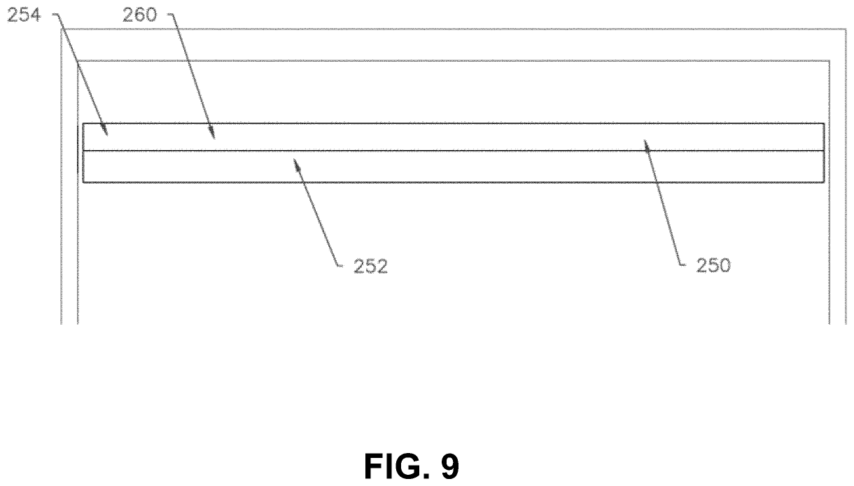

As depicted in FIG. 8 and FIG. 9, the load bracket 150 of the first mounting system 100 and the load bracket 250 of the second mounting system 200 are connected to the load 30, such as the exposed surface 44 of the reinforcing substrate 32. In some embodiments, for example, the load bracket 150 of the first mounting system 100 and the load bracket 250 of the second mounting system 200 are connected to the reinforcing substrate 32 at multiple points using fasteners 40. In some embodiments, for example, as depicted in FIG. 8, the load bracket 150 of the first mounting system 100 is positioned above the load bracket 250 of the second mounting system 200 when the load bracket 150 of the first mounting system 100 and the load bracket 250 of the second mounting system 200 are connected to the load 30. In some embodiments, the distance between the wall bracket 110 of the first mounting system 100 and the wall bracket 210 of the second mounting system 200 is the same, or generally similar, to the distance between the load bracket 150 of the first mounting system 100 and the load bracket 250 of the second mounting system 200.

With the wall bracket 110 of the first mounting system 100 and the wall bracket 210 of the second mounting system 200 connected to supports 20, such as studs 20 or a wall frame 20, and the load bracket 150 of the first mounting system 100 and the load bracket 250 of the second mounting system 200 are connected to the load 30, the load 30 is disposed such that the load bracket 150 of the first mounting system 100 and the load bracket 250 of the second mounting system 200 are positioned over the wall bracket 110 of the first mounting system 100 and the wall bracket 210 of the second mounting system 200, respectively. In some embodiments, for example, the load 30 is lifted a distance that is at least the height or vertical length of the retaining flange 114 of the wall bracket 110 of the first mounting system 100 or the retaining flange 214 of the wall bracket 210 of the second mounting system 200. The load 30 is then lowered such that the retainable flange 154 of the load bracket 150 of the first mounting system 100 is received in the receiving space 122 defined by the wall bracket 110 of the first mounting system 100, the retainable flange 254 of the load bracket 250 of the second mounting system 200 is received in the receiving space 222 defined by the load bracket 210 of the second mounting system 200, and the load 30 is supported by the ledge 218. In some embodiments, for example, the retainable flange 154 of the load bracket 150 of the first mounting system 100 is loosely received in the receiving space 122 defined by the wall bracket 110 of the first mounting system 100, the retainable flange 254 of the load bracket 250 of the second mounting system 200 is loosely received in the receiving space 222 defined by the wall bracket 210 of the second mounting system 200, and the load 30 is supported by the ledge 218. In such embodiments, for example, the load 30 is loosely secured to the wall frame 20 while being supported by the ledge 218.

In some embodiments, for example, while the load 30 is supported by the ledge 218, the retaining flange 114 of the wall bracket 110 of the first mounting system 100 is received, or loosely received, in the receiving space 162 defined by the load bracket 150 of the first mounting system 100.

In some embodiments, for example, while the load 30 is supported by the ledge 218, the retaining flange 214 of the wall bracket 210 of the second mounting system 200 is received, or loosely received, in the receiving space 262 defined by the load bracket 250 of the second mounting system 200.

In some embodiments, for example, while the load 30 is supported by the ledge 218, the space 126 is defined between the lower end surface 164 of the retainable flange 154 of the load bracket 150 of the first mounting system 100 and the connecting member 116 of the wall bracket 110 of the first mounting system 100.

In some embodiments, for example, while the load 30 is supported by the ledge 218, the space 226 is defined between the lower end surface 264 of the retainable flange 254 of the load bracket 250 of the second mounting system 200 and the connecting member 216 of the wall bracket 210 of the second mounting system 200.

In some embodiments, for example, while the load 30 is supported by the ledge 218, the space 166 is defined between the upper end surface 124 of the retaining flange 114 of the wall bracket 110 of the first mounting system 100 and the connecting member 156 of the load bracket 150 of the first mounting system 100.

In some embodiments, for example, while the load 30 is supported by the ledge 218, the space 266 is defined between the upper end surface 224 of the retaining flange 214 of the wall bracket 210 of the second mounting system 200 and the connecting member 256 of the load bracket 250 of the second mounting system 200.

At this point, with the load 30 secured to the wall frame 20, the weight of the load 30 is supported by the ledge 218, while the retaining flange 114 of the wall bracket 110 of the first mounting system 100 and the retaining flange 214 of the wall bracket 210 of the second mounting system 200 resists displacement of the load 30 away from the wall frame 20.

When the load 30 is secured to the wall frame 20, the wall paneling 34 is facing outwardly, such that the wall paneling 34 is seen while obscuring the wall frame 20 from view. In some embodiments, for example, where the load 30 is the wall panel assembly 30, the system 10 and the wall panel assembly 30 are co-operatively configured such that while the wall panel assembly 30 is mounted to the wall frame 20, the wall panel assembly 30 occludes, or partially occludes, the wall frame 20 or a portion of the wall frame 20. In some embodiments, for example, the wall panel assembly 30, while mounted on the wall frame 20, obscures the wall frame 20 or a portion of the wall frame 20 from view. From the perspective of an observer standing in front of the wall frame 20 and looking at the wall panel assembly 30, the system 10 and the wall panel assembly 30 are co-operatively configured such that while the wall panel assembly 30 is mounted to the wall frame 20, the surface 50 of the wall paneling 34 is facing outwardly relative to the wall frame 20, such that the surface 50 of the wall paneling 34 is visible while the wall panel assembly 30 occludes the wall frame 20 or a portion of the wall frame 20, or obscures the wall frame 20 or a portion of the wall frame 20 from view.

In some embodiments, for example, the system 10, the wall frame 20, and the load 30 are co-operatively configured such that while the load 30 is mounted to the wall frame 20 using the system 10, the system 10 resists tilting, pivoting, or rotating of the load 30 relative to the wall frame 20.

In some embodiments, for example, while the wall bracket 110 of the first mounting system 100 is mounted to the wall frame 20, and the load bracket 150 of the first mounting system 100 is mounted to the load 30, and the retainable flange 154 of the load bracket 150 of the first mounting system 100 is received in the receiving space 122 defined by the wall bracket 110 of the first mounting system 100 and the wall frame 20, the wall frame 20, the retaining flange 114 of the wall bracket 110 of the first mounting system 100, and the retainable flange 154 of the load bracket 150 of the first mounting system 100 are co-operatively configured to resist tilting, pivoting, or rotating of the load 30 relative to the wall frame 20.

In some embodiments, for example, while the wall bracket 210 of the second mounting system 200 is mounted to the wall frame 20, and the load bracket 250 of the second mounting system 200 is mounted to the load 30, and the retainable flange 254 of the load bracket 250 of the second mounting system 200 is received in the receiving space 222 defined by the wall bracket 210 of the second mounting system 200 and the wall frame 20, the wall frame 20, the retaining flange 214 of the wall bracket 210 of the second mounting system 200, and the retainable flange 254 of the load bracket 250 of the second mounting system 200 are co-operatively configured to resist tilting, pivoting, or rotating of the load 30 relative to the wall frame 20.

In some embodiments, for example, while the wall bracket 110 of the first mounting system 100 is mounted to the wall frame 20, and the load bracket 150 of the first mounting system 100 is mounted to the load 30, and the retaining flange 114 of the wall bracket 110 of the first mounting system 100 is received in the receiving space 162 defined by the load bracket 150 of the first mounting system 100 and the load 30, the load 30, the retaining flange 114 of the wall bracket 110 of the first mounting system 100, and the retainable flange 154 of the load bracket 150 of the first mounting system 100 are co-operatively configured to resist tilting, pivoting, or rotating of the load 30 relative to the wall frame 20.

In some embodiments, for example, while the wall bracket 210 of the second mounting system 200 is mounted to the wall frame 20, and the load bracket 250 of the second mounting system 200 is mounted to the load 30, and the retaining flange 214 of the wall bracket 210 of the second mounting system 200 is received in the receiving space 262 defined by the load bracket 250 of the second mounting system 200 and the load 30, the load 30, the retaining flange 214 of the wall bracket 210 of the second mounting system 200, and the retainable flange 254 of the load bracket 250 of the second mounting system 200 are co-operatively configured to resist tilting, pivoting, or rotating of the load 30 relative to the wall frame 20.

In some embodiments, for example, where the load 30 is the wall panel assembly 30, the system 10, the wall frame 20, and the wall panel assembly 30 are co-operatively configured such that while the wall panel assembly 30 is mounted to the wall frame 20 using the system 10, the wall panel 34 is generally parallel relative to the wall frame 20, and the system 10 resists tilting, pivoting, or rotating of the wall panel assembly 30 relative to the wall frame 20, such that the relative generally parallel disposition of the wall frame 20 and the wall panel 34 of the wall panel assembly 30 is maintained by the system 10.

A plurality of loads 30, for example, wall panels 30 that include the reinforcing substrate 32 and the glass panel 34, may be secured to wall frames 20 or studs 20 using the system 10 as described herein to install a wall defined by a plurality of wall panels 30, with the cushioning member 36 disposed between the glass panels 34, as depicted in FIG. 10, FIG. 27, and FIG. 28. In some embodiments, for example, each one of the wall panels 30, independently, is a composite panel, the composite panel including a glass panel 34 and a reinforcing substrate 32 connected to the rear surface 48 of the glass panel 34.

In some embodiments, where the load 30 is loosely secured to the wall frame 20, the load 30 may be lifted to disengage the wall bracket 110 and the load bracket 150 of the first mounting system 100 and the wall bracket 210 and the load bracket 250 of the second mounting system 200.

In some embodiments, for example, while the load 30 is mounted to the wall frame 20 with the system 10, the load 30 is dismountable from the wall frame 20. In some embodiments, for example, the system 10, the wall frame 20, and the load 30 are co-operatively configured such that while the load 30 is mounted to the wall frame 20 using the system 10, the load 30 is dismountable from the wall frame 20. In some embodiments, for example, while the load 30 is mounted to the wall frame 20, the load 30 is lifted relative to the wall frame 20, and in particular, the load bracket 150 of the first mounting system 100 and the load bracket 250 of the second mounting system 200 that are mounted to the load 30 are lifted relative to the wall bracket 110 of the first mounting system 100 and the wall bracket 210 of the second mounting system 200 that are mounted to the wall frame 20, to disengage, de-couple, or separate the wall bracket 110 and the load bracket 150 of the first connecting system 100 and the wall bracket 210 and the load bracket 250 of the second mounting system 200, such that the mounting of the load 30 to the wall frame 20 by the system 10 is absent. In some embodiments, for example, the load 30 is lifted such that the support of the load 30 by the ledge 218 is absent, and that the mounting of the load 30 to the wall frame 20 by the system 10 is absent.

In some embodiments, for example, while the retainable flange 154 of the load bracket 150 of the first mounting system 100 is received in the receiving space 122 defined by the wall bracket 110 of the first mounting system 100, the retainable flange 154 is retractable or withdrawable from the receiving space 122, for example, by lifting the load 30 relative to the wall bracket 110 of the first mounting system 100 and the wall bracket 210 of the second mounting system 200.

In some embodiments, for example, while the retainable flange 254 of the load bracket 250 of the second mounting system 200 is received in the receiving space 222 defined by the wall bracket 210 of the second mounting system 200, the retainable flange 254 is retractable or withdrawable from the receiving space 222, for example, by lifting the load 30 relative to the wall bracket 110 of the first mounting system 100 and the wall bracket 210 of the second mounting system 200.

In some embodiments, for example, while the retaining flange 114 of the wall bracket 110 of the first mounting system 100 is received in the receiving space 162 defined by the load bracket 150 of the first mounting system 100, the retaining flange 114 is retractable or withdrawable from the receiving space 162, for example, by lifting the load 30 relative to the wall bracket 110 of the first mounting system 100 and the wall bracket 210 of the second mounting system 200.

In some embodiments, for example, while the retaining flange 214 of the wall bracket 210 of the second mounting system 200 is received in the receiving space 262 defined by the load bracket 250 of the second mounting system 200, the retaining flange 214 is retractable or withdrawable from the receiving space 222, for example, by lifting the load 30 relative to the wall bracket 110 of the first mounting system 100 and the wall bracket 210 of the second mounting system 200.

In some embodiments, for example, the wall frame 20 defines one or more portions, for example, a left side or portion, a right side or portion, a top or upper portion, or a bottom or lower portion.

In some embodiments, for example, while the load 30 is mounted to the wall frame 20 and disposed at first portion of the wall frame 20 via the first mounting system 100 and the second mounting system 200, in some embodiments, for example, the load 30 is dismountable from the wall frame 20 and is re-positionable relative to a second portion of the wall frame 20, and the load 30 is re-mountable to the second portion of the wall frame 20 via the first mounting system 100 and the second mounting system 200 of the system 10.

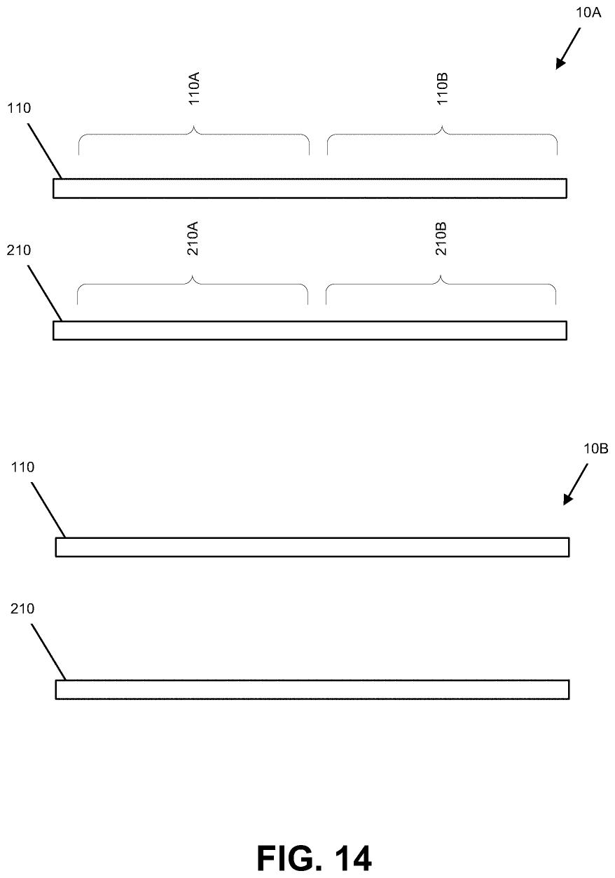

In some embodiments, for example, the wall bracket 110 of the first mounting system 100 is defined by more than one portion, for example, a first portion of the wall bracket 110A of the first mounting system 100 and a second portion of the wall bracket 110B of the first mounting system 100, as depicted in FIG. 14. In some embodiments, for example, the first portion of the wall bracket 110A of the first mounting system 100 and the second portion of the wall bracket 110B of the first mounting system 100 are connected. In some embodiments, for example, the first portion of the wall bracket 110A of the first mounting system 100 and the second portion of the wall bracket 110B of the first mounting system 100 are of unitary one-piece construction, and the second portion of the wall bracket 110B of the first mounting system 100 extends from the first portion of the wall bracket 110A of the first mounting system 100. In some embodiments, for example, while the wall bracket 110 is mounted to the wall frame 20, the first portion of the wall bracket 110A is disposed at a first portion of the wall frame 20, for example, the left side of the wall frame 20, and the second portion of the wall bracket 110B is disposed at a second portion of the wall frame 20, for example, the right side of the wall frame 20.

In some embodiments, for example, the wall bracket 210 of the second mounting system 200 is defined by more than one portion, for example, a first portion of the wall bracket 210A of the second mounting system 200 and a second portion of the wall bracket 210B of the second mounting system 200, as depicted in FIG. 14. In some embodiments, for example, the first portion of the wall bracket 210A of the second mounting system 200 and the second portion of the wall bracket 210B of the second mounting system 200 are connected. In some embodiments, for example, the first portion of the wall bracket 210A of the second mounting system 200 and the second portion of the wall bracket 210B of the second mounting system 200 are of unitary one-piece construction, and the second portion of the wall bracket 210B of the second mounting system 200 extends from the first portion of the wall bracket 210A of the second mounting system 200. In some embodiments, for example, while the wall bracket 210 is mounted to the wall frame 20, the first portion of the wall bracket 210A is disposed at a first portion of the wall frame 20, for example, the left side of the wall frame 20, and the second portion of the wall bracket 210B is disposed at a second portion of the wall frame 20, for example, the right side of the wall frame 20.

In some embodiments, for example, to dispose the load 30 at a desired portion of the support 30, the load 30 is mounted to the wall frame 20 via a portion of the wall bracket 110A and a portion of the wall bracket 210A that are disposed at the desired portion of the support 30 while the wall bracket 110 and the wall bracket 210 are mounted to the wall frame 20.

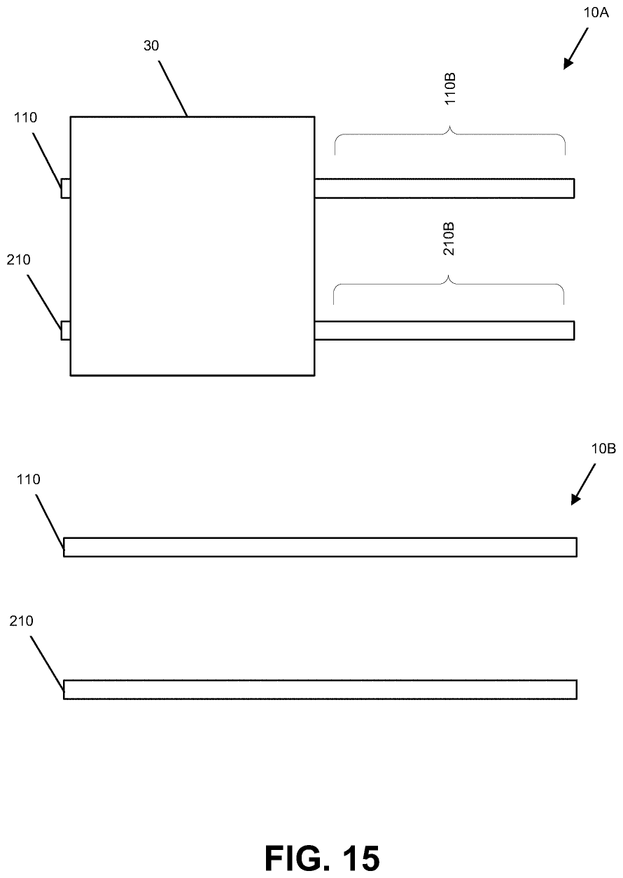

In some embodiments, for example, the first portion of the wall bracket 110A of the first mounting system 100, the load bracket 150 of the first mounting system 100, the first portion of the wall bracket 210A of the second mounting system 200, and the load bracket 250 of the second mounting system 200 are co-operatively configured to mount the load 30 to the wall frame 20, for example, to the first portion of the wall frame 20, as depicted in FIG. 15. While the load 30 is mounted to the wall frame 20 via the first portion of the wall bracket 110A of the first mounting system 100, the load bracket 150 of the first mounting system 100, the first portion of the wall bracket 210A of the second mounting system 200, and the load bracket 250 of the second mounting system 200, the load 30 is disposed at a portion of the wall frame 20. In some embodiments, for example, the load 30 is disposed at a left side or a left portion of the wall frame 20.

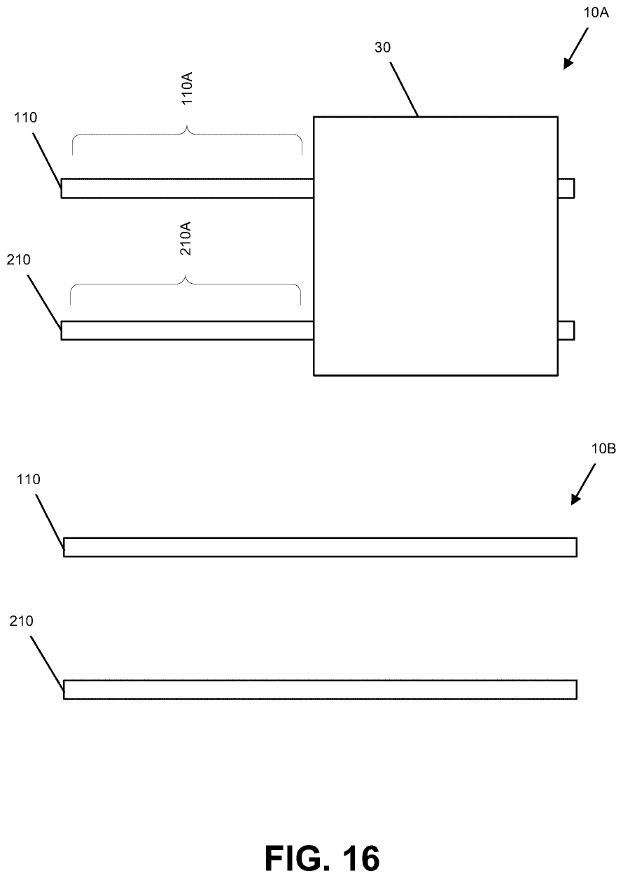

In some embodiments, for example, as depicted in FIG. 15 and FIG. 16, the load 30 is dismountable from the first portion of the wall frame 20, and re-positionable relative to the second portion of the wall frame 20 and relative to the second portion of the wall bracket 110B of the first mounting system 100 and the second portion of the wall bracket 210B of the second mounting system 200. In some embodiments, for example, the second portion of the wall bracket 110B of the first mounting system 100, the load bracket 150 of the first mounting system 100, the second portion of the wall bracket 210B of the second mounting system 200, and the load bracket 250 of the second mounting system 200 are co-operatively configured to mount the load 30 to the wall frame 20, for example, to the second portion of the wall frame 20, as depicted in FIG. 16. In some embodiments, for example, while the load 30 is mounted to a left portion of the wall frame 20, the load 30 is re-positioned from the left side of the wall frame 20 to be disposed at a right side or right portion of the wall frame 20.

In some embodiments, for example, while the load 30 is mounted to the wall frame 20 via a first mounting system 100 and a second mounting system 200 of a first system 10, in some embodiments, for example, the load 30 is dismountable from the wall frame 20 and is re-positionable relative to a first mounting system 100 and a second mounting system 200 of a second system 10, and the load 30 is re-mountable to a wall frame 20 via the first mounting system 100 and the second mounting system 200 of the second system 10. In some embodiments, for example, the first wall bracket 110 and the second wall bracket 210 of the first system 10 is mounted to a first wall frame 20, and the first wall bracket 110 and the second wall bracket 210 of the second system 10 is mounted to the same wall frame 20 as the first wall bracket 110 and the second wall bracket 210 of the first system 10. In some embodiments, for example, the first wall bracket 110 and the second wall bracket 210 of the first system 10 and the first wall bracket 110 and the second wall bracket 210 of the second system 10 are mounted on different supports 20.

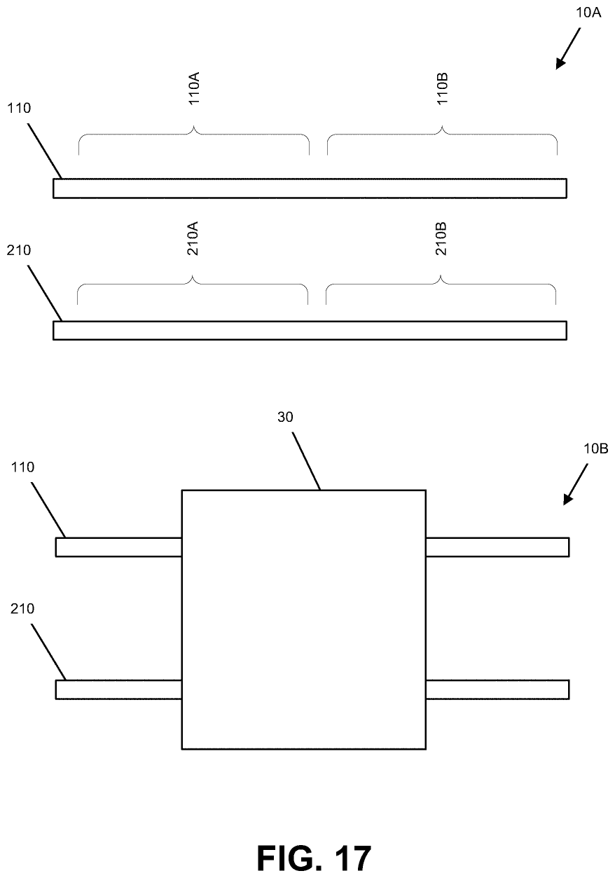

In some embodiments, for example, as depicted in FIG. 17, the system 10 for mounting the load 30 to the wall frame 20, which includes the first mounting system 100 and the second mounting system 200, is a first system 10A for mounting the load 30 to the wall frame 20. In some embodiments, for example, there is a second system 10B for mounting the load 30 to the wall frame 20. Similar to the first system 10A, the second system 10B includes a first mounting system 100 and a second mounting system 200. The first mounting system 100 of the second system 10B includes a wall bracket 110 and a load bracket 150, which is substantially the same as the wall bracket 110 and the load bracket 150 of the first mounting system 100 of the first system 10A. The second mounting system 200 of the second system 10B includes a wall bracket 210 and a load bracket 250, which is substantially the same as the wall bracket 210 and the load bracket 250 of the second mounting system 200 of the first system 10A.

Similar to the wall bracket 110 of the first mounting system 100 of the first system 10A, the wall bracket 110 of the first mounting system 100 of the second system 10B includes a mounting flange 112, a retaining flange 114, and a connecting member 116 that extends between the mounting flange 112 and the retaining flange 114. While the wall bracket 110 of the first mounting system 100 of the second system 10B is mounted to the wall frame 20, a receiving space 122 is defined between the wall frame 20 and the retaining flange 114.

Similar to the load bracket 150 of the first mounting system 100 of the first system 10A, the load bracket 150 of the first mounting system 100 of the second system 10B includes a mounting flange 152, a retainable flange 154, and a connecting member 156 that extends between the mounting flange 152 and the retainable flange 154. While the load bracket 150 of the first mounting system 100 is mounted to the load 30, a receiving space 162 is defined between the load 30 and the retainable flange 154.

Similar to the wall bracket 210 of the second mounting system 200 of the first system 10A, the wall bracket 210 of the second mounting system 200 of the second system 10B includes a mounting flange 212, a retaining flange 214, and a connecting member 216 that extends between the mounting flange 212 and the retaining flange 214. While the wall bracket 210 of the second mounting system 200 of the second system 10B is mounted to the wall frame 20, a receiving space 222 is defined between the wall frame 20 and the retaining flange 114. Similar to the wall bracket 210 of the second mounting system 200 of the first system 10A, the wall bracket 210 of the second mounting system 200 of the second system 10B includes a ledge 218 that is configured to support the load 30. In some embodiments, for example, the ledge 218 is configured for the load 30 to sit on or rest on the ledge 218. In some embodiments, for example, a sealing member 217 is disposed on the ledge 218 to reduce damage to the ledge 218 and the load 30 while the load 30 is supported on the ledge 218.

Similar to the load bracket 250 of the second mounting system 200 of the first system 10A, the load bracket 250 of the second mounting system 200 of the second system 10B includes a mounting flange 252, a retainable flange 254, and a connecting member 256 that extends between the mounting flange 252 and the retainable flange 254. While the load bracket 250 of the second mounting system 200 is mounted to the load 30, a receiving space 262 is defined between the load 30 and the retainable flange 254.

In some embodiments, for example, the load bracket 150 of the first mounting system 100 of the first system 10A is the load bracket 150 of the first mounting system 100 of the second system 10B. In some embodiments, for example, the load bracket 250 of the second mounting system 200 of the first system 10A is the load bracket 250 of the second mounting system 200 of the second system 10B.

In some embodiments, for example, the wall bracket 110 of the first mounting system 100 of the second system 10B and the wall bracket 210 of the second mounting system 200 of the second system 10B are mounted on a portion of the wall frame 20 that is different from the portion of the wall frame 20 on which the wall bracket 110 of the first mounting system 100 of the first system 10A and the wall bracket 210 of the second mounting system 200 of the first system 10A are mounted. For example, as depicted in FIG. 17, the wall bracket 110 of the first mounting system 100 and the wall bracket 210 of the second mounting system 200 of the first system 10A are mounted to an upper portion of the wall frame 20, and the wall bracket 110 of the first mounting system 100 and the wall bracket 210 of the second mounting system 200 of the second system 10B are mounted to a lower portion of the wall frame 20.

In some embodiments, for example, the wall bracket 110 of the first mounting system 100 of the second system 10B and the wall bracket 210 of the second mounting system 200 of the second system 10B are mounted on a wall frame 20 that is different from the wall frame 20 on which the wall bracket 110 of the first mounting system 100 of the first system 10A and the wall bracket 210 of the second mounting system 200 of the first system 10A are mounted. For example, the wall bracket 110 of the first mounting system 100 and the wall bracket 210 of the second mounting system 200 of the first system 10A are mounted to a wall frame 20 corresponding to a first side of a room, and the wall bracket 110 of the first mounting system 100 and the wall bracket 210 of the second mounting system 200 of the second system 10B are mounted to a wall frame 20 corresponding to a second side of a room that is different from the first side of the room. As another example, the wall bracket 110 of the first mounting system 100 and the wall bracket 210 of the second mounting system 200 of the first system 10A are mounted to a wall frame 20 of a first room, and the wall bracket 110 of the first mounting system 100 and the wall bracket 210 of the second mounting system 200 of the second system 10B are mounted to a wall frame 20 of a second room that is different from the first room.

In some embodiments, for example, as depicted in FIG. 15, FIG. 16, and FIG. 17, the load 30 is dismountable from the wall frame 20 on which the wall bracket 110 of the first mounting system 100 and the wall bracket 210 of the second mounting system 200 of the first system 10A, and re-positionable relative to the wall bracket 110 of the first mounting system 100 and the wall bracket 210 of the second mounting system 200 of the second system 10B and relative to the wall frame 20 on which the wall bracket 110 of the first mounting system 100 and the wall bracket 210 of the second mounting system 100 of the second system 10B are mounted. In some embodiments, for example, the wall bracket 110 of the first mounting system 100 of the second system 10B, the load bracket 150 of the first mounting system 100 of the second system 10B, the wall bracket 210 of the second mounting system 200 of the second system 10B, and the load bracket 250 of the second mounting system 200 of the second system 10B are co-operatively configured to mount the load 30 to the wall frame 20, for example, a second portion of the wall frame 20 as depicted in FIG. 17, or a different wall frame 20. As depicted in FIG. 15, FIG. 16, and FIG. 17, while the load 30 is mounted to an upper portion of the wall frame 20 via the first system 10A, the load 30 is re-positionable to be mounted to a lower portion of the wall frame 20 via the second system 10B.

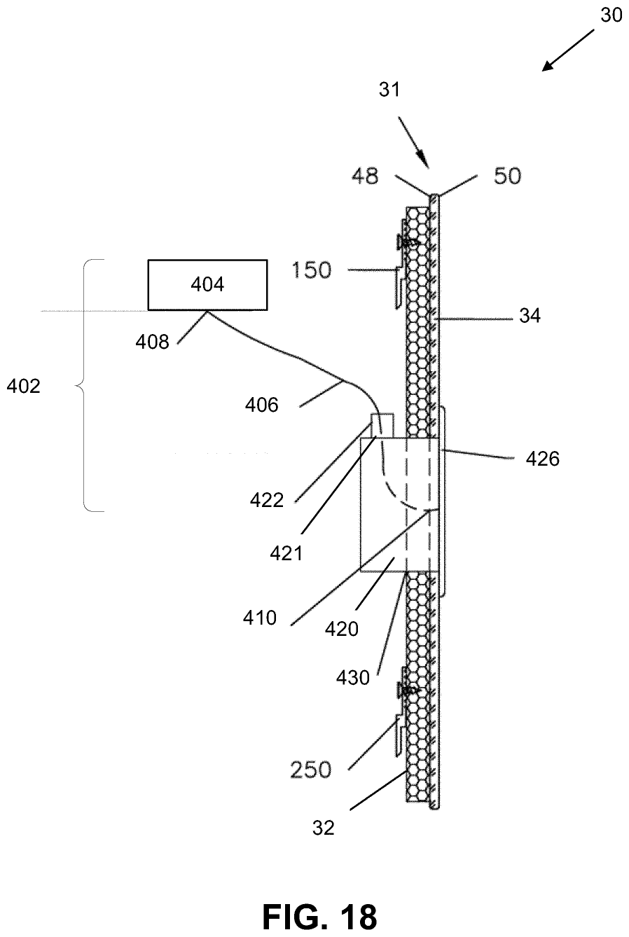

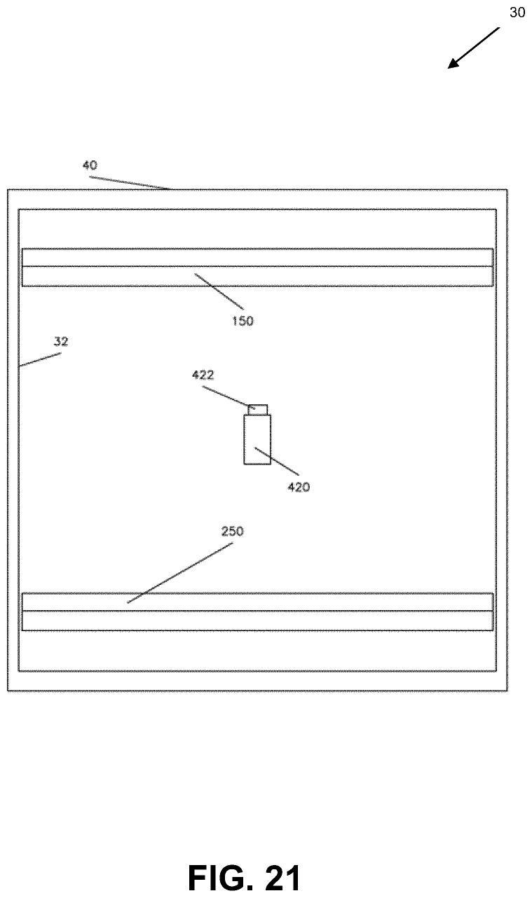

FIGS. 18 to 22 depict an embodiment of the wall panel assembly 30. The wall panel assembly 30 is configured to be mounted to a wall frame 20, for example, via the system 10. The wall panel assembly 30 includes the wall panel 31, which includes the reinforcing substrate 32 and the wall paneling 34. In some embodiments, for example, the wall panel 31 is mountable to the wall frame 20, for example, via the system 10. As depicted in FIG. 18, the load bracket 150 of the first mounting system 100 and the load bracket 250 of the second mounting system 200 are mounted to the reinforcing substrate 32 of the wall panel assembly 30.

The wall panel assembly 30 includes a wall panel assembly-defined current or light communicating module 402. The wall panel assembly-defined current or light communicating module 402 includes a wall panel assembly-defined counterpart 404 of a connecting structure 450, and a wall panel assembly-defined current or light conductor 406.

In some embodiments, for example, the wall panel assembly-defined counterpart 404 of the connecting structure 450 is configured to be connected to the wall panel assembly-defined current or light conductor 406. In some embodiments, for example, the wall panel assembly-defined counterpart 404 is connected to the wall panel assembly-defined current or light conductor 406 using a fastening device, adhesive, or welding, and the like. In some embodiments, for example, the wall panel assembly-defined counterpart 404 is connected to the wall panel assembly-defined current or light conductor 406 using friction fit, interference fit, snap fit, and the like. In some embodiments, for example, the wall panel assembly-defined counterpart 404 defines an opening to receive the wall panel assembly-defined current or light conductor 406 for connecting the wall panel assembly-defined counterpart 404 and the wall panel assembly-defined current or light conductor 406.

In some embodiments, for example, the wall panel assembly-defined counterpart 404 of the connecting structure 450 is configured to be disposed in operable communication, for example, electrical communication or data communication, with the wall panel assembly-defined current or light conductor 406. In some embodiments, for example, while the wall panel assembly-defined counterpart 404 is connected to the wall panel assembly-defined current or light conductor 406, the wall panel assembly-defined counterpart 404 of the connecting structure 450 is disposed in operable communication, for example, electrical communication or data communication, with the wall panel assembly-defined current or light conductor 406.

The wall panel assembly-defined current or light conductor 406 is configured to conduct electrical current, data signals, or light therethrough. In some embodiments, for example, the wall panel assembly-defined current or light conductor 406 includes one or more electrical wires, one or more network cables, or one or more fibre optic cables. In some embodiments, for example, the wall panel assembly-defined current or light conductor 406 includes one or more copper wires, one or more Category 5 cables, or one or more USB cables.

As depicted in FIG. 18, the wall panel assembly-defined current or light conductor 406 includes a first end 408 and a second end 410. As depicted, the first end 408 of the wall panel assembly-defined current or light conductor 406 is connected to the wall panel assembly-defined counterpart 404, such that operable communication, for example, electrical communication or data communication, is established between the wall panel assembly-defined current or light conductor 406 and the wall panel assembly-defined counterpart 404. In some embodiments, for example, the first end 408 of the wall panel assembly-defined current or light conductor 406 terminates at the wall panel assembly-defined counterpart 404.

As depicted in FIG. 18, the wall panel 31 of the wall panel assembly 30 includes the wall paneling 34 having the first surface 48 and the second surface 50 that is that is opposite the first surface 48. As depicted, the reinforcing substrate 32 is connected to the first surface 48. In some embodiments, for example, the wall panel 31 includes an opening 430 that extends through the wall paneling 34 and the reinforcing substrate 32. In some embodiments, for example, the wall paneling 34 defines an opening that extends through the wall paneling 34, and the reinforcing substrate 32 defines an opening that extends through the reinforcing substrate 32, and the wall paneling 34 and the reinforcing substrate 32 are co-operatively configured such that while the reinforcing substrate 32 is connected to the wall paneling 34, the opening, or at least a portion of the opening, defined by the wall paneling 34 and the opening, or at least a portion of the opening, defined by the reinforcing substrate 32 are aligned to define the opening 430.

In some embodiments, for example, the wall panel assembly-defined current or light conductor 406 is received in or disposed in the opening 430. In some embodiments, for example, the second end 410 of the wall panel assembly-defined current or light conductor 406 is received in or disposed in the opening 430. In some embodiments, for example, the wall panel assembly-defined current or light conductor 406 extends through the wall panel 31, for example, via the opening 430.

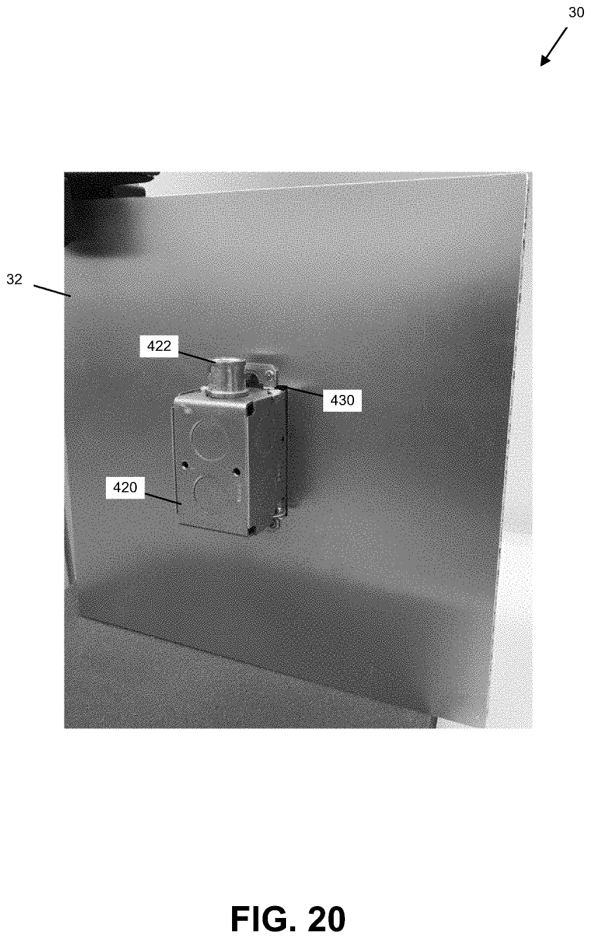

In some embodiments, for example, the opening 430 is shaped to receive the wall panel assembly-defined current or light conductor 406. In some embodiments, for example, the opening 430 has a shape with one side, for example, a circle or an oval. In some embodiments, for example, the opening 430 has a shape with more than one side, such as a triangle, square, quadrilateral, or a polygon. In some embodiments, for example, as depicted in FIG. 20, the opening 430 has a four-sided shape. In some embodiments, for example, the shape of the opening defined by the wall paneling 34 and the shape of the opening defined by the reinforcing substrate 32, which define the opening 430 upon alignment,

As depicted in FIGS. 18 to 21, the wall panel assembly 30 includes a device box 420. In some embodiments, for example, the device box 420 defines an opening 421 that is configured for access to the interior of the device box 420. In some embodiments, for example, an access ring 422 is releasably couplable to the device box 420, such that, while the access ring 422 is releasably coupled to the device box 420, the passage defined by the access ring 422 is disposed in communication with the opening 421, such that the interior of the device box 420 is accessible through the access ring 422 and the opening 421.

As depicted, in some embodiments, for example, the device box 420 is connected to the reinforcing structure 32, for example, using a fastening device, adhesive, or welding, and the like. In some embodiments, for example, the device box 420 is received in the opening 430 of the wall panel 31. The wall panel 31 and the device box 420 are co-operatively configured such that while the device box 420 is connected to the wall panel 31, the opening of the device box 420 that is configured for access to the interior of the device box 420 is aligned with, or partially aligned with, the opening 430 of the wall panel 31, such that the interior of the device box 420 is accessible through the opening 430. In some embodiments, for example, as depicted in FIG. 18, while the device box 420 is received in the opening 430 and connected to the wall panel 31, the interior of the device box 420 is accessible from the side of the wall panel 31 that is opposes the surface 50 of the wall paneling 31, for example, the front side of the wall paneling 31. In some embodiments, for example, as depicted in FIG. 18, while the device box 420 is received in the opening 430 and connected to the wall panel 31, the interior of the device box 420 is accessible from the side of the wall panel 31 that is opposite the surface 50 of the wall paneling 31 via the opening 421 and the access ring 422. In some embodiments, for example, as depicted in FIG. 18, while the device box 420 is received in the opening 430 and connected to the wall panel 31, the interior of the device box 420 is accessible from the rear side of the wall panel 31 via the opening 421 and the access ring 422.

In some embodiments, for example, while the device box 420 is connected to the wall panel 31 and while the wall panel 31 is mounted to the wall frame 20, the opening of the device box 420 is facing in a frontward direction.

In some embodiments, for example, the wall panel assembly-defined current or light conductor 406, or a portion of the wall panel assembly-defined current or light conductor 406, is received in the device box 420. In some embodiments, for example, the first end 408 of the wall panel assembly-defined current or light conductor 406 is external of the device box 420, and the second end 410 of the wall panel assembly-defined current or light conductor 406 is disposed in the device box 420. In some embodiments, for example, the wall panel assembly-defined current or light conductor 406, the wall panel 31 and the device box 420 are co-operatively configured such that while the device box 420 is connected to the wall panel 31 and at least a portion of the wall panel assembly-defined current or light conductor 406 is received in the device box 420, the opening of the device box 420 that is configured for access to the interior of the device box 420 is aligned with, or partially aligned with, the opening 430 of the wall panel 31, such that the wall panel assembly-defined current or light conductor 406, for example, the second end 410 of the wall panel assembly-defined current or light conductor 406, is accessible through the opening 430. In some embodiments, for example, as depicted in FIG. 18, while the device box 420 is received in the opening 430 and connected to the wall panel 31, and while the wall panel assembly-defined current or light conductor 406 is disposed in the device box 420, the second end 410 of the wall panel assembly-defined current or light conductor 406 is accessible from the side of the wall panel 31 that is opposes the surface 50 of the wall paneling 31, for example, the front side of the wall panel 31. In some embodiments, for example, as depicted in FIG. 18, while the device box 420 is received in the opening 430 and connected to the wall panel 31, and while the wall panel assembly-defined current or light conductor 406 is disposed in the device box 420, the second end 410 of the wall panel assembly-defined current or light conductor 406 is accessible from the side of the wall panel 31 that is opposite the surface 50 of the wall paneling 31 via the opening 421 and the access ring 422. In some embodiments, for example, as depicted in FIG. 18, while the device box 420 is received in the opening 430 and connected to the wall panel 31, and while the wall panel assembly-defined current or light conductor 406 is disposed in the device box 420, the second end 410 of the wall panel assembly-defined current or light conductor 406 is accessible from the rear side of the wall panel 31 via the opening 421 and the access ring 422. In some embodiments, for example, as depicted in FIG. 18, the wall panel assembly-defined current or light conductor 406 extends through the opening 421 of the device box 420. In some embodiments, for example, while the access ring 422 is releasably coupled to the device box 420, the wall panel assembly-defined current or light conductor 406 extends through the opening 421 and the access ring 422.

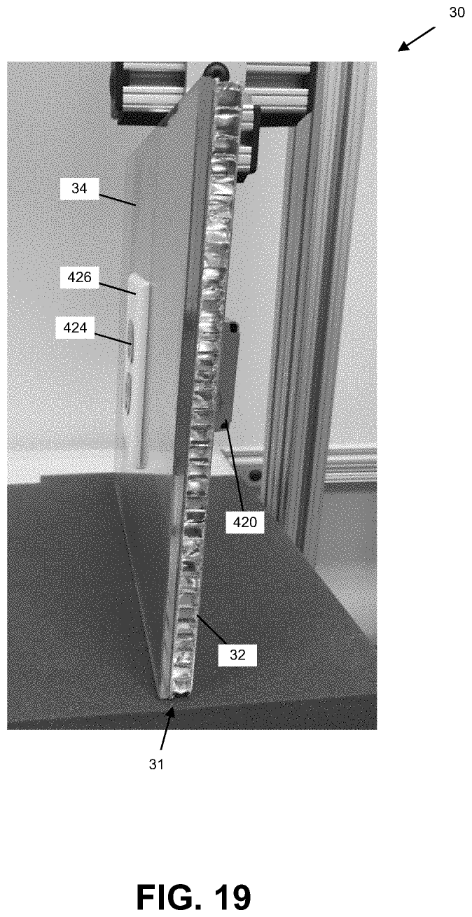

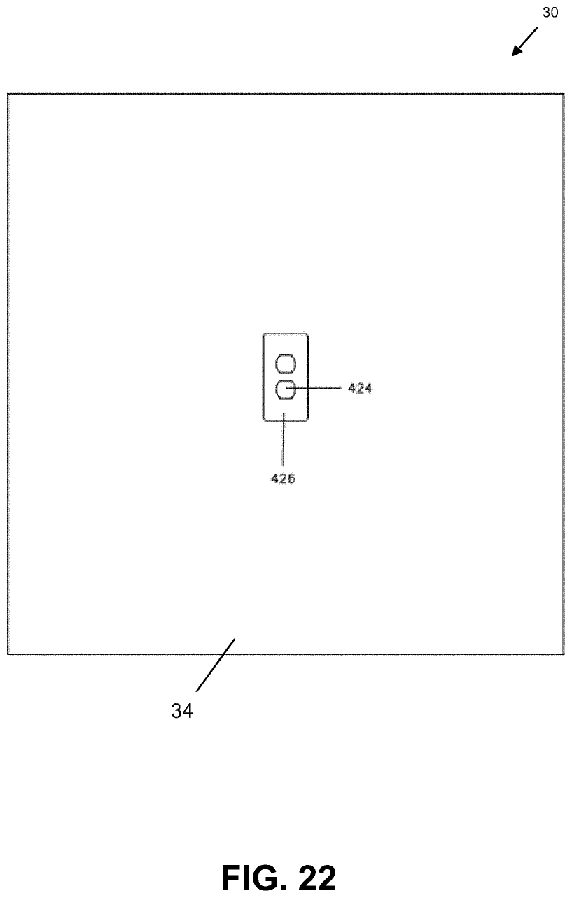

In some embodiments, for example, the wall panel assembly 30 includes an outlet, terminal, jack, or switch 424. As depicted in FIG. 19 and FIG. 22, the outlet 424 is an electrical outlet. In some embodiments, for example, the outlet 424 is a data outlet, a USB port, a light switch, and the like.

In some embodiments, for example, as depicted in FIG. 18, the wall panel assembly-defined current or light conductor 406, such as the second end 410, is connected to the outlet 424, such that operable communication, for example, electrical communication or data communication, is established between the wall panel assembly-defined current or light conductor 406 and the outlet 424. In some embodiments, for example, the second end 410 of the wall panel assembly-defined current or light conductor 406 terminates at the outlet 424. In some embodiments, for example, the wall panel assembly-defined current or light conductor 406 and the outlet 424 are co-operatively configured such that while the wall panel assembly-defined current or light conductor 406 and the outlet 424 are connected, operable communication is established between the outlet 424 and the end of wall panel assembly-defined current or light conductor 406 opposite the end to which the outlet 424 is connected, for example, the first end 408, which, in some embodiments, is connected to the wall panel assembly-defined counterpart 404.

In some embodiments, for example, as depicted in FIG. 18, FIG. 19, and FIG. 22, the wall panel assembly 30 includes a cover plate 426. The cover plate 426 is configured to be connected to the wall panel assembly 30. In some embodiments, for example, the cover plate 426 is configured to be connected to the wall paneling 34 via a fastening device, adhesive, welding, and the like. In some embodiments, for example, the cover plate 426 is configured to be connected to the wall panel 31 using friction fit, interference fit, snap fit, and the like, with the opening 430 of the wall panel 31.

In some embodiments, for example, the cover plate 426 defines an opening to receive the outlet 424, such that the outlet 424 is supported by the cover plate 426 and disposed in an operable orientation while the outlet 424 is received in the opening of the cover plate 424. In some embodiments, for example, where the outlet 424 is an electrical outlet 424, while the electrical outlet 424 is received in the opening of the cover plate 426, the slots of the electrical outlet 424 that are configured to receive the prongs of a corresponding electrical plug are accessible from the side of the wall panel 31 that opposes the surface 50 of the wall paneling 31, for example, the front side of the wall paneling 31, such that the prongs of the corresponding electrical plug may be inserted into the slots of the electrical outlet 424.

In some embodiments, for example, the wall panel 31 and the cover plate 426 are co-operatively configured such that while the cover plate 426 is connected to the wall panel 31, the cover plate 426 occludes the opening 430 from the side of the wall panel 31 that opposes the surface 50 of the wall paneling 31, for example, the front side of the wall paneling 31.

In some embodiments, for example, the wall panel 31, the device box 420, and the cover plate 426 are co-operatively configured such that while the cover plate 426 is connected to the wall panel 31, and while the device box 420 is received in the opening 430 and connected to the wall panel 31, the cover plate 426 restricts access to the interior of the device box 420 from the side of the wall panel 31 that opposes the surface 50 of the wall paneling 31, for example, the front side of the wall paneling 31.

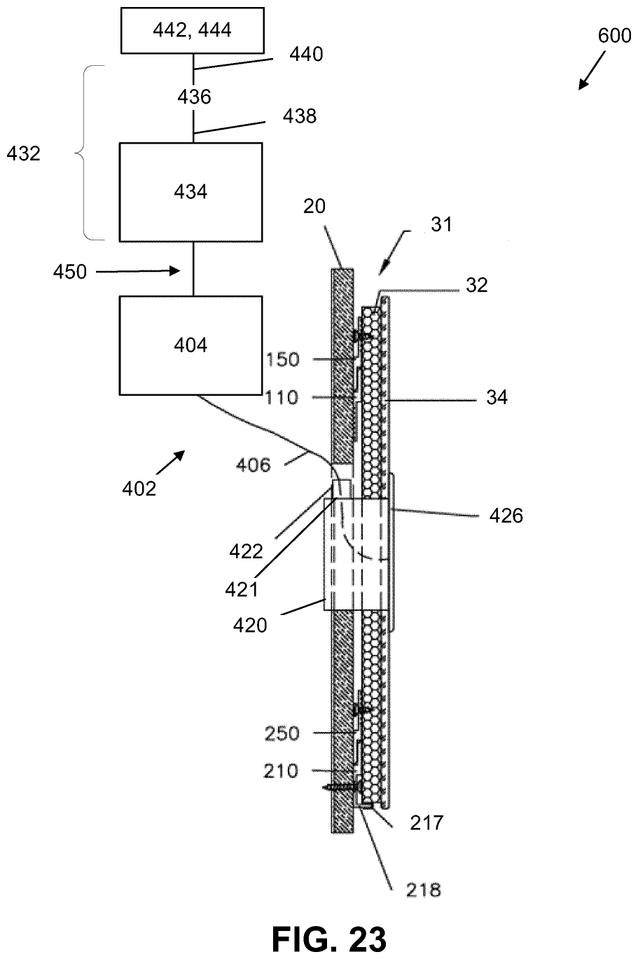

As depicted in FIG. 23, the wall frame 20 includes a support-defined current or light communicating module 432. The support-defined current or light communicating module 432 includes a support-defined counterpart 434 of a connecting structure 450 and a support-defined current or light conductor 436.

In some embodiments, for example, the support-defined counterpart 434 of the connecting structure 450 is configured to be connected to the support-defined current or light conductor 436. In some embodiments, for example, the support-defined counterpart 434 is connected to the support-defined current or light conductor 436 using a fastening device, adhesive, or welding, and the like. In some embodiments, for example, the support-defined counterpart 434 is connected to the support-defined current or light conductor 436 using friction fit, interference fit, snap fit, and the like. In some embodiments, for example, the support-defined counterpart 434 defines an opening to receive the support-defined current or light conductor 436 for connecting the support-defined counterpart 434 and the support-defined current or light conductor 436.

In some embodiments, for example, the support-defined counterpart 434 of the connecting structure 450 is configured to be disposed in operable communication, for example, electrical communication or data communication, with the support-defined current or light conductor 436. In some embodiments, for example, while the support-defined counterpart 434 is connected to the support-defined current or light conductor 436, the support-defined counterpart 434 of the connecting structure 450 is disposed in operable communication, for example, electrical communication or data communication, with the support-defined current or light conductor 436. In some embodiments, for example, in response to connection of the support-defined counterpart 434 and the support-defined current or light conductor 436, the support-defined counterpart 434 of the connecting structure 450 become disposed in operable communication, for example, electrical communication or data communication, with the support-defined current or light conductor 436.

The support-defined current or light conductor 436 is configured to conduct electrical current, data signals, or light therethrough. In some embodiments, for example, the support-defined current or light conductor 436 includes one or more electrical wires, one or more network cables, or one or more fibre optic cables. In some embodiments, for example, the wall panel assembly-defined current or light conductor 436 includes one or more copper wires, one or more Category 5 cables, or one or more USB cables.

As depicted in FIG. 23, the support-defined current or light conductor 436 includes a first end 438 and a second end 440. As depicted, the first end 438 of the support-defined current or light conductor 436 is connected to the support-defined counterpart 434, such that operable communication, for example, electrical communication or data communication, is established between the support-defined current or light conductor 436 and the support-defined counterpart 434. In some embodiments, for example, the first end 438 of the support-defined current or light conductor 436 terminates at the support-defined counterpart 434.

In some embodiments, for example, as depicted in FIG. 23, the support-defined current or light conductor 436, such as the second end 440, is connected to a power source 442 or a data source 444, such that operable communication, for example, electrical communication or data communication, is established between the support-defined current or light conductor 436 and the power source 442 or the data source 444. In some embodiments, for example, the second end 440 of the support-defined current or light conductor 436 terminates at the power source 442 or the data source 444. In some embodiments, for example, the support-defined current or light conductor 436 and the power source 442 or data source 444 are co-operatively configured such that while the support-defined current or light conductor 436 and the power source 442 or the data source 444 are connected, operable communication is established between the power source 442 or the data source 444 and the end of support-defined current or light conductor 436 opposite the end to which the power source 442 or the data source 444 is connected, for example, the first end 438, which, in some embodiments, is connected to the support-defined counterpart 434.

In some embodiments, for example, the power source 442 is an electrical panel.

In some embodiments, for example, the data source 444 is a modem.

In some embodiments, for example, the wall panel assembly-defined counterpart 404 of the connecting structure 450 is configured for releasably coupling to the support-defined counterpart 434 of the connecting structure 450. In some embodiments, for example, the wall panel assembly-defined counterpart 404 is releasably coupled to the support-defined counterpart 434 using a fastening device, adhesive, or welding, and the like. In some embodiments, for example, the wall panel assembly-defined counterpart 404 is connected to the support-defined counterpart 434 using friction fit, interference fit, snap fit, and the like.

In some embodiments, for example, the connecting structure 450 is a quick disconnect connecting structure, for example, an electrical quick disconnect connecting structure or a data quick disconnect connecting structure. In some embodiments, for example, one of the wall panel assembly-defined counterpart 404 and the support-defined counterpart 434 includes a first quick disconnect counterpart, for example, a quick disconnect male counterpart, and the other one of the wall panel assembly-defined counterpart 404 and the support-defined counterpart 434 includes a second quick disconnect counterpart, for example, a quick disconnect female counterpart, wherein the first quick disconnect counterpart and the second quick disconnect counterpart are co-operatively configured for releasably coupling the wall panel assembly-defined counterpart 404 and the support-defined counterpart 434.

In some embodiments, for example, the wall panel assembly-defined current or light conductor 406 and the wall panel assembly-defined counterpart 404 of the connecting structure 450 are co-operatively configured such that in response to the releasable coupling of the wall panel assembly-defined counterpart 404 and the support-defined counterpart 434 of the connecting structure 450, connection of the wall panel assembly-defined current or light communicating module 402 and the support-defined current or light communicating module 432 is established via the connecting structure 450.

In some embodiments, for example, the wall panel assembly-defined current or light conductor 406 and the wall panel assembly-defined counterpart 404 of the connecting structure 450 are co-operatively configured such that in response to the releasable coupling of the wall panel assembly-defined counterpart 404 and the support-defined counterpart 434 of the connecting structure 450, the wall panel assembly-defined current or light conductor 406 becomes disposed in operable communication, for example, electrical communication or data communication, with the support-defined current or light conductor 436.

In some embodiments, for example, the wall panel assembly-defined current or light conductor 406 and the wall panel assembly-defined counterpart 404 of the connecting structure 450 are co-operatively configured such that in response to the releasable coupling of the wall panel assembly-defined counterpart 404 and the support-defined counterpart 434 via an electrical quick disconnect connecting structure, the wall panel assembly-defined current or light conductor 406 becomes disposed in electrical communication with the support-defined current or light conductor 436.

In some embodiments, for example, the wall panel assembly-defined current or light conductor 406 and the wall panel assembly-defined counterpart 404 of the connecting structure 450 are co-operatively configured such that in response to the releasable coupling of the wall panel assembly-defined counterpart 404 and the support-defined counterpart 434 via a data quick disconnect connecting structure, the wall panel assembly-defined current or light conductor 406 becomes disposed in data communication with the support-defined current or light conductor 436.

In some embodiments, for example, the wall panel assembly-defined current or light conductor 406 and the wall panel assembly-defined counterpart 404 of the connecting structure 450 are co-operatively configured such that while the connection of the wall panel assembly-defined current or light communicating module 402 and the support-defined current or light communicating module 432 is established, for example, in response to the releasable coupling of the wall panel assembly-defined counterpart 404 and the support-defined counterpart 434, the wall panel assembly-defined current or light conductor 406 becomes disposed in operable communication, for example, electrical communication or data communication, with the support-defined current or light conductor 436.

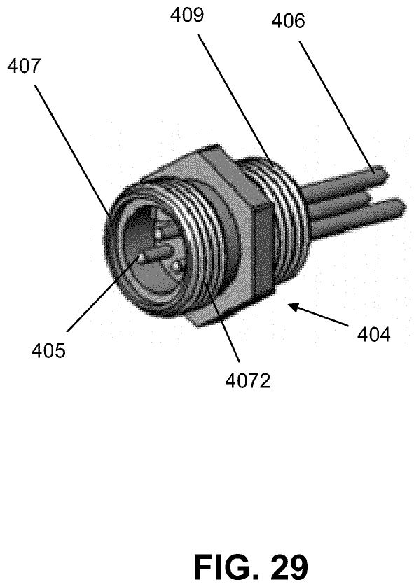

FIG. 29 depicts an example embodiment of the wall panel assembly-defined counterpart 404. As depicted, in some embodiments, for example, the wall panel assembly-defined counterpart 404 is disposed in operable communication with the wall panel assembly-defined current or light conductor 406. The wall panel assembly-defined counterpart 404 includes one or more prongs 405 that are receivable in corresponding one or more slots 435 of the support-defined counterpart 434.

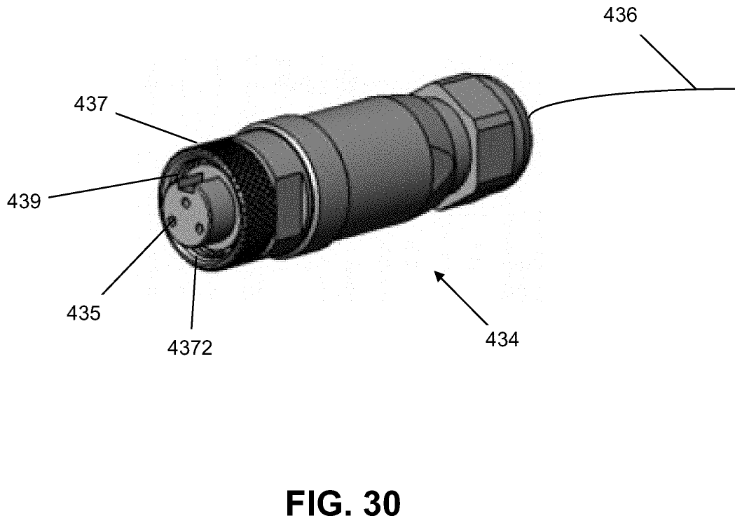

FIG. 30 depicts an example embodiment of the support-defined counterpart 434. As depicted, in some embodiments, for example, the support-defined counterpart 434 is disposed in operable communication with the support-defined current or light conductor 436. The support-defined counterpart 434 includes one or more slots 435 for receiving corresponding the one or more prongs 405 of the wall panel assembly-defined counterpart 404.

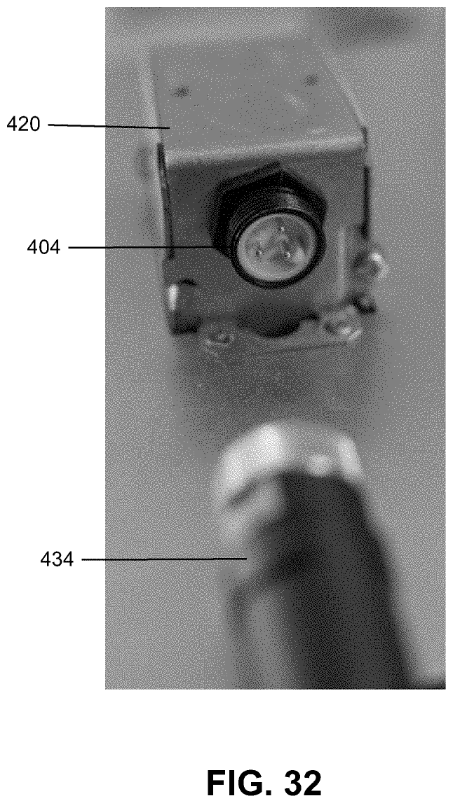

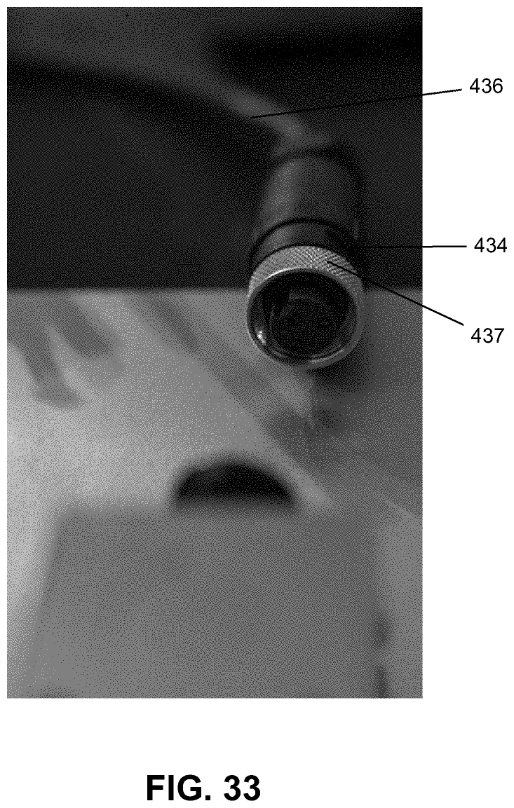

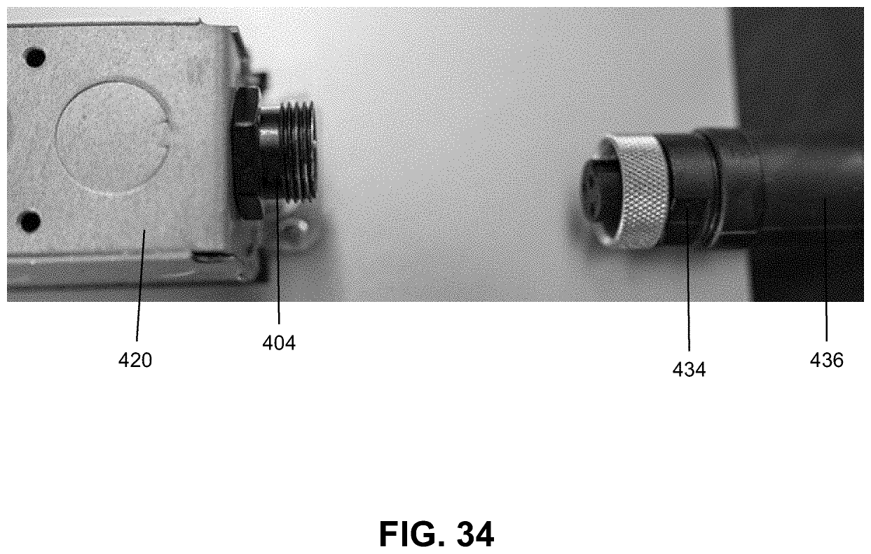

In some embodiments, for example, as depicted in FIG. 32 to FIG. 36, the releasably coupling of the wall panel assembly-defined counterpart 404 and the support-defined counterpart 434 is effectible by: (i) alignment of the one or more prongs 405 of the wall panel assembly-defined counterpart 404 with the one or more slots 435 of the support-defined counterpart 434, and (ii) insertion of the one or more prongs 405 into the one or more slots 435. In some embodiments, for example, the wall panel assembly-defined current or light conductor 406, the wall panel assembly-defined counterpart 404 of the connecting structure 450, the support-defined current or light conductor 436, and the support-defined counterpart 434 of the connecting structure 450 are co-operatively configured such that, in response to the insertion of the one or more prongs 405 into the one or more slots 435, the wall panel assembly-defined current or light conductor 406 becomes disposed in operable communication, for example, electrical communication or data communication, with the support-defined current or light conductor 436.

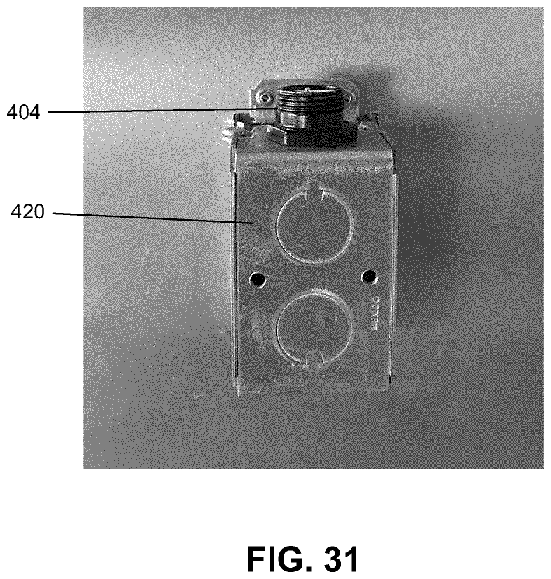

In some embodiments, for example, as depicted in FIG. 29, the wall panel assembly-defined counterpart 404 is releasably couplable to the device box 420. In this respect, in some embodiments, for example, the wall panel assembly-defined counterpart 404 includes connection threads 409 for releasably coupling the wall panel assembly-defined counterpart 404 to the device box 420. In some embodiments, for example, the wall panel assembly-defined counterpart 404 is coupled to the device box 420, for example, by threading the connection threads 409 through the opening 421, as depicted in FIG. 31 to FIG. 36. In some embodiments, for example, the coupling of the access ring 422 to the device box 420 is released, and such that the access ring 422 is decoupled from the device box 420, and the wall panel assembly-defined counterpart 404 is then coupled to the device box 420. In some embodiments, for example, while the wall panel assembly-defined counterpart 404 is coupled to the device box 420, the wall panel assembly-defined current or light conductor 406 is disposed in the device box 420. In some embodiments, for example, while the wall panel assembly-defined counterpart 404 is coupled to the device box 420 and the wall panel assembly-defined current or light conductor 406 is disposed in the device box 420, the wall panel assembly 30 is displaceable with reduced impediment by the wall panel assembly-defined counterpart 404 or the wall panel assembly-defined current or light conductor 406. In some embodiments, for example, while the wall panel assembly-defined counterpart 404 is coupled to the device box 420 and the wall panel assembly-defined current or light conductor 406 is disposed in the device box 420, the wall panel assembly-defined current or light conductor 406 is concealed from view by the device box 420, the outlet 424, and the cover plate 426.

In some embodiments, for example, while the wall panel assembly-defined counterpart 404 and the support-defined counterpart 434 are releasably coupled, for example, via insertion of the one or more prongs 405 into the one or more slots 435, the wall panel assembly-defined counterpart 404 and the support-defined counterpart 434 are releasable from the releasable coupling, for example, by pulling the one or more prongs 405 out of the one or more slots 435. In some embodiments, for example, the wall panel assembly-defined current or light conductor 406, the wall panel assembly-defined counterpart 404 of the connecting structure 450, the support-defined current or light conductor 436, and the support-defined counterpart 434 of the connecting structure 450 are co-operatively configured such that, while the wall panel assembly-defined counterpart 404 and the support-defined counterpart 434 are releasably coupled, for example, via insertion of the one or more prongs 405 into the one or more slots 435, in response to the removal of the one or more prongs 405 from the one or more slots 435, disposition of the wall panel assembly-defined current or light conductor 406 with the support-defined current or light conductor 436 in the operable communication, for example, electrical communication or data communication, becomes defeated.

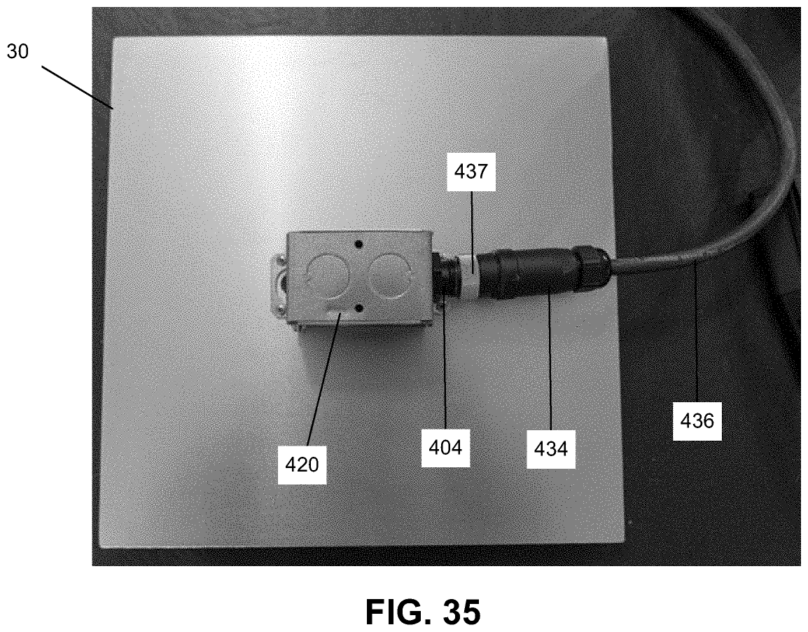

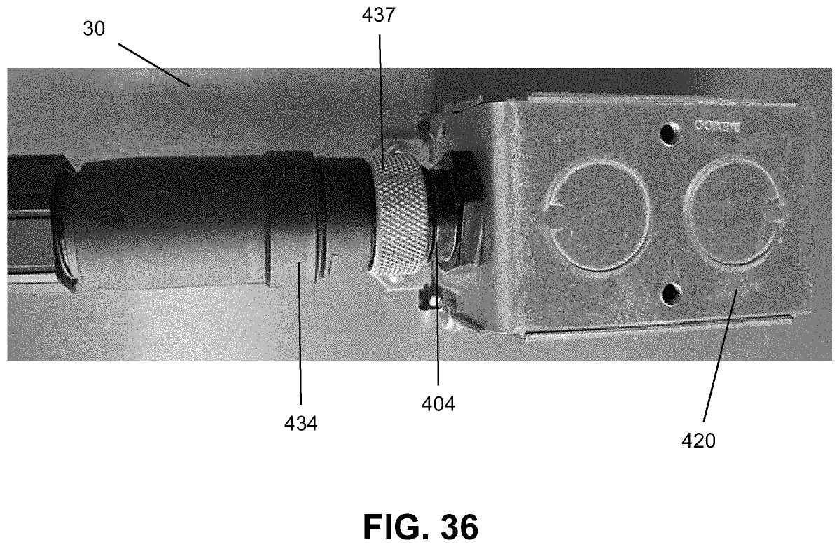

In some embodiments, for example, the releasable coupling of the wall panel assembly-defined counterpart 404 and the support-defined counterpart 434 is retainable to resist de-coupling of the coupling. In this respect, in some embodiments, for example, as depicted in FIG. 29 and FIG. 30, the wall panel assembly-defined counterpart 404 includes a retaining collar 407, and the support-defined counterpart 434 includes a retaining ring 437. As depicted in FIG. 29, the retaining collar 407 is disposed around the one or more prongs 405. The retaining collar 407 includes threads 4072 disposed on an outer surface of the retaining collar 407. As depicted in FIG. 30, the retaining ring 437 is disposed around the one or more slots 435. The retaining ring 437 includes threads 4372 disposed on an inner surface of the retaining ring 437. In some embodiments, for example, the retaining collar 407 and the retaining ring 437 are co-operatively configurable to retain the releasable coupling of the wall panel assembly-defined counterpart 404 and the support-defined counterpart 434. In some embodiments, while the wall panel assembly-defined counterpart 404 and the support-defined counterpart 434 are releasably coupled, for example, via insertion of the one or more prongs 405 into the one or more slots 435, the retaining ring 437 is coupled to the retaining collar 407, for example, by threading the retaining ring 437 onto the retaining collar 407 via the threads 4372 and the threads 4072, as depicted in FIG. 35 and FIG. 36, with effect that: (i) the releasable coupling the wall panel assembly-defined counterpart 404 and the support-defined counterpart 434 is retained, and (ii) releasing of the releasable coupling of the wall panel assembly-defined counterpart 404 and the support-defined counterpart 434 is resisted, by the coupling of the retaining ring 437 and the retaining collar 407.

In some embodiments, for example, the outlet 424 is an electrical outlet 424, and the wall panel assembly-defined current or light conductor 406 is disposed in electrical communication with the electrical outlet 424. In some embodiments, for example, the wall panel assembly-defined current or light conductor 406, the electrical outlet 424, and the wall panel assembly-defined counterpart 404 of the connecting structure 450 are co-operatively configured such that while the wall panel assembly-defined counterpart 404 of the connecting structure 450 and the support-defined counterpart 434 of the connecting structure 450 are releasably coupled, the electrical outlet 424 and the support-defined counterpart 434 of the connecting structure 450 are disposed in electrical communication.

In some embodiments, for example, the power source 442 is an electrical panel 442, and the support-defined counterpart 434 of the connecting structure 450 is disposed in electrical communication with the electrical panel 442. In some embodiments, for example, the wall panel assembly-defined current or light conductor 406, the electrical outlet 424, and the wall panel assembly-defined counterpart 404 of the connecting structure 450 are co-operatively configured such that while the wall panel assembly-defined counterpart 404 of the connecting structure 450 and the support-defined counterpart 434 of the connecting structure 450 are releasably coupled, the electrical outlet 424 and the electrical panel 442 are disposed in electrical communication.

In some embodiments, for example, the outlet 424 is a switch 424, and the wall panel assembly-defined current or light conductor 406 is disposed in electrical communication with the switch 424. In some embodiments, for example, the wall panel assembly-defined current or light conductor 406, the switch 424, and the wall panel assembly-defined counterpart 404 of the connecting structure 450 are co-operatively configured such that while the wall panel assembly-defined counterpart 404 of the connecting structure 450 and the support-defined counterpart 434 of the connecting structure 450 are releasably coupled, the switch 424 and the support-defined counterpart 434 of the connecting structure 450 are disposed in electrical communication.

In some embodiments, for example, the power source 442 is an electrical panel 442, and the support-defined counterpart 434 of the connecting structure 450 is disposed in electrical communication with the electrical panel 442. In some embodiments, for example, the wall panel assembly-defined current or light conductor 406, the switch 424, and the wall panel assembly-defined counterpart 404 of the connecting structure 450 are co-operatively configured such that while the wall panel assembly-defined counterpart 404 of the connecting structure 450 and the support-defined counterpart 434 of the connecting structure 450 are releasably coupled, the switch 424 and the electrical panel 442 are disposed in electrical communication.

In some embodiments, for example, the outlet 424 is a data port 424, and the wall panel assembly-defined current or light conductor 406 is disposed in data communication with the data port 424. In some embodiments, for example, the wall panel assembly-defined current or light conductor 406, the data port 535, and the wall panel assembly-defined counterpart 404 of the connecting structure 450 are co-operatively configured such that while the wall panel assembly-defined counterpart 404 of the connecting structure 450 and the support-defined counterpart 434 of the connecting structure 450 are releasably coupled, the data port 424 and the support-defined counterpart 434 of the connecting structure 450 are disposed in data communication.

In some embodiments, for example, the data source 444 is a modem 444, and the support-defined counterpart 434 of the connecting structure 450 is disposed in data communication with the modem 444. In some embodiments, for example, the wall panel assembly-defined current or light conductor 406, the data port 424, and the wall panel assembly-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the data port 424 and the modem 444 are disposed in data communication.

As depicted in FIG. 23, in some embodiments, for example, the wall bracket 110 of the first mounting system 100 and the wall bracket 210 of the second mounting system 200 are connected to the wall frame 20, for example, studs 20 or wall frame 20, and the load bracket 150 of the first mounting system 100 and the load bracket 250 of the second mounting system 200 are connected to the wall panel assembly 30, such as the exposed surface 44 of the reinforcing substrate 32 of the wall panel assembly 30. In some embodiments, for example, the wall panel assembly 30 is mountable to a wall frame 20, for example, using the system 10, as described herein. In some embodiments, for example, the wall panel assembly-defined counterpart 404 and the support-defined counterpart 434 of the connecting structure 450 are releasably coupled, and then the wall panel assembly 30 is mounted to the wall frame 20 using the system 10.

In some embodiments, for example, the wall panel assembly 30 and the connecting structure 450 are co-operatively configured such that, while the wall panel assembly-defined counterpart 404 of the connecting structure 450 and the support-defined counterpart 434 of the connecting structure 450 are releasably coupled, and the wall panel assembly 30 is mounted to the wall frame 20, the connecting structure 450 is occluded, or partially occluded, by the wall panel assembly 30. In some embodiments, for example, the wall panel assembly 30, while mounted on the wall frame 20, obscures the connecting structure 450 or a portion of the connecting structure 450 from view. From the perspective of an observer standing in front of the wall frame 20 and looking at the wall panel assembly 30, the system 10 and the wall panel assembly 30 are co-operatively configured such that while the wall panel assembly 30 is mounted to the wall frame 20, the wall paneling 34 is facing outwardly relative to the wall frame 20, such that the wall paneling 34 is visible while the wall panel assembly 30 occludes the connecting structure 450 or a portion of the connecting structure 450, or obscures the connecting structure 450 or a portion of the connecting structure 450 from view.

In some embodiments, for example, while the wall panel assembly 30 is mounted to the wall frame 20 with the system 10, the wall panel assembly 30 is dismountable from the wall frame 20. In some embodiments, for example, the system 10, the wall frame 20, and the wall panel assembly 30 are co-operatively configured such that while the wall panel assembly 30 is mounted to the wall frame 20 using the system 10, the wall panel assembly 30 is dismountable from the wall frame 20. In some embodiments, for example, while the wall panel assembly 30 is mounted to the wall frame 20, the wall panel assembly 30 is lifted relative to the wall frame 20, and in particular, the load bracket 150 of the first mounting system 100 and the load bracket 250 of the second mounting system 200 that are mounted to the wall panel assembly 30 are lifted relative to the load bracket 110 of the first mounting system 100 and the wall bracket 210 of the second mounting system 200 that are mounted to the wall frame 20, to disengage, de-couple, or separate the wall bracket 110 and the load bracket 150 of the first mounting system 100 and the wall bracket 210 and the load bracket 250 of the second mounting system 200, such that the mounting of the wall panel assembly 30 to the wall frame 20 by the system 10 is absent. In some embodiments, for example, the wall panel assembly 30 is lifted such that the support of the wall panel assembly 30 by the ledge 218 is absent, and that the mounting of the wall panel assembly 30 to the wall frame 20 by the system 10 is absent.

FIG. 23 depicts a wall panel system 600. The wall panel system 600 includes the wall panel assembly 30 that is mountable to a wall frame 20. The wall panel assembly 30 includes the wall panel assembly-defined current or light communicating module 402 that includes the wall panel assembly-defined counterpart 404 of the connecting structure 450 that is configured for releasably coupling to the support-defined counterpart 434 of the connecting structure 450, the wall panel assembly-defined current or light conductor 406. The support 402 includes a support-defined current or light communicating module 432 that includes the support-defined counterpart 434 of the connecting structure 450 and the support-defined current or light conductor 436. The wall panel assembly-defined current or light conductor 406, the support-defined current or light conductor 436, the wall panel assembly-defined counterpart 404 of the connecting structure 450, and the support-defined counterpart 434 of the connecting structure 450 are co-operatively configured such that in response to the releasable coupling of the wall panel assembly-defined counterpart 404 of the connecting structure 450 and the support-defined counterpart 434 of the connecting structure 450, the wall panel assembly-defined current or light conductor 404 becomes disposed in operable communication with the support-defined current or light conductor 434.

In some embodiments, for example, the outlet 424 is an electrical outlet 424, and the wall panel assembly-defined current or light conductor 406 is disposed in electrical communication with the electrical outlet 424. In some embodiments, for example, the wall panel assembly-defined current or light conductor 406, the support-defined current or light conductor 436, the electrical outlet 424, the wall panel assembly-defined counterpart 404 of the connecting structure 450, and the support-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the electrical outlet 424 and the support-defined current or light conductor 436 are disposed in electrical communication.

In some embodiments, for example, the power source 442 is an electrical panel 442, and the support-defined counterpart 434 of the connecting structure 450 is disposed in electrical communication with the electrical panel 442. In some embodiments, for example, the wall panel assembly-defined current or light conductor 406, the support-defined current or light conductor 436, the electrical outlet 424, the electrical panel 442, the wall panel assembly-defined counterpart 404 of the connecting structure 450, and the support-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the electrical outlet 424 and the electrical panel 442 are disposed in electrical communication.

In some embodiments, for example, the outlet 424 is a switch 424, and the wall panel assembly-defined current or light conductor 406 is disposed in electrical communication with the switch 424. In some embodiments, for example, the wall panel assembly-defined current or light conductor 406, the support-defined current or light conductor 436, the switch 424, the wall panel assembly-defined counterpart 404 of the connecting structure 450, and the support-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the switch 424 and the support-defined current or light conductor 436 are disposed in electrical communication.

In some embodiments, for example, the power source 442 is an electrical panel 442, and the support-defined counterpart 434 of the connecting structure 450 is disposed in electrical communication with the electrical panel 442. In some embodiments, for example, the wall panel assembly-defined current or light conductor 406, the support-defined current or light conductor 436, the switch 424, the electrical panel 442, the wall panel assembly-defined counterpart 404 of the connecting structure 450, and the support-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the switch 442 and the electrical panel 442 are disposed in electrical communication.

In some embodiments, for example, the outlet 424 is a data port 424, and the wall panel assembly-defined current or light conductor 406 is disposed in data communication with the data port 424. In some embodiments, for example, the wall panel assembly-defined current or light conductor 406, the support-defined current or light conductor 436, the data port 424, the wall panel assembly-defined counterpart 404 of the connecting structure 450, and the support-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the data port 424 and the support-defined current or light conductor 436 are disposed in data communication.

In some embodiments, for example, the data source 444 is a modem 444, and the support-defined counterpart 434 of the connecting structure 450 is disposed in data communication with the modem 444. In some embodiments, for example, the wall panel assembly-defined current or light conductor 406, the support-defined current or light conductor 436, the data port 424, the modem 444, the wall panel assembly-defined counterpart 404 of the connecting structure 450, and the support-defined counterpart 434 of the connecting structure 450 are co-operatively configured such that while the wall panel assembly-defined counterpart 404 of the connecting structure 450 and the support-defined counterpart 434 of the connecting structure 450 are releasably coupled, the data port 424 and the modem 444 are disposed in data communication.

In some embodiments, for example, while the wall panel assembly-defined counterpart 404 and the support-defined counterpart 434 of the connecting structure 450 are releasably coupled, and while the wall panel assembly 30 is mounted to a first portion of the wall frame 20, for example, the left side of the wall frame 20, in some embodiments, for example, the wall panel assembly 30 is dismountable from the wall frame 20 and is re-positionable relative to another portion of the first mounting system 100 and another portion of the second mounting system 200 of the system 10, and the wall panel assembly 30 is re-mountable to a second portion of the wall frame 20, for example the right side of the wall frame 20, via the other portion of the first mounting system 100 and the other portion of the second mounting system 200 of the system 10 without releasing the releasable coupling of the wall panel assembly-defined counterpart 404 and the support-defined counterpart 434 of the connecting structure 450.

In some embodiments, for example, the first portion of the wall bracket 110A of the first mounting system 100, the load bracket 150 of the first mounting system 100, the first portion of the wall bracket 210A of the second mounting system 200, and the load bracket 250 of the second mounting system 200 are co-operatively configured to mount the wall panel assembly 30 to the wall frame 20, as depicted in FIG. 15. While the wall panel assembly 30 is mounted to the wall frame 20 via the first portion of the wall bracket 110A of the first mounting system 100, the load bracket 150 of the first mounting system 100, the first portion of the wall bracket 210A of the second mounting system 200, and the load bracket 250 of the second mounting system 200, the wall panel assembly 30 is disposed at a portion relative to the wall frame 20, for example, the left portion of the wall frame 20. Where the wall panel assembly 30 includes the outlet 424, the outlet 424 disposed at a portion relative to the wall frame 20 based on the relative disposition of the wall panel assembly 30 and the wall frame 20. In some embodiments, for example, the outlet 424 is disposed at a left portion of the wall frame 20.

In some embodiments, for example, as depicted in FIG. 15 and FIG. 16, the wall panel assembly 30 is re-positionable relative to the second portion of the wall bracket 110B of the first mounting system 100 and the second portion of the wall bracket 210B of the second mounting system 200, such that the second portion of the wall bracket 110B of the first mounting system 100, the load bracket 150 of the first mounting system 100, the second portion of the wall bracket 210B of the second mounting system 200, and the load bracket 250 of the second mounting system 200 are co-operatively configured to mount the wall panel assembly 30 to the wall frame 20. In such embodiments, for example, the outlet 424 of the wall panel assembly 30 is re-positionable relative to the wall frame 20 without releasing the releasable coupling of the wall panel assembly-defined counterpart 404 and the support-defined counterpart 434 of the connecting structure 450. In some embodiments, for example, the outlet 424 is re-positioned from the left portion of the wall frame 20 to be disposed at a right portion of the wall frame 20.

In some embodiments, for example, while the wall panel assembly-defined counterpart 404 and the support-defined counterpart 434 of the connecting structure 450 are releasably coupled, and while the load 30 is mounted to the wall frame 20, in some embodiments, for example, the releasable coupling of the wall panel assembly-defined counterpart 404 and the support-defined counterpart 434 of the connecting structure 450 is releasable, the load 30 is dismountable from the wall frame 20, the load 30 is re-positionable relative to a second support-defined current or light communicating module 462, the wall panel assembly-defined counterpart 404 is releasably couplable with a support-defined counterpart 464 of a second connecting structure 480, and the load 30 is re-mountable to the wall frame 20, for example, via the same system 10 or via another system 10.

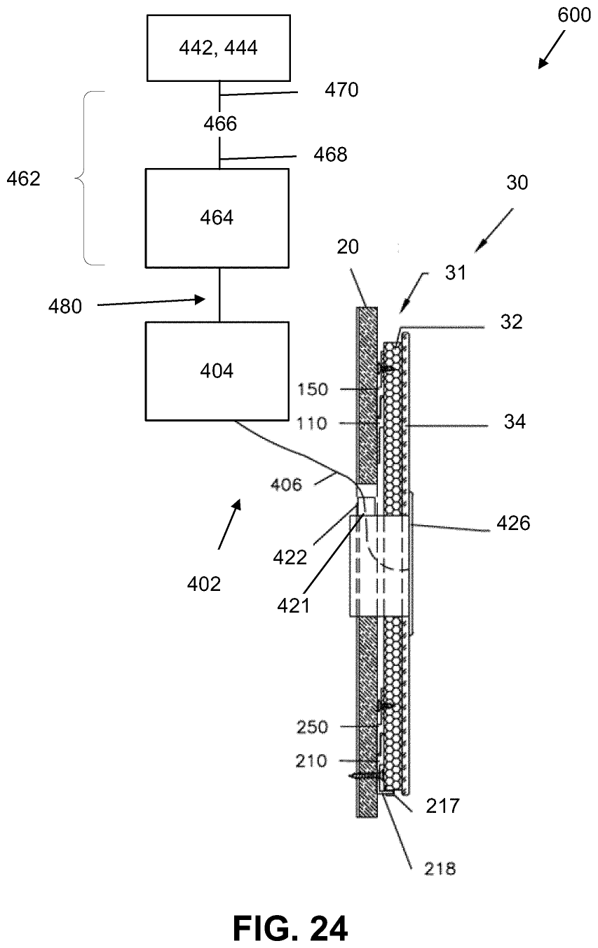

In some embodiments, for example, as depicted in FIG. 23, the support-defined current or light communicating module 432 is a first support-defined current or light communicating module 432, the connecting structure 450 is a first connecting structure 450, and the support-defined current or light conductor 436 is a first support-defined current or light conductor 436. In some embodiments, as depicted in FIG. 24, the wall frame 20 includes a second support-defined current or light communicating module 462 that includes a support-defined counterpart 464 of a second connecting structure 480, a second support-defined current or light conductor 466. The support-defined counterpart 464 of the second connecting structure 480 is substantially the same as the support-defined counterpart 434 of the first connecting structure 450, and the second support-defined current or light conductor 466 is substantially the same as the first support-defined current or light conductor 436. As depicted in FIG. 24, similar to the first support-defined current or light conductor 436, the second support-defined current or light conductor 466 is disposed in operable communication, for example, electrical communication or data communication, with the support-defined counterpart 464 of a second connecting structure 480 and the power source 442 or data source 444.

In some embodiments, for example, the wall panel assembly-defined counterpart 404 of the first connecting structure 450 is a wall panel assembly defined counterpart 404 of the second connecting structure 480. In some embodiments, for example, the wall panel assembly-defined counterpart 404 of the second connecting structure 408 is configured for releasably coupling to the support-defined counterpart 464 of the second connecting structure 480.

In some embodiments, for example, the second connecting structure 480 is substantially the same as the first connection structure 450.

In some embodiments, for example, the second support-defined current or light communicating module 462 is disposed relative a portion of the wall frame 20 that is different from the portion of the wall frame 20 on which the first support-defined communicating module 432 is disposed. For example, the support-defined counterpart 434 of the first connecting structure 450 is disposed on an upper portion of the wall frame 20, and the support-defined counterpart 464 of the second connecting structure 480 is disposed on a lower portion of the wall frame 20.

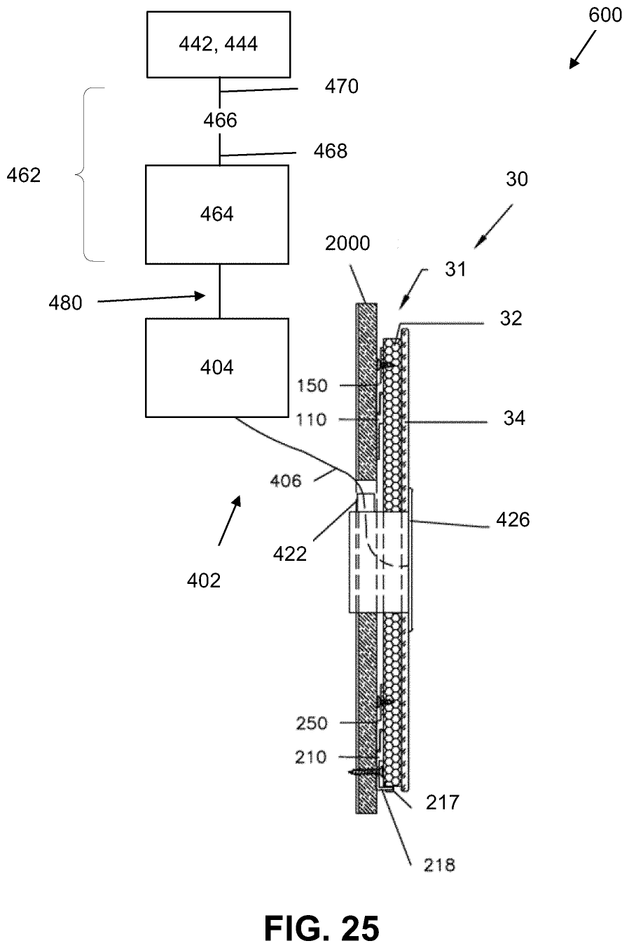

In some embodiments, for example, the second support-defined current or light communicating module 462 is disposed on a support 2000, for example, a wall frame 2000, that is different from the wall frame 20 on which the first support-defined communicating module 432 is disposed, as depicted in FIG. 25. For example, the support-defined counterpart 434 of the first connecting structure 450 is disposed on a wall frame 20 corresponding to a first side of a room, and the support-defined counterpart 464 of the second connecting structure 480 is disposed on a wall frame 2000 corresponding to a second side of a room that is different from the first side of the room. As another example, the support-defined counterpart 434 of the first connecting structure 450 is disposed on a wall frame 20 of a first room, and the support-defined counterpart 464 of the second connecting structure 480 is disposed on a wall frame 2000 of a second room that is different from the first room.

In some embodiments, for example, while the wall panel assembly-defined counterpart 404 of the first connecting structure 450 is releasably coupled to the support-defined counterpart 434 of the first connecting structure 450 and mounted to the wall frame 20 with the system 10, the wall panel assembly 30 is disposed at a position relative to the wall frame 20. Where the wall panel assembly 30 includes the outlet 424, the outlet 424 disposed at a position relative to the wall frame 20 based on the relative disposition of the wall panel assembly 30 and the wall frame 20. In some embodiments, for example, the outlet 424 is disposed at a first portion of the wall frame 20.

In some embodiments, for example, the wall panel assembly 30 is re-positionable relative to the support-defined counterpart 464 of the second connecting structure 450, such that the wall panel assembly-defined current or light conductor 406, the second support-defined current or light conductor 466, the wall panel assembly-defined counterpart 404 of the second connecting structure 480, and the support-defined counterpart 464 of the second connecting structure 480 are co-operatively configured such that in response to the releasable coupling of the wall panel assembly-defined counterpart 404 of the second connecting structure 480 and the support-defined counterpart 464 of the second connecting structure 480, the wall panel assembly-defined current or light conductor 404 becomes disposed in operable communication with the second support-defined current or light conductor 466. In such embodiments, for example, the releasable coupling of the wall panel assembly-defined counterpart 404 and the support-defined counterpart 434 of the connecting structure 450 is released, the wall panel assembly 30 is re-positioned relative to the support-defined counterpart 464 of the second connecting structure 450, the wall panel assembly-defined counterpart 404 of the second connecting structure 480 and the support-defined counterpart 464 of a second connecting structure 480 are releasably coupled, and the wall panel assembly 30 is mounted to a support, such as the wall frame 20, which includes the first support-defined communicating module 432, or the wall frame 2000, which is a support that is different from the wall frame 20.

In some embodiments, for example, the outlet 424 is re-positioned from the first portion of the wall frame 20 to be disposed at a second portion of the wall frame 20, where the wall panel assembly-defined counterpart 404 of the first connecting structure 450 is not releasably couplable to the support-defined counterpart 434 of the first connecting structure 450, for example, due to the length of one or more of wall panel assembly-defined current or light conductor 406 and the support-defined current or light conductor 436, but where the wall panel assembly-defined counterpart 404 of the second connecting structure 480 is releasably couplable to the support-defined counterpart 464 of the second connecting structure 480, while the wall panel assembly 30 is disposed at the second portion of the wall frame 20.

In some embodiments, for example, the outlet 424 is re-positioned from a first wall frame 20 to a second wall frame 2000, where the wall panel assembly-defined counterpart 404 of the first connecting structure 450 is not releasably couplable to the support-defined counterpart 434 of the first connecting structure 450, for example, due to the length of one or more of wall panel assembly-defined current or light conductor 406 and the support-defined current or light conductor 436, but where the wall panel assembly-defined counterpart 404 of the second connecting structure 480 is releasably couplable to the support-defined counterpart 464 of the second connecting structure 480, while the wall panel assembly 30 is disposed at the second wall frame 2000.

In some embodiments, for example, the outlet 424 is the electrical outlet 424, and the wall panel assembly-defined current or light conductor 406 is disposed in electrical communication with the electrical outlet 424. In some embodiments, for example, the wall panel assembly-defined current or light conductor 406, the second support-defined current or light conductor 466, the electrical outlet 424, the wall panel assembly-defined counterpart 404 of the second connecting structure 480, and the support-defined counterpart 464 of the second connecting structure 480 are co-operatively configured such that while the wall panel assembly-defined counterpart 404 of the second connecting structure 480 and the support-defined counterpart 464 of the second connecting structure 480 are releasably coupled, the electrical outlet 424 and the second support-defined current or light conductor 466 are disposed in electrical communication.

In some embodiments, for example, the power source 442 is the electrical panel 442, and the support-defined counterpart 464 of the second connecting structure 480 is disposed in electrical communication with the electrical panel 442. In some embodiments, for example, the wall panel assembly-defined current or light conductor 406, the second support-defined current or light conductor 466, the electrical outlet 424, the electrical panel 442, the wall panel assembly-defined counterpart 404 of the second connecting structure 480, and the support-defined counterpart 464 of the second connecting structure 480 are co-operatively configured such that while the wall panel assembly-defined counterpart 404 of the second connecting structure 480 and the support-defined counterpart 464 of the second connecting structure 480 are releasably coupled, the electrical outlet 424 and the electrical panel 442 are disposed in electrical communication.

In some embodiments, for example, the outlet 424 is the switch 424, and the wall panel assembly-defined current or light conductor 406 is disposed in electrical communication with the switch 424. In some embodiments, for example, the wall panel assembly-defined current or light conductor 406, the second support-defined current or light conductor 466, the switch 424, the wall panel assembly-defined counterpart 404 of the second connecting structure 480, and the support-defined counterpart 464 of the second connecting structure 480 are co-operatively configured such that while the wall panel assembly-defined counterpart 404 of the second connecting structure 480 and the support-defined counterpart 464 of the second connecting structure 480 are releasably coupled, the switch 424 and the second support-defined current or light conductor 466 are disposed in electrical communication.

In some embodiments, for example, the power source 442 is the electrical panel 442, and the support-defined counterpart 464 of the second connecting structure 480 is disposed in electrical communication with the electrical panel 442. In some embodiments, for example, the wall panel assembly-defined current or light conductor 406, the second support-defined current or light conductor 466, the switch 424, the electrical panel 466, the wall panel assembly-defined counterpart 404 of the second connecting structure 480, and the support-defined counterpart 464 of the second connecting structure 480 are co-operatively configured such that while the wall panel assembly-defined counterpart 404 of the second connecting structure 480 and the support-defined counterpart 464 of the second connecting structure 480 are releasably coupled, the switch 424 and the electrical panel 442 are disposed in electrical communication.

In some embodiments, for example, the outlet 424 is the data port 424, and the wall panel assembly-defined current or light conductor 406 is disposed in data communication with the data port 424. In some embodiments, for example, the wall panel assembly-defined current or light conductor 406, the second support-defined current or light conductor 466, the data port 424, the wall panel assembly-defined counterpart 404 of the second connecting structure 480, and the support-defined counterpart 464 of the second connecting structure 480 are co-operatively configured such that while the wall panel assembly-defined counterpart 404 of the second connecting structure 480 and the support-defined counterpart 464 of the second connecting structure 480 are releasably coupled, the data port 424 and the second support-defined current or light conductor 466 are disposed in data communication.

In some embodiments, for example, the data source 444 is the modem 444, and the support-defined counterpart 434 of the connecting structure 450 is disposed in data communication with the modem 444. In some embodiments, for example, the wall panel assembly-defined current or light conductor 406, the second support-defined current or light conductor 466, the data port 424, the modem 444, the wall panel assembly-defined counterpart 404 of the second connecting structure 480, and the support-defined counterpart 464 of the second connecting structure 480 are co-operatively configured such that while the wall panel assembly-defined counterpart 404 of the second connecting structure 480 and the support-defined counterpart 464 of the second connecting structure 480 are releasably coupled, the data port 424 and the modem 444 are disposed in data communication.

In some embodiments, for example, the wall panel assembly 30 and the second connecting structure 480 are co-operatively configured such that, while the wall panel assembly-defined counterpart 404 of the second connecting structure 480 and the support-defined counterpart 464 of the second connecting structure 480 are releasably coupled, and the wall panel assembly 30 is mounted to the wall frame 20 or the wall frame 2000, the second connecting structure 480 is occluded, or partially occluded, by the wall panel assembly 30. In some embodiments, for example, the wall panel assembly 30, while mounted on the wall frame 20 or the wall frame 2000, obscures the second connecting structure 480 or a portion of the second connecting structure 480 from view. From the perspective of an observer standing in front of the wall frame 20 or wall frame 2000 and looking at the wall panel assembly 30, the system 10 and the wall panel assembly 30 are co-operatively configured such that while the wall panel assembly 30 is mounted to the wall frame 20 or the wall frame 2000, the wall paneling 34 is facing outwardly relative to the wall frame 20 or the wall frame 2000, such that the wall paneling 34 is visible while the wall panel assembly 30 occludes the second connecting structure 480 or a portion of the second connecting structure 480, or obscures the second connecting structure 480 or a portion of the second connecting structure 480 from view.

By securing the load 30 to the wall frame 20 using the system 10, it may facilitate leveling of the load 30 relative to the floor. In some embodiments, for example, the weight of the load 30 is supported solely by the ledge 218. In such embodiments, the user only has to level one component of the system 10, namely the ledge 218, relative to the floor to level the load 30 when the load 30 is supported by the ledge 218. By supporting the load 30 solely with the ledge 218, the risk of incorrect leveling of the load 30 due to having multiple points of contact with a securing system and the load 30 is avoided or reduced. In this regard, during manufacturing, particular attention may be directed to the ledge 218 and the load 30 such that the reinforcing substrate 32 is configured to be supported on the ledge 218. By directing attention to the manufacturing of the ledge 218 and the load 30, the leveling of the load 30 relative to the floor may be improved, on site adjustments of the system 10 may be avoided or reduced.

The wall panel assembly 30 and the wall panel system 600 may allow for outlets to be added or relocated quickly and efficiently. Each of the support-defined current or light conductors 436 may be run from the power source 442 or data source 444 to the wall frame 20 during construction of a building or room, such that additional conductors 436 may not need to be run from the power source 442 or data source 444. In addition, using the system 10, the wall panel assembly 30 may be quickly mounted to a wall frame 20, dismounted from the wall frame 20, and re-mounted to the wall frame 20 at the same position, at a different position, or re-mounted to a different wall frame 2000. Accordingly, the outlet 424 may be re-positionable relative to the wall frame 20 or the wall frame 2000 without cutting openings through the drywall, which also avoids having to patch up said openings. Moreover, by installing the wall bracket 110 of the first mounting system 100 and the wall bracket 210 of the second mounting system 200 at desirable locations of the wall frame 20, the wall panel assembly 30 and the outlet 424 may be disposed at said desirable locations of the wall frame 20. In this regard, the wall panel assembly 30 and the wall panel system 600 are modular, such that the disposition of the wall panel assembly 30 and the outlet 424 may be changed based on the preference of the user.

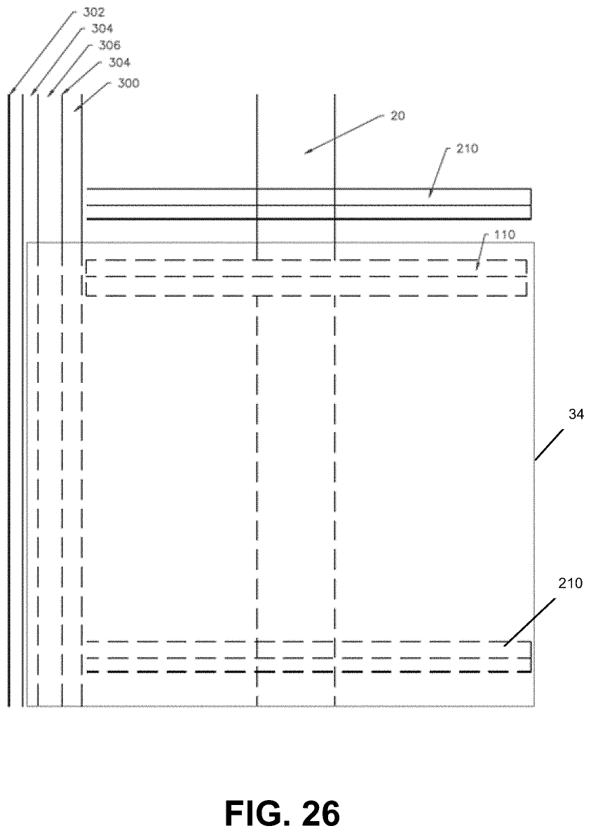

In some embodiments, for example, a corner bracket 300 is installed in the corner of a room while securing the loads 30 to the supports 20, as depicted in FIG. 26 to FIG. 28. The corner bracket 300 is configured to occlude or obscure from view the underlying components, such as the studs, insulation, wood, and other building materials, and provide a pleasant aesthetic as a decorative trim at the corner of the room.

As depicted in FIG. 26 to FIG. 28, the corner bracket 300 has a body 302. In some embodiments, for example, the body 302 has an L-shape or a W-shape body. In some embodiments, for example, the bracket 300 includes one or more ribs 304 that are configured to engage with the load 30. In some embodiments, for example, the ribs 304 are configured to abut against the load 30, for example, the cushioning member 36 of a wall panel 30. In some embodiments, for example, the body 302 and the ribs 304 of the corner bracket 300 are co-operatively configured to define one or more channels 306. In some embodiments, for example, appropriate fasteners, such as tape or adhesives, are inserted in the channels 306 to connect the corner bracket 300 and the load 30. In some embodiments, for example, the channels 306 are configured to receive insulation as part of the completion of the room.

In some embodiments, for example, a kit for assembling a wall between a first corner and a second corner of a room, wherein the first corner is horizontally spaced from the second corner by a first distance, includes the corner bracket 300. In some embodiments, for example, the kit includes a plurality of wall assemblies 30 that are configured to be mounted in end-to-end configuration or in series configuration between the first and second corners, such that a plurality of mounted walls panel assemblies 30 are obtained. The walls panel assemblies 30 and the corner bracket 300 are co-operatively configured such that, while: (i) the walls panel assemblies 30 are mounted in the end-to-end configuration, starting from the first corner and extending towards the second corner, such that a gap is defined between the last one of the walls panel assemblies 30 and the second corner, and (ii) the corner bracket 300 is mounted at the second corner, the corner bracket 300 extends from the second corner such that the walls panel assemblies 30 are disposed in overlapping relationship with the corner bracket 300. In some embodiments, for example, while the walls panel assemblies 30, such as the last of the walls panel assemblies 30, is in overlapping relationship with the corner bracket 300, the gap is concealed or covered by the corner bracket 300, as depicted in FIG. 26 to FIG. 28. In some embodiments, for example, the corner bracket 300, or a portion of the corner bracket 300, such as a leg of the corner bracket 300 that defines a portion of the L-shape or W-shape body of the corner bracket 300, is received in the gap to fill at least a portion of the space defined by the gap, while the gap is concealed or covered by the corner bracket 300, as depicted in FIG. 26 to FIG. 28. In such embodiments, for example, the gap between the last of the walls panel assemblies 30 and the corner is absent or substantially absent, as the corner bracket 300 has filled in gap by being received in the gap. By assembling a wall between a first corner and a second corner of a room using the walls panel assemblies 30 and the corner bracket 300, the corner of the room may have an aesthetically pleasing look, and the building materials are obscured or covered from view.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1-38. (canceled)

39. A wall panel assembly for mounting to a support, the support including a support-defined current or light communicating module that includes a support-defined counterpart of a connecting structure and a support-defined current or light conductor, the wall panel assembly comprising:
a wall panel that is mountable the support;
a wall panel assembly-defined current or light communicating module that includes:
a wall panel assembly-defined counterpart of the connecting structure that is configured for releasably coupling to the support-defined counterpart of the connecting structure; and
a wall panel assembly-defined current or light conductor;
wherein the wall panel assembly-defined current or light conductor and the wall panel assembly-defined counterpart of the connecting structure are co-operatively configured such that in response to the releasable coupling of the wall panel assembly-defined and the support-defined counterparts of the connecting structure, the wall panel assembly-defined current or light conductor becomes disposed in operable communication with the support-defined current or light conductor.

40. The wall panel assembly of claim 39, wherein:
the wall panel assembly and the connecting structure are co-operatively configured such that, while:
the wall panel assembly-defined counterpart of the connecting structure and the support-defined counterpart of the connecting structure are releasably coupled; and
the wall panel assembly is mounted to the support;
the connecting structure is occluded by the wall panel assembly.

41. The wall panel assembly of claim 39, wherein:
the wall panel includes:
a wall paneling, including a first surface and a second surface that is opposite the first surface;
a reinforcing structure connected to the first surface of the wall paneling;
an opening that extends through the wall paneling and the reinforcing structure; and
the wall panel assembly-defined current or light conductor is received in the opening of the wall panel.

42. The wall panel assembly of claim 39, wherein:
the operable communication in which the wall panel assembly-defined current or light conductor and the support-defined current or light conductor becomes disposed is electrical communication;
the wall panel assembly-defined current or light conductor is disposed in electrical communication with an electrical outlet;
the support-defined counterpart of the connecting structure is disposed in electrical communication with an electrical panel; and
the wall panel assembly-defined current or light conductor, the electrical outlet, and the wall panel assembly-defined counterpart of the connecting structure are co-operatively configured such that while the wall panel assembly-defined counterpart of the connecting structure and the support-defined counterpart of the connecting structure are releasably coupled, the electrical outlet and the electrical panel are disposed in electrical communication.

43. The wall panel assembly of claim 39, wherein:
the operable communication in which the wall panel assembly-defined current or light conductor and the support-defined current or light conductor becomes disposed is electrical communication;
the wall panel assembly-defined current or light conductor is disposed in electrical communication with a switch;
the support-defined counterpart of the connecting structure is disposed in electrical communication with an electrical panel; and
the wall panel assembly-defined current or light conductor, the switch, and the wall panel assembly-defined counterpart of the connecting structure are co-operatively configured such that while the wall panel assembly-defined counterpart of the connecting structure and the support-defined counterpart of the connecting structure are releasably coupled, the switch and the electrical panel are disposed in electrical communication.

44. The wall panel assembly of claim 39, wherein:
the operable communication in which the wall panel assembly-defined current or light conductor and the support-defined current or light conductor becomes disposed is data communication;
the wall panel assembly-defined current or light conductor is disposed in data communication with a data port;
the support-defined counterpart of the connecting structure is disposed in data communication with a modem; and
the wall panel assembly-defined current or light conductor, the data port, and the wall panel assembly-defined counterpart of the connecting structure are co-operatively configured such that while the wall panel assembly-defined counterpart of the connecting structure and the support-defined counterpart of the connecting structure are releasably coupled, the data port and the modem are disposed in data communication.

45. The wall panel assembly of claim 39, comprising a system for securing the wall panel assembly to the support, the system comprising:
a first mounting system and a second mounting system, wherein:
the first mounting system includes a wall bracket and a load bracket;
the second mounting system includes a wall bracket and a load bracket;
wherein:
the wall bracket of the first mounting system includes:
a mounting flange for mounting the wall bracket of the first mounting system to the support; and
a retaining flange;
the load bracket of the first mounting system includes:
a mounting flange for mounting the load bracket of the first mounting system to the wall panel assembly;
a retainable flange;
the wall bracket of the second mounting system includes:
a mounting flange for mounting the wall bracket of the second mounting system to the support;
a retaining flange; and
a ledge configured to vertically support the wall panel assembly;
the load bracket of the second mounting system includes:
a mounting flange for mounting the load bracket of the second mounting system to the wall panel assembly; and
a retainable flange;
wherein the wall bracket and the load bracket of the first mounting system and the wall bracket and the load bracket of the second mounting system are co-operatively configured, and the wall bracket of the first mounting system, the load bracket of the first mounting system, the wall bracket of the second mounting system, the load bracket of the second mounting system, the mountability of the wall bracket, of the first mounting system, to the support, the mountability of the load bracket, of the first mounting system, to the wall panel assembly, the mountability of the wall bracket, of the second mounting system, to the support, and the mountability of the load bracket, of the second mounting system, to the wall panel assembly are co-operatively configured, such that:
a first receiving space is defined between the support and the retaining flange of the wall bracket of the first mounting system;
the retainable flange of the load bracket of the first mounting system is receivable within the first receiving space;
a second receiving space is defined between the support and the retaining flange of the wall bracket of the second mounting system;
the retainable flange of the load bracket of the second mounting system is receivable within the second receiving space; and
the ledge is disposed for vertically supporting the load while: (i) the retainable flange of the load bracket of the first mounting system is disposed within the first receiving space, and (ii) the retainable flange of the load bracket of the second mounting system is disposed within the second receiving space, such that the wall panel assembly is mounted to the support via the first and second mounting systems.

46. A wall panel system, comprising:
a wall panel assembly that is mountable to a support, the support including a support-defined current or light communicating module that includes:
a support-defined counterpart of a connecting structure; and
a support-defined current or light conductor;
the wall panel assembly including a wall panel assembly-defined current or light communicating module that includes:
a wall panel assembly-defined counterpart of the connecting structure that is configured for releasably coupling to the support-defined counterpart of the connecting structure; and
a wall panel assembly-defined current or light conductor;
wherein the wall panel assembly-defined current or light conductor, the support-defined current or light conductor, the wall panel assembly-defined counterpart of the connecting structure, and the support-defined counterpart of the connecting structure are co-operatively configured such that in response to the releasable coupling of the wall panel assembly-defined counterpart of the connecting structure and the support-defined counterpart of the connecting structure, the wall panel assembly-defined current or light conductor becomes disposed in operable communication with the support-defined current or light conductor.

47. The wall panel system of claim 46, wherein:
the wall panel assembly and the connecting structure are co-operatively configured such that, while:
the wall panel assembly-defined counterpart of the connecting structure and the support-defined counterpart of the connecting structure are releasably coupled; and
the wall panel assembly is mounted to the support;
the connecting structure is occluded by the wall panel assembly.

48. The wall panel system of claim 46, wherein:
the wall panel of the wall panel assembly includes:
a wall paneling, including a first surface and a second surface that is opposite the first surface;
a reinforcing structure connected to the first surface of the wall paneling;
an opening that extend through the wall paneling and the reinforcing structure; and
the wall panel assembly-defined current or light conductor is received in the opening of the wall panel.

49. The wall panel system of claim 46, wherein:
the operable communication in which the wall panel assembly-defined current or light conductor and the support-defined current or light conductor becomes disposed is electrical communication;
the wall panel assembly-defined current or light conductor is disposed in electrical communication with an electrical outlet;
the support-defined current or light conductor is disposed in electrical communication with an electrical panel; and
the wall panel assembly-defined current or light conductor, the support-defined current or light conductor, the electrical outlet, the electrical panel, the wall panel assembly-defined counterpart of the connecting structure, and the support-defined counterpart of the connecting structure are co-operatively configured such that while the wall panel assembly-defined counterpart of the connecting structure and the support-defined counterpart of the connecting structure are releasably coupled, the electrical outlet and the electrical panel are disposed in electrical communication.

50. The wall panel system of claim 46, wherein:
the operable communication in which the wall panel assembly-defined current or light conductor and the support-defined current or light conductor becomes disposed is electrical communication;
the wall panel assembly-defined current or light conductor is disposed in electrical communication with a switch;
the support-defined current or light conductor is disposed in electrical communication with an electrical panel; and
the wall panel assembly-defined current or light conductor, the support-defined current or light conductor, the switch, the electrical panel, the wall panel assembly-defined counterpart of the connecting structure, and the support-defined counterpart of the connecting structure are co operatively configured such that while the wall panel assembly-defined counterpart of the connecting structure and the support-defined counterpart of the connecting structure are releasably coupled, the switch and the electrical panel are disposed in electrical communication.

51. The wall panel system of claim 46, wherein:
the operable communication in which the wall panel assembly-defined current or light conductor and the support-defined current or light conductor becomes disposed is data communication;
the wall panel assembly-defined current or light conductor is disposed in data communication with a data port;
the support-defined current or light conductor is disposed in data communication with a modem; and
the wall panel assembly-defined current or light conductor, the support-defined current or light conductor, the data port, the modem, the wall panel assembly-defined counterpart of the connecting structure, and the support-defined counterpart of the connecting structure are co operatively configured such that while the wall panel assembly-defined counterpart of the connecting structure and the support-defined counterpart of the connecting structure are releasably coupled, the data port and the modem are disposed in data communication.

52. The wall panel system of claim 46, wherein:
the support-defined current or light communicating module is a first support-defined current or light communicating module, the connecting structure is a first connecting structure, and the support-defined current or light conductor is a first support-defined current or light conductor;
the support includes a second support-defined current or light communicating module that includes:
a support-defined counterpart of a second connecting structure; and
a second support-defined current or light conductor;
the wall panel assembly is re-positionable relative to the support-defined counterpart of the second connecting structure;
the wall panel assembly-defined counterpart of the first connecting structure is a wall panel assembly-defined counterpart of the second connecting structure, the wall panel assembly-defined counterpart of the second connecting structure is configured for releasably coupling to the support-defined counterpart of the second connecting structure;
wherein the wall panel assembly-defined current or light conductor, the second support-defined current or light conductor, the wall panel assembly-defined counterpart of the second connecting structure, and the support-defined counterpart of the second connecting structure are co-operatively configured such that in response to the releasable coupling of the wall panel assembly-defined counterpart of the second connecting structure and the support-defined counterpart of the second connecting structure, the wall panel assembly-defined current or light conductor becomes disposed in operable communication with the second support-defined current or light conductor.

53. The wall panel assembly of claim 52, wherein:
the wall panel assembly and the second connecting structure are co-operatively configured such that, while:
the wall panel assembly-defined counterpart of the second connecting structure and the support-defined counterpart of the second connecting structure are releasably coupled; and
the wall panel assembly is mounted to the support;
the second connecting structure is occluded by the wall panel assembly.

54. The wall panel system of claim 52, wherein:
the operable communication in which the wall panel assembly-defined current or light conductor and the support-defined current or light conductor becomes disposed is electrical communication;
the wall panel assembly-defined current or light conductor is disposed in electrical communication with the electrical outlet;
the second support-defined current or light conductor is disposed in electrical communication with the electrical panel; and
the wall panel assembly-defined current or light conductor, the second support-defined current or light conductor, the electrical outlet, the electrical panel, the wall panel assembly defined counterpart of the second connecting structure, and the support-defined counterpart of the second connecting structure are co operatively configured such that while the wall panel assembly defined counterpart of the second connecting structure and the support-defined counterpart of the second connecting structure are releasably coupled, the electrical outlet and the electrical panel are disposed in electrical communication.

55. The wall panel system of claim 52, wherein:
the operable communication in which the wall panel assembly-defined current or light conductor and the support-defined current or light conductor becomes disposed is electrical communication;
the wall panel assembly-defined current or light conductor is disposed in electrical communication with the switch;
the second support-defined current or light conductor is disposed in electrical communication with the electrical panel; and
the wall panel assembly-defined current or light conductor, the second support-defined current or light conductor, the switch, the electrical panel, the wall panel assembly-defined counterpart of the second connecting structure, and the support-defined counterpart of the second connecting structure are co-operatively configured such that while the wall panel assembly-defined counterpart of the second connecting structure and the support-defined counterpart of the second connecting structure are releasably coupled, the switch and the electrical panel are disposed in electrical communication.

56. The wall panel system of claim 52, wherein:
the operable communication in which the wall panel assembly-defined current or light conductor and the support-defined current or light conductor becomes disposed is data communication;
the wall panel assembly-defined current or light conductor is disposed in data communication with the data port;
the second support-defined current or light conductor is disposed in data communication with the modem; and
the wall panel assembly-defined current or light conductor, the second support-defined current or light conductor, the data port, the modem, the wall panel assembly-defined counterpart of the second connecting structure, and the support-defined counterpart of the second connecting structure are co-operatively configured such that while the wall panel assembly-defined counterpart of the second connecting structure and the support-defined counterpart of the second connecting structure are releasably coupled, the data port and the modem are disposed in data communication.

57. The wall panel assembly of claim 52, wherein the support is a first support, and a second support includes the second support-defined current or light communicating module.

58. The wall panel system of claim 46, further comprising a system for securing the wall panel assembly to the support, the system for securing the wall panel assembly to the support comprising:
a first mounting system and a second mounting system, wherein:
the first mounting system includes a wall bracket and a load bracket;
the second mounting system includes a wall bracket and a load bracket;
wherein:
the wall bracket of the first mounting system includes:
a mounting flange for mounting the wall bracket of the first mounting system to the support; and
a retaining flange;
the load bracket of the first mounting system includes:
a mounting flange for mounting the load bracket of the first mounting system to the wall panel assembly;
a retainable flange;
the wall bracket of the second mounting system includes:
a mounting flange for mounting the wall bracket of the second mounting system to the support;
a retaining flange; and
a ledge configured to vertically support the wall panel assembly;
the load bracket of the second mounting system includes:
a mounting flange for mounting the load bracket of the second mounting system to the wall panel assembly; and
a retainable flange;
wherein the wall bracket and the load bracket of the first mounting system and the wall bracket and the load bracket of the second mounting system are co-operatively configured, and the wall bracket of the first mounting system, the load bracket of the first mounting system, the wall bracket of the second mounting system, the load bracket of the second mounting system, the mountability of the wall bracket, of the first mounting system, to the support, the mountability of the load bracket, of the first mounting system, to the wall panel assembly, the mountability of the wall bracket, of the second mounting system, to the support, and the mountability of the load bracket, of the second mounting system, to the wall panel assembly are co-operatively configured, such that:
a first receiving space is defined between the support and the retaining flange of the wall bracket of the first mounting system;
the retainable flange of the load bracket of the first mounting system is receivable within the first receiving space;
a second receiving space is defined between the support and the retaining flange of the wall bracket of the second mounting system;
the retainable flange of the load bracket of the second mounting system is receivable within the second receiving space; and
the ledge is disposed for vertically supporting the load while: (i) the retainable flange of the load bracket of the first mounting system is disposed within the first receiving space, and (ii) the retainable flange of the load bracket of the second mounting system is disposed within the second receiving space, such that the wall panel assembly is mounted to the support via the first and second mounting systems.
